(19) United States
(12) Patent Application Publication
(10) Pub. No.: US 2007/0291363 A1
(43) Pub. Date: Dec. 20, 2007

(54) Optical Film

(75) Inventors: Tetsuya Asakura, Minami-Ashigara-shi (JP); Naohiro Matsunaga, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/765,244

(22) Filed: Jun. 19, 2007

(30) Foreign Application Priority Data
Jun. 19, 2006 (JP) 2006-168852

(51) Int. Cl. G02B 1/10

(52) U.S. Cl. 359/586

(57) ABSTRACT

An optical film including: a transparent support; at least one hardcoat layer containing a light-transparent resin; and at least one light-transparent organic resin particle, wherein the light-transparent organic resin particle has a refractive index being higher than a refractive index of the hardcoat layer, and a difference between the refractive index of the light-transparent organic resin particle and the refractive index of the hardcoat layer is 0.10 or more.

### FIELD OF THE INVENTION

The present invention relates to an optical film for the display element of a display device (e.g., CRT, PDP, ELD, SED, LCD) used for displaying an image of computers, word processors, televisions and the like. More specifically, the present invention relates to an inexpensive light-diffusing film for enhancing the viewing angle property and visibility, and a polarizing plate and a display device, particularly, a liquid display device (LCD), each using the light-diffusing film.

### BACKGROUND OF THE INVENTION

A liquid crystal display device is generally composed of a polarizing film and a liquid crystal cell.

In the TN-mode TFT liquid crystal display device, an optical compensation film is inserted between the polarizing film and the liquid crystal, whereby a liquid crystal display device with high display quality is realized However, this liquid crystal display device has a problem that tone reversal occurs in the down direction of the panel. Furthermore, the problem in the display quality due to reflection of outside light or the problem of the tint changing depending on the viewing angle has not yet been overcome.

In order to solve these problems, in JP-T-2005-505019 (the term “JP-T” as used herein means a “published Japanese translation of a PCT patent application”) (corresponding to WO 03/032061 A1), the forward scattering light intensity of a light-diffusing film containing a diffusing agent inside the resin film is appropriately designed and at the same time, the backward scattering light intensity is made very small, whereby a liquid crystal display device advantageous in view of brightness and high resolution and assured of a wide viewing angle can be realized.

However, for practicing this method as specific means, incorporation of an expensive ZrO₂ fine particle and a diffusing agent into the binder, or double-layer coating for the light-diffusing layer is required, as a result, the cost rises and mass production becomes difficult.

With respect to the inexpensive light-diffusing film, in JP-A-11-160505 (the term “JP-A” as used herein means an “unexamined published Japanese patent application”) (corresponding to U.S. Pat. No. 6,111,699), a method of using a low refractive index layer-coated particle as the diffusing agent is known. For practicing this method as specific means, an air layer needs to be introduced between the particle and the binder and unless the thickness of the air layer is precisely controlled, the light scattering property varies. Thus, stable production is difficult.

### SUMMARY OF THE INVENTION

An object of the present invention is, as described above, to provide a light-diffusing film which can more elevate the display quality of a liquid crystal display device, particularly, a liquid crystal display device with the viewing angle being widened by an optically anisotropic layer comprising a liquid crystalline compound, by using a light-diffusing layer and further ensures a low cost and no fluctuation at the production. Another object of the present invention is to provide a polarizing plate and a display device each having the optical film.

As a result of intensive studies, the present inventors have found that the above-described objects can be achieved by an optical film having the following constructions.

(1) An optical film comprising a transparent support and at least one light-transparent resin-containing hardcoat layer, wherein at least one of the at least one hardcoat layer contains at least one kind of a light-transparent organic resin particle, and the surface of the light-transparent organic resin particle is covered with a metal oxide.

(2) The optical film as described in 1 above, wherein the metal oxide covering the surface of the light-transparent organic resin particle is silica.

(3) The optical film as described in 1 or 2 above, wherein the light-transparent organic resin particle is a melamine resin.

(4) The optical film as described in any one of 1 to 3 above, wherein the average particle diameter of the light-transparent organic resin particle is 2.5 μm or less.

(5) The optical film as described in any one of 1 to 4 above, wherein the CV value (standard deviation of particle diameter/average particle diameter) of the light-transparent organic resin particle is less than 10%.

(6) The optical film as described in any one of 1 to 5 above, wherein the refractive index of the light-transparent organic resin particle is higher than the refractive index of the hardcoat layer and the difference therebetween is 0.10 or more.

(7) The optical film as described in any one of 1 to 6 above, wherein the internal haze of the optical film is from 20% to less than 80%.

(8) The optical film as described in any one of 1 to 7 above, wherein the surface haze of the optical film is less than 3%.

(9) The optical film as described in any one of 1 to 8 above, wherein the Ra (root-mean-square roughness) of the optical film is less than 0.07 μm.

(10) The optical film as described in any one of 1 to 9 above, wherein the thickness of the hardcoat layer is 5 μm or more.

(11) The optical film as described in any one of 1 to 10 above, wherein the optical film contains at least two kinds of light-transparent particles differing in the average particle diameter, at least one kind thereof is the above-described light-transparent organic resin particle having an average particle diameter of 2.5 μm or less, at least one kind is a light-transparent particle having an average particle diameter of 3 μm or more, and the number of the light-transparent organic resin particles having an average particle diameter of 2.5 μm or less per unit area is 3 times or more the number of the light-transparent particles having an average particle diameter of 3 μm or more per unit area.

(12) The optical film as described in any one of 1 to 11, wherein the optical film further comprises a low refractive index layer as the outermost layer and the low refractive index layer has a refractive index lower than the refractive index of an adjacent layer.

(13) The optical film as described in any one of 1 to 12 above, wherein assuming that the average value of 5° specular reflectance in the wavelength region of 450 to 650 nm is A and the average value of integrated reflectance in that region is B, B is 3% or less and B-A is 1.5% or less.

(14) The optical film as described in 12 or 13, wherein the low refractive index layer contains at least one kind of a fine particle having a particle diameter corresponding to 15 to 150% of the thickness of the low refractive index layer.

(15) The optical film as described in 14 above, wherein at least one kind of the fine particle is a hollow fine particle.

(16) The optical film as described in any one of 12 to 15 above, wherein the low refractive index layer is formed by coating and the coating solution for forming the low refractive index layer contains at least one kind of a light-transparent resin having an ultraviolet (UV)-curable and/or heat-curable functional group.

(17) The optical film as described in any one of 12 to 16 above, wherein the low refractive index layer is formed by coating, the coating solution for forming the low refractive index layer contains at least two or more kinds of light-transparent resins, at least one kind of the light-transparent resin has an ultraviolet (UV)-curable functional group, and at least one different kind of the light-transparent resin has a heat-curable functional group.

(18) The optical film as described in 16 or 17 above, wherein the low refractive index layer is formed by coating, the coating solution for forming the low refractive index layer contains at least two or more kinds of light-transparent resins, at least one kind of the light-transparent resin has an ultraviolet (UV)-curable functional group and a fluorine group, and at least one different kind of the light-transparent resin has no fluorine group and has an ultraviolet (UV)-curable functional group.

(19) The optical film as described in any one of 16 to 18 above, wherein the coating solution for forming the low refractive index layer further contains at least one kind of a polymerization initiator and/or at least one kind of a heat-curable crosslinking agent.

(20) The optical film as described in 19 above, wherein the coating solution for forming the low refractive index layer further contains at least one curing catalyst capable of accelerating the thermal curing.

(21) The optical film as described in any one of 1 to 20 above, wherein at least any one layer contains at least one kind of a fluorine-based leveling agent and/or at least one kind of a silicone-based leveling agent.

(22) The optical film as described in any one of 1 to 21 above, wherein all layers contain a silica material.

(23) The optical film as described in any one of 1 to 22 above, wherein the contact angle by pure water on the surface of the optical film as measured in an environment of 25° C. and 60% RH is 90° or more.

(24) The optical film as described in any one of 1 to 23 above, wherein the coefficient of dynamic friction on the surface of the optical film as measured in an environment of 25° C. and 60% RH is 0.3 or less.

(25) The optical film as described in any one of 1 to 24 above, wherein the vertical separation charge for polyethylene terephthalate as measured in an environment of 25° C. and 60% RH is from −500 to +500 pc (pico coulomb)/cm².

(26) The optical film as described in any one of 1 to 25 above, wherein the surface resistance value as measured in an environment of 25° C. and 60% RH is less than 1×10¹¹ Ω/square.

(27) A polarizing plate obtained by sandwiching a polarizer with two protective films, wherein one protective film of the polarizing plate is the optical film described in any one of 1 to 26 above.

(28) The polarizing plate as described in 27 above, wherein the protective film on the side opposite the optical film side has an optically anisotropic layer comprising a liquid crystalline compound.

(29) An image display device comprising the optical film described in any one of 1 to 26 above or the polarizing plate described in 27 or 28 above.

(30) The image display device as described in 29 above, wherein the image display device is a TFT liquid crystal display device selected from a TN mode, a VA mode, an IPS mode and an OCB mode.

The optical film of the present invention enables an image display device [1] to be more enhanced in the display quality, [2] to be inexpensive, and [3] to be reduced in the light scattering property at the production. The image display device having the optical film of the present invention can be assured of enlargement of the viewing angle, virtually no reduction in the contrast due to change of the viewing angle, and very little generation of tone or black-and-white reversal, tint change and the like.

### BRIEF DESCRIPTION OF THE DRAWINGS

FIGS. 1A, 1B and 1C are schematic cross-sectional views schematically showing the construction of the optical film of the present invention.

### DESCRIPTION OF REFERENCE NUMERALS AND SIGNS

1 Support
2 Hardcoat layer
3 Particle
4 Low refractive index layer
5 Hardcoat second layer
6 Hardcoat first layer

### DETAILED DESCRIPTION OF THE INVENTION

The present invention is described in detail below. Incidentally, the term “from (numerical value 1) to (numerical value 2)” as used in the present invention for expressing a physical value, a characteristic value or the like means “(numerical value 1) or more and (numerical value 2) or less” Also, the term “(meth)acrylate” as used in the present invention means “at least either acrylate or methacrylate”. The same applies to “(meth)acrylic acid” and the like.

### [Construction of Optical Film]

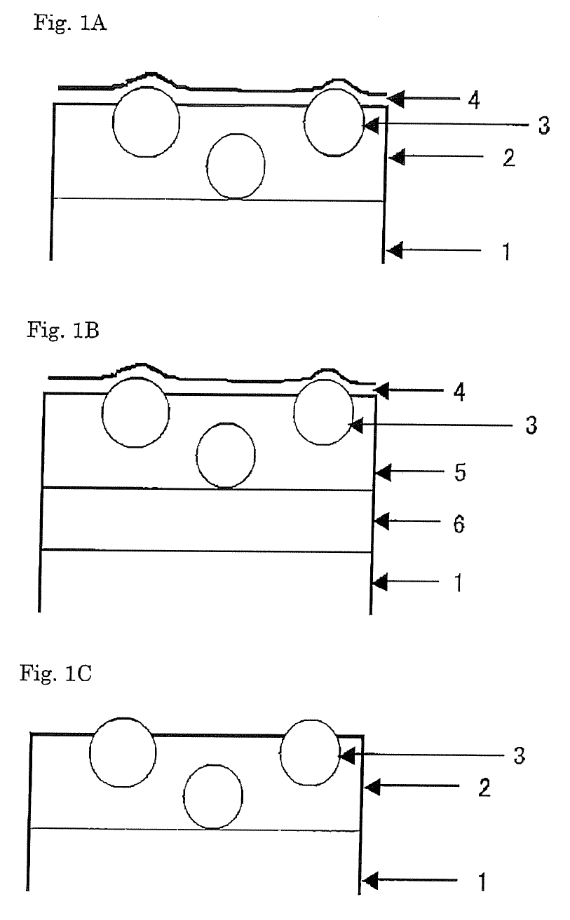

The optical film of the present invention has at least one light-transparent resin-containing hardcoat layer on a transparent support. The optical film of the present invention is described by referring to FIGS. 1A, 1B and 1C.

FIGS. 1A, 1B and 1C are schematic cross-sectional views schematically showing a preferred embodiment of the optical film of the present invention.

The optical film of FIG. 1A has one hardcoat layer (2) on a transparent support (1) and has, as the outermost layer, a low refractive index layer (4) having a refractive index lower than the refractive index of the adjacent hardcoat layer (2). The hardcoat layer (2) contains an organic resin particle (3).

The hardcoat layer may be formed of a plurality of layers and this is also preferred. The optical film of FIG. 1B has two hardcoat layers (a hardcoat layer (6) and a hardcoat layer (5) from the transparent support side) on a transparent support (1), and a low refractive index layer (4) is stacked as the outermost layer. The metal oxide particle is preferably contained in the hardcoat layer (5) on the side of the low refractive index layer as the outermost layer.

### (Hardcoat Layer)

In view of optical design for obtaining an anti-reflective film, the refractive index of the hardcoat layer for use in the present invention is preferably from 1.48 to 2.00, more preferably 1.48 to 1.60, still more preferably from 1.48 to 1.55. In the present invention, at least one low refractive index layer is present on the hardcoat layer and therefore, if the refractive index is less than the range above, the antireflection property decreases, whereas if it is excessively large, the tint of reflected light tends to be intensified.

In the present invention, preferably, the refractive index of the light-transparent organic resin particle described later is higher than the refractive index of the hardcoat layer, and the difference therebetween is preferably from 0.07 to 0.20, more preferably from 0.10 to 0.18, and most preferably from 0.13 to 0.16. If the difference of refractive index layer is less than 0.07, a large amount of the particle is required to obtain the desired internal haze and this gives rise to worsening of the adhesive property and coating suitability to the transparent substrate, whereas if the difference of refractive index exceeds 0.20, the scattering angle of transmitted light is excessively widened and the front contrast may disadvantageously decrease.

Meanwhile, even when the refractive index of the hardcoat layer is higher than the refractive index of the light-transparent organic resin particle and the difference therebetween is in the above-described range, the effect of the present invention can be obtained. However, in this case, a high refractive index fine particle (several nm to tens of nm) such as ZrO₂, TiO₂ and Al₂O₃, or a high refractive index monomer needs to be incorporated in a large amount into the hardcoat layer and this is not preferred in view of rise in the cost.

Here, the refractive index of the hardcoat layer can be quantitatively evaluated, for example, by directly measuring the refractive index with an Abbe refractometer or by measuring the spectral reflection spectrum or spectral ellipsometry. The refractive index of the light-transparent organic resin particle is determined as follows. The light-transparent particle is dispersed in an equal amount in solvents prepared by changing the mixing ratio of two kinds of solvents differing in the refractive index and thereby varying the refractive index, the turbidity is measured, and the refractive index of the solvent when the turbidity becomes minimum is measured by an Abbe refractometer.

As for the film thickness of the hardcoat layer, in view of imparting sufficiently high durability and impact resistance to the film, the thickness of the hardcoat layer is usually 5 μm or more, preferably 7 μm or more, and most preferably 10 μm or more.

The strength of the hardcoat layer is preferably H or more, more preferably 2 H or more, still more preferably 3 H or more, in the pencil hardness test.

Furthermore, in the Taber test according to JIS K5400, the abrasion loss of the specimen between before and after test is preferably smaller.

The hardcoat layer for use in the present invention is formed through a crosslinking or polymerization reaction of an ionizing radiation-curable compound. That is, a coating composition containing an ionizing radiation-curable polyfunctional monomer or polyfunctional oligomer is coated on a transparent support, and a crosslinking or polymerization reaction of the polyfunctional monomer or polyfunctional oligomer is brought about, whereby the hardcoat layer can be formed. The functional group in the ionizing radiation-curable polyfunctional monomer or polyfunctional oligomer is preferably a photo (ultraviolet)-, electron beam- or radiation-polymerizable functional group, more preferably a photopolymerizable functional group. Examples of the photopolymerizable functional group include an unsaturated polymerizable functional group such as (meth)acryloyl group, vinyl group, styryl group and allyl group. Among these, a (meth)acryloyl group is preferred.

Specific examples of the photopolymerizable poly-functional monomer having a photopolvmerizable functional group include (meth)acrylic acid diesters of alkylene glycol, such as neopentyl glycol acrylate, 1,6-hexanediol(meth)acrylate and propylene glycol di(meth)acrylate; (meth)acrylic acid diesters of polyoxyalkylene glycol, such as triethylene glycol di(meth)acrylate, dipropylene glycol di(meth)acrylate, polyethylene glycol di(meth)acrylate and polypropylene glycol di(meth)acrylate; (meth)acrylic acid diesters of polyhydric alcohol, such as pentaerythritol di(meth)acrylate; and (meth)acrylic acid diesters of ethylene oxide or propylene oxide adduct, such as 2,2-bis{4-(acryloxydiethoxy)phenyl}propane and 2-2-bis{4-(acryloxypolypropoxy)phenyl}propane.

Furthermore, epoxy (meth)acrylates, urethane (meth)-acrylates and polyester(meth)acrylates may also be preferably used as the photopolymerizable polyfunctional monomer. Among these, esters of a polyhydric alcohol and a (meth)acrylic acid are preferred, and a polyfunctional monomer having three or more (meth)acryloyl groups within one molecule is more preferred. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)pentaerythritol hexa(meth)acrylate, tripentaerythritol triacrylate and tripentaerythritol hexatriacrylate. The terms “(meth)acrylate”, “(meth)acrylic acid” and “(meth)acryloyl” as used in the present invention mean “acrylate or methacrylate”, “acrylic acid or methacrylic acid” and “acryloyl or methacryloyl”, respectively.

As for the polyfunctional monomer binder, monomers differing in the refractive index may be used for controlling the refractive index of each layer. In particular, examples of the high refractive index monomer include bis(4-methacryloylthiophenyl)sulfide, vinylnaphthalene, vinyl phenyl sulfide and 4-methacryloxyphenyl-4′-methoxyphenylthioether. Furthermore, dendrimers described, for example, in JP-A-2005-76005 and JP-A-2005-36105, and norbornene ring-containing monomers described, for example, in JP-A-2005-60425 may also be used.

As for the polyfunctional monomer or polyfunctional oligomer, two or more kinds of binders may be used in combination. The polymerization of such a binder having an ethylenically unsaturated group may be performed by the irradiation of ionizing radiation or under heating, in the presence of a photoradical initiator or a thermal radical initiator.

In the polymerization reaction of the photopolymerizable polyfunctional monomer or polyfunctional oligomer, a photopolymerization initiator is preferably used, and the photopolymerization initiator is preferably a photoradical polymerization initiator or a photocationic polymerization initiator, more preferably a photoradical polymerization initiator.

In the present invention, a polymer or a crosslinked polymer can be used in combination as the binder. The crosslinked polymer preferably has an anionic group. The crosslinked polymer having an anionic group has a structure that the main chain of the polymer having an anionic group is crosslinked.

Examples of the polymer main chain include a polyolefin (saturated hydrocarbon), a polyether, a polyurea, a polyurethane, a polyester, a polyamine, a polyamide and a melamine resin. A polyolefin main chain, a polyether main chain and a polyurea main chain are preferred, a polyolefin main chain and a polyether main chain are more preferred, and a polyolefin main chain is most preferred.

The polyolefin main chain comprises a saturated hydrocarbon. The polyolefin main chain is obtained, for example, by the addition polymerization reaction of an unsaturated polymerizable group. In the polyether main chain, repeating units are bonded through an ether bond (—O—). The polyether main chain is obtained, for example, by the ring-opening polymerization reaction of an epoxy group. In the polyurea main chain, repeating units are connected through a urea bond (—NH—CO—NH—). The polyurea main chain is obtained, for example, by the condensation polymerization reaction of an isocyanate group and an amino group. In the polyurethane main chain, repeating units are connected through a urethane bond (—NH—CO—O—). The polyurethane main chain is obtained, for example, by the condensation polymerization reaction of an isocyanate group and a hydroxyl group (including an N-methylol group). In the polyester main chain, repeating units are connected through an ester bond (—CO—O—). The polyester main chain is obtained, for example, by the condensation polymerization reaction of a carboxyl group (including an acid halide group) and a hydroxyl group (including an N-methylol group). In the polyamine main chain, repeating units are connected through an imino bond (—NH—). The polyamine main chain is obtained, for example, by the ring-opening polymerization reaction of an ethyleneimine group. In the polyamide main chain, repeating units are connected through an amide bond (—NH—CO—). The polyamide main chain is obtained, for example, by the reaction of an isocyanate group and a carboxyl group (including an acid halide group). The melamine resin main chain is obtained, for example, by the condensation polymerization reaction of a triazine group (e.g., melamine) and an aldehyde (e.g., formaldehyde). In the melamine resin, the main chain itself has a crosslinked structure.

The anionic group is bonded directly to the main chain of the polymer or bonded to the main chain through a linking group. The anionic group is preferably bonded as a side chain to the main chain through a linking group.

Examples of the anionic group include a carboxylic acid group (carboxyl), a sulfonic acid group (sulfo) and a phosphoric acid group (phosphono), with a sulfonic acid group and a phosphoric acid group being preferred.

The anionic group may be in a salt state. The cation forming a salt with the anionic group is preferably an alkali metal ion. The proton of the anionic group may be dissociated.

The linking group connecting the anionic group and the polymer main chain is preferably a divalent group selected from —CO—, —O—, an alkylene group, an arylene group and a combination thereof.

The crosslinked structure has two or more chemically bonded (preferably covalently bonded) main chains and preferably has three or more covalently bonded main chains. The crosslinked structure preferably comprises a divalent or greater group selected from —CO—, —O—, —S—, a nitrogen atom, a phosphorus atom, an aliphatic residue, an aromatic residue and a combination thereof.

The crosslinked polymer having an anionic group is preferably a copolymer containing a repeating unit having an anionic group and a repeating unit having a crosslinked structure. The proportion of the repeating unit having an anionic group in the copolymer is preferably from 2 to 96 mass%, more preferably from 4 to 94 mass %, and most preferably from 6 to 92 mass %. The repeating unit may have two or more anionic groups. The proportion of the repeating unit having a crosslinked structure in the copolymer is preferably from 4 to 98 mass %, more preferably from 6 to 96 mass %, and most preferably from 8 to 94 mass %.

The repeating unit of the crosslinked polymer having an anionic group may have both an anionic group and a crosslinked structure. Also, other repeating units (a repeating unit having neither an anionic group nor a crosslinked structure) may be contained.

The other repeating units are preferably a repeating unit having an amino group or a quaternary ammonium group and a repeating unit having a benzene ring. The amino group or quaternary ammonium group has a function of maintaining the dispersed state of inorganic particles similarly to the anionic group. Incidentally, the same effects are obtained even when the amino group, quaternary ammonium group or benzene ring is contained in the repeating unit having an anionic group or in the repeating unit having a crosslinked structure.

In the repeating unit having an amino group or a quaternary ammonium group, the amino group or quaternary ammonium group is bonded directly to the main chain of the polymer or bonded to the main chain through a linking group. The amino group or quaternary ammonium group is preferably bonded as a side chain to the main chain through a linking group. The amino group or quaternary ammonium group is preferably a secondary amino group, a tertiary amino group or a quaternary ammonium group, more preferably a tertiary amino group or a quaternary ammonium group. The group bonded to the nitrogen atom of the secondary amino group, tertiary amino group or quaternary ammonium group is preferably an alkyl group, more preferably an alkyl group having a carbon number of 1 to 12, still more preferably an alkyl group having a carbon number of 1 to 6. The counter ion of the quaternary ammonium group is preferably halide ion. The linking group connecting the amino group or quaternary ammonium group and the polymer main chain is preferably a divalent group selected from —CO—, —NH—, —O—, an alkylene group, an arylene group and a combination thereof. In the case where the crosslinked polymer having an anionic group contains a repeating unit having an amino group or a quaternary ammonium group, the proportion of the repeating unit is preferably from 0.06 to 32 mass %, more preferably from 0.08 to 30 mass %, and most preferably from 0.1 to 28 mass %.

In the binder of the hardcoat layer, for the purpose of controlling the refractive index of the hardcoat layer, a high refractive index monomer, an inorganic particle such as ZrO₂, TiO₂ and SiO₂, or both may be added. The inorganic particle has an effect of suppressing the curing shrinkage due to a crosslinking reaction, in addition to the effect of controlling the refractive index. In the present invention, a polymer produced by the polymerization of the above-described polyfunctional monomer and/or high refractive index monomer or the like after the formation of the hardcoat layer is, including the inorganic particle dispersed therein, referred to as a binder.

The haze of the hardcoat layer differs depending on the function imparted to the antireflection film. In the case of imparting an antiglare function by the effect of surface scattering of the hardcoat layer in addition to the function of suppressing the reflectance on the surface, the surface haze is preferably 7% or less, more preferably 5% or less, and most preferably less than 3%.

Also, in the case of imparting a function of making less perceivable the liquid crystal panel pattern, color unevenness, brightness unevenness or glaring by the effect of internal scattering of the hardcoat layer or a function of enlarging the viewing angle by the effect of scattering, the internal haze value (a value obtained by subtracting the surface haze value from the entire haze value) is preferably from 20 to 80%, more preferably form 35 to 75%, and most preferably from 50 to 70%.

In the film of the present invention, the surface haze and internal haze may be freely set according to the purpose.

As for the surface irregularity shape of the hardcoat layer, out of the properties indicating the surface roughness, for example, the centerline average roughness (Ra) is preferably set to 0.10 μm or less so as to maintain the clearness of image and obtain a clear surface. Ra is more preferably 0.07 μm or less, still more preferably less than 0.05 μm. In the film of the present invention, the surface irregularities of the film are mainly governed by the surface irregularities of the hardcoat layer and by adjusting the centerline average roughness of the hardcoat layer, the antireflection film can be made to have a centerline average roughness within the above-described range.

### (Light-Transparent Particle)

In the hardcoat layer for use in the present invention, a light-transparent organic resin particle is used so as to impart antiglare property (surface scattering property) or internal scattering property.

The light-transparent organic resin particle for use in the hardcoat layer of the present invention is preferably a light-transparent organic resin particle in which the particle surface is covered with a metal oxide. When the surface is covered with a metal oxide, the weather resistance is enhanced and good dispersibility in an organic solvent is obtained. Specific examples of the metal oxide include ZrO₂, SiO₂, Al₂O₃, In₂O₃, ZnO, SnO₂ and Sb₂O₃. Among these, SiO₂ is inexpensive and preferred. As for the surface coat SiO₂, a colloidal silica having an average particle diameter of 5 to 70 nm may be coated by the method disclosed in JP-A-2002-327036. The thickness of the metal oxide coat layer on the particle surface is preferably 400 nm or less.

Example of the light-transparent organic resin include a polymethyl methacrylate particle (refractive index: 1.49), a crosslinked poly(acryl-styrene) copolymer particle (refractive index: 1.54), a melamine resin particle (refractive index: 1.57 to 1.65), a polycarbonate particle (refractive index: 1.57), a polystyrene particle (refractive index: 1.60), a crosslinked polystyrene particle (refractive index: 1.61), a polyvinyl chloride particle (refractive index: 1.60) and a benzoguanamine-melamine formaldehyde particle (refractive index: 1.68).

The internal haze, surface haze and centerline average roughness of the present invention can be achieved by adjusting the refractive index of the binder according to the refractive index of the light-transparent organic resin particle selected from those particles above.

In the case of using a binder (refractive index after curing: 1.50 to 1.53) mainly comprising a trifunctional or greater (meth)acrylate monomer, a light-transparent particle comprising a benzoguanamine-melamine formamide particle (refractive index: 1.68) or a melamine formaldehyde particle (refractive index: 1.65) is preferably used in combination. In particular, a combination of the binder and a melamine resin particle (refractive index: 1.65) with the surface being covered by silica are preferred.

In the case of such a light-transparent organic resin particle, an inorganic filler such as silica may be added in the binder so as to prevent the precipitation. As the amount of the inorganic filler added is larger, this is effective for preventing the precipitation of the light-transparent organic resin particle but gives an adverse effect on the transparency of the coating film. Accordingly, an organic filler having a particle diameter of 0.5 μm or less is preferably contained in the binder to an extent not impairing the transparency of the coating film, that is, in an mount of approximately less than 0.1 mass %.

The average particle diameter of the light-transparent organic resin particle is preferably from 0.5 to 7 μm, more preferably from 1.0 to 5.0 μm, still more preferably from 1.2 to 2.5 μm. If the average particle diameter is less than 0.5 μm, the distribution of light scattering angle extends to a wide angle and the character blurring of the display is disadvantageously brought about, whereas if it exceeds 7 μm, the thickness of the layer to which the light-transparent organic resin particle is added must be increased and this causes a problem such as curl or rise in cost.

Two or more kinds of light-transparent particles differing in the particle diameter may be used in combination. The ratio between the number of light-transparent organic resin particles having a particle diameter of 2.5 μm or less and the number of light-transparent particles having an average particle diameter of 3 μm, per unit area, is preferably 3 times or more, more preferably 5 times or more. The light-transparent particle having an average particle diameter of 3 μm or more can impart an antiglare property, and the light-transparent organic resin particle having a smaller particle diameter can reduce the roughened texture on the surface. The light-transparent particle of 3 μm or more may be either an organic particle or an inorganic particle. The inorganic particle includes an oxide of at least one metal selected from silicon, zirconium, titanium, aluminum, indium, zinc, tin and antimony, and specific examples thereof include ZrO₂, TiO₂, Al₂O₃, In₂O₃, ZnO, SnO₂, Sb₂O₃ and ITO. Other examples include BaSO₄, CaCO₃, talc and kaolin.

The light-transparent organic resin particle is blended to account for 5 to 40 mass %, preferably from 5 to 25 mass %, more preferably from 7 to 20 mass %, in the entire solid content of the layer to which the light-transparent organic resin particle is added. If the content of the light-transparent organic resin particle is less than 3 mass %, the effect expected by the addition is insufficient, whereas if it exceeds 40 mass %, there arises a problem such as image blurring or surface clouding or glaring.

The coated amount of the light-transparent organic resin particle is preferably from 30 to 2,500 mg/m², more preferably from 100 to 2,400 mg/m², still more preferably from 600 to 2,300 mg/m².

The compressive strength of the organic resin particle for use in the present invention is preferably from 2 to 10 kgf/mm², more preferably from 4 to 9 kgf/mm², still more preferably from 5 to 8 kgf/mm². Within this range, the organic resin particle can contribute to increasing the film hardness, and particle breakage due to worsened brittleness less occurs.

The compressive strength means a compressive strength when the particle diameter is 10% deformed. The compressive strength when the particle diameter is 10% deformed is a particle compressive strength (S10 strength), and this is a value obtained by performing a compression test of a resin particle alone up to a load of 1 gf with use of a micro-compression tester, MCT W201, manufactured by Shimadzu Corp., and introducing the load when causing 10% deformation of the particle diameter and the particle diameter before compression into the following formula:

S10 strength (kgf/mm²)=2.8×load (kgf)/{(π×particle diameter (mm)×particle diameter (mm))

### <Preparation and Classification of Light-Transparent Particle>

Examples of the production method of the light-transparent particle for use in the present invention include a suspension polymerization method, an emulsion polymerization method, a soap-free emulsion polymerization method, a dispersion polymerization method and a seed polymerization method, and the light-transparent particle may be produced by any of these methods. These production methods may be performed by referring to the methods described, for example, in Takayuki Ohtsu and Masaetsu Kinoshita, Kobunshi Gosei no Jikken Ho (Experimental Technique for the Synthesis of Polymer), page 130 and pages 146 to 147, Kagaku Dojin Sha, Gosei Kobunshi (Synthetic Polymer), Vol. 1, pp. 246-290, ibid., Vol. 3, pp. 1-108, U.S. Pat. Nos. 2,543,503, 3,508,304, 2,746,275, 3,521,560 and 3,580,320, JP-A-10-1561, JP-A-7-2908, JP-A-5-297506 and JP-A-2002-145919.

As for the particle size distribution of the light-transparent particle, in view of the control of haze value and diffusing property and the homogeneity of coated surface state, a monodisperse particle is preferred. The CV value (standard deviation of particle diameter/average particle diameter) standing for the uniformity of particle diameter is preferably less than 10%, more preferably from 0 to 8%, still more preferably from 0 to 5%. Also, when a particle having a particle diameter 20% or more larger than the average particle diameter is defined as a coarse particle, the proportion of this coarse particle is preferably 1% or less, more preferably 0.1% or less, still more preferably 0.01% or less, based on the number of all particles. For obtaining a particle having such a particle size distribution, classification after preparation or synthesis reaction is effective and by increasing the number of classifications or elevating the level of classification, a particle having a desired distribution can be obtained.

The classification is preferably performed using a method such as air classification, centrifugal classification, precipitation classification, filtration classification and electrostatic classification.

In the measurement of the CV value, the particle size distribution is measured by an existing particle size distribution measuring meter such as Coulter counter, and the measured distribution is converted into the standard deviation of the particle diameter. The average particle diameter is calculated from the measured particle size distribution, and the CV value is determined using the values obtained.

### [Low Refractive Index Layer]

In the low refractive index layer of the present invention, a fluorine-containing copolymer compound may be preferably used. Examples of the fluorine-containing vinyl monomer include fluoroolefins (e.g., fluoroethylene, vinvlidene fluoride, tetrafluoroethylene, hexafluoropropylene), partially or completely fluorinated alkyl ester derivatives of (meth)acrylic acid (e.g., BISCOTE 6FM (trade name, produced by Osaka Organic Chemical Industry Ltd.), R-2020 (trade name, produced by Daikin Industries, Ltd.)), and completely or partially fluorinated vinyl ethers. Among these, perfluoroolefins are preferred, and hexafluoropropylene is more preferred in view of refractive index, solubility, transparency, availability and the like. When the compositional ratio of the fluorine-containing vinyl monomer is increased, the refractive index may be lowered but the film strength decreases. In the present invention, the fluorine-containing vinyl monomer is preferably introduced such that the copolymer has a fluorine content of 20 to 60 mass %, more preferably from 25 to 55 mass %, still more preferably from 30 to 50 mass %.

The constituent unit for imparting crosslinking reactivity mainly includes the following units (A), (B) and (C):

(A): a constituent unit obtained by the polymerization of a monomer previously having a self-crosslinking functional group within the molecule, such as glycidyl (meth)acrylate and glycidyl vinyl ether,

(B) a constituent unit obtained by the polymerization of a monomer having a carboxyl group, a hydroxyl group, an amino group, a sulfo group or the like, such as (meth)acrylic acid, methylol(meth)acrylate, hydroxyalkyl(meth)acrylate, allyl acrylate, hydroxyethyl vinyl ether, hydroxybutyl vinyl ether, maleic acid and crotonic acid, and

(C) a constituent unit obtained by reacting a compound having a group capable of reacting with the functional group of (A) or (B) above within the molecule and separately having a crosslinking functional group, with the constituent unit of (A) or (B) above (for example, a constituent unit which can be synthesized by a technique such as causing an acrylic acid chloride to act on a hydroxyl group).

In the constituent unit of (C), the crosslinking functional group is preferably a photopolymerizable group. Examples of the photopolymerizable group include a (meth)acryloyl group, an alkenyl group, a cinnamoyl group, a cinnamylideneacetyl group, a benzalacetophenone group, a styrylpyridine group, an a-phenylmaleimide group, a phenyl-azide group, a sulfonylazide group, a carbonylazide group, a diazo group, an o-quinonediazide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group and an azadioxabicyclo group. Only one of these groups or two or more species thereof may be contained. Among these, a (meth)acryloyl group and a cinnamoyl group are preferred, and a (meth)acryloyl group is more preferred.

The specific method for preparing the photopolymerizable group-containing copolymer includes, but is not limited to, the following methods:

a. a method of reacting a (meth)acrylic acid chloride with a crosslinking functional group-containing copolymer having a hydroxyl group, thereby effecting esterification,

b. a method of reacting a (meth)acrylic acid ester having an isocyanate group with a crosslinking functional group-containing copolymer having a hydroxyl group, thereby effecting urethanization,

c. a method of reacting a (meth)acrylic acid with a crosslinking functional group-containing copolymer having an epoxy group, thereby effecting esterification, and

d. a method of reacting a (meth)acrylic acid ester having an epoxy group with a crosslinking functional group-containing copolymer having a carboxyl group, thereby effecting esterification.

The amount of the photopolymerizable group introduced can be arbitrarily controlled and from the standpoint of, for example, stabilizing the coated film surface state, reducing the surface state failure when an inorganic particle is present together, or enhancing the film strength, it is also preferred to leave a fixed amount of carboxyl group, hydroxyl group or the like.

In the copolymer useful for the present invention, in addition to the repeating unit derived from the fluorine-containing vinyl monomer and the repeating unit having a (meth)acryloyl group in the side chain, other vinyl monomers may be appropriately copolymerized from various viewpoints such as adhesion to substrate, Tg (contributing to film hardness) of polymer, solubility in solvent, transparency, slipperiness, dust resistance and antifouling property. A plurality of these vinyl monomers may be used in combination according to the purpose, and these monomers are preferably introduced to account for, in total, from 0 to 65 mol %, more preferably from 0 to 40 mol %, still more preferably from 0 to 30 mol %, in the copolymer.

The vinyl monomer unit which can be used in combination is not particularly limited, and examples thereof include olefins (e.g., ethylene, propylene, isoprene, vinyl chloride, vinylidene chloride), acrylic acid esters (e.g., methyl acrylate, methyl acrylate, ethyl acrylate, 2-ethylhexyl acrylate, 2-hydroxyethyl acrylate), methacrylic acid esters (e.g., methyl methacrylate, ethyl methacrylate, butyl methacrylate, 2-hydroxyethyl methacrylate), styrene derivatives (e.g., styrene, p-hydroxymethylstyrene, p-methoxystyrene), vinyl ethers (e.g., methyl vinyl ether, ethyl vinyl ether, cyclohexyl vinyl ether, hydroxyethyl vinyl ether, hydroxybutyl vinyl ether), vinyl esters (e.g., vinyl acetate, vinyl propionate, vinvi cinnamate), unsaturated carboxylic acids (e.g., acrylic acid, methacrylic acid, crotonic acid, maleic acid, itaconic acid), acrylamides (e.g., N,N-dimethylacrylamide, N-tert-butylacrylamide, N-cyclohexylacrylamide), methacrylamides (e.g., N,N-dimethylmethacrylamide), and acrylonitrile.

The fluorine-containing polymer particularly useful in the present invention is a random copolymer of a perfluoroolefin and a vinyl ether or vinyl ester. In particular, the fluorine-containing polymer preferably has a group capable of undergoing a crosslinking reaction by itself (for example, a radical reactive group such as (meth)acryloyl group, or a ring-opening polymerizable group such as epoxy group and oxetanyl group). The crosslinking reactive group-containing polymerization unit preferably occupies from 5 to 70 mol %, more preferably from 30 to 60 mol %, in all polymerization units of the polymer. Preferred examples of the polymer include those described in JP-A-2002-243907, JP-A-2002-372601, JP-A-2003-26732, JP-A-2003-222702, JP-A-2003-294911, JP-A-2003-329804, JP-A-2004-4444 and JP-A-2004-45462.

For the purpose of imparting antifouling property, a polysiloxane structure is preferably introduced into the fluorine-containing polymer for use in the present invention. The method for introducing a polysiloxane structure is not limited, but preferred examples thereof include a method of introducing a polysiloxane block copolymerization component by using a silicone macroazo initiator described in JP-A-6-93100, JP-A-11-189621, JP-A-11-228631 and JP-A-2000-313709, and a method of introducing a polysiloxane graft copolymerization component by using a silicone macromer described in JP-A-2-251555 and JP-A-2-308806. Particularly preferred compounds include the polymers in Examples 1, 2 and 3 of JP-A-11-189621, and Copolymers A-2 and A-3 of JP-A-2-251555. The content of the polysiloxane component in the polymer is preferably from 0.5 to 10 mass %, more preferably from 1 to 5 mass %.

The molecular weight of the polymer which can be preferably used in the present invention is, in terms of the mass average molecular weight, preferably 5,000 or more, more preferably from 10,000 to 500,000, and most preferably from 15,000 to 200,000. It is also possible to improve the coating film surface state or scratch resistance by using polymers differing in the average molecular weight in combination.

A curing agent having a polymerizable unsaturated group described in JP-A-10-25388 and JP-A-2000-17028 may be appropriately used in combination with the above-described polymer. Also, as described in JP-A-2002-145952, use in combination of a compound having a fluorine-containing polyfunctional polymerizable unsaturated group is preferred. Examples of the compound having a polyfunctional polymerizable unsaturated group include the polyfunctional monomers described above for the hardcoat layer. Such a compound is preferred because a large effect on the improvement of scratch resistance is provided by its use in combination particularly when a compound having a polymerizable unsaturated group is used for the polymer main body.

The refractive index of the low refractive index layer is preferably from 1.20 to 1.46, more preferably from 1.25 to 1.42, still more preferably from 1.30 to 1.38.

The thickness of the low refractive index layer is preferably from 50 to 150 nm, more preferably from 70 to 120 nm.

The fine particle which can be preferably used in the low refractive index layer of the present invention is described below.

The coated amount of the fine particle is preferably from 1 to 100 mg/m², more preferably from 5 to 80 mg/m², still more preferably from 10 to 70 mg/m². If the coated amount is too small, the effect of improving the scratch resistance may decrease, whereas if it is excessively large, fine irregularities may be generated on the low refractive index layer surface to deteriorate the outer appearance or integrated reflectance. The fine particle is incorporated into the low refractive index layer and therefore, preferably has a low refractive index.

Specifically, a metal oxide fine particle, hollow metal oxide fine particle or hollow organic resin fine particle having a low refractive index is preferred. Examples thereof include a silica fine particle and a hollow silica fine particle. The average particle diameter of the fine particle for use in the low refractive index layer is preferably from 15 to 150%, more preferably from 25 to 100%, still more preferably from 35 to 70%, of the thickness of the low refractive index layer. In other words, when the thickness of the low refractive index layer is 100 nm, the particle diameter of the fine particle is preferably from 15 to 150 nm, more preferably from 25 to 100 nm, still more preferably from 35 to 60 nm. For obtaining high scratch resistance, preferably, a metal oxide particle is contained in all layers of the optical film, and most preferably, a silica particle is contained in all layers of the optical film.

As described above, if the particle diameter of the (hollow) silica fine particle is too small, the effect of improving the scratch resistance may decrease, whereas if it is excessively large, fine irregularities may be generated on the low refractive index layer surface to deteriorate the outer appearance or integrated reflectance. The (hollow) silica fine particle may be either crystalline or amorphous and may be a monodisperse particle or an aggregate particle (in this case, the secondary particle diameter is preferably from 15 to 150% of the thickness of the low refractive index layer). Also, a plurality of two or more kinds of particles (differing in the kind or particle diameter) may be used. The shape is most preferably spherical but even if an indefinite form, there arises no problem.

In order to reduce the refractive index of the low refractive index layer, a hollow silica fine particle is preferably used. The refractive index of the hollow silica fine particle is preferably from 1.15 to 1.40, more preferably from 1.17 to 1.35, still more preferably from 1.17 to 1.30. The refractive index as used herein indicates the refractive index of the particle as a whole and does not indicate the refractive index of only the outer shell silica forming the hollow silica fine particle. At this time, assuming that the radius of the cavity inside the particle is a and the radius of the outer shell of the particle is b, the porosity x is calculated according to the following mathematical formula (I):

x=(4πa³/3)/(4πb³/3)×100 Mathematical Formula (I)

The porosity x is preferably from 10 to 70%, more preferably from 20 to 60%, and most preferably from 30 to 60%. If the hollow silica particle is made to have a lower refractive index and a higher porosity, the thickness of the outer shell becomes small and the strength as a particle decreases. Therefore, in view of the scratch resistance, a particle having a low refractive index of less than 1.15 is not so suitable. Incidentally, the refractive index of the hollow silica particle was measured by an Abbe refractometer (manufactured by ATAGO K. K.).

In the present invention, from the standpoint of enhancing the antifouling property, the surface free energy on the low refractive index layer surface is preferably reduced. Specifically, a fluorine-containing compound or a compound having a polysiloxane structure is preferably used in the low refractive index layer.

As for the additive having a polysiloxane structure, addition of a reactive group-containing polysiloxane (for example, KF-100T, X-22-169AS, KF-102, X-22-3701IE, X-22-164B, X-22-5002, X-22-173B, X-22-174D, X-22-167B, X-22-161AS (trade names, all produced by Shin-Etsu Chemical Co., Ltd.), AK-5, AK-30, AK-32 (trade names, all produced by Toagosei Chemical Industry Co., Ltd.), SILAPLANE FM0725, SILAPLANE FM0721 (trade names, both produced by Chisso Corp.)) is also preferred. Furthermore, the silicone-based compounds described in Tables 2 and 3 of JP-A-2003-112383 may also be preferably used. Such a polysiloxane is preferably added in an amount of 0.1 to 10 mass %, more preferably from 1 to 5 mass %, based on the entire solid content of the low refractive index layer.

### [Components Contained in Hardcoat Layer and/or Low Refractive Index Layer]

### (Organosilane Compound)

In view of scratch resistance, at least one layer out of the layers constituting the optical film of the present invention preferably contains at least one component selected from a hydrolysate of organosilane compound and/or a partial condensate of the hydrolysate, that is, so-called sol component (hereinafter, sometimes referred to in this way). Particularly, in the case of an optical film having a low refractive index layer, the sol component is preferably incorporated into the low refractive index layer so as to satisfy both the antireflection performance and the scratch resistance. This sol component forms a cured product by undergoing condensation during drying and heating after coating and works out to a part of the binder in the low refractive index layer. Furthermore, in the case where the cured product has a polymerizable unsaturated bond, a binder having a three-dimensional structure is formed upon irradiation of actinic rays.

The organosilane compound is preferably an organosilane compound represented by the following formula 1:

(R1)ₘ—Si (X)₄₋ₘ Formula 1

In formula 1, R1 represents a substituted or unsubstituted alkyl group or a substituted or unsubstituted aryl group. The alkyl group is preferably an alkyl group having a carbon number of 1 to 30, more preferably from 1 to 16, still more preferably from 1 to 6. Specific examples of the alkyl group include methyl, ethyl, propyl, isopropyl, hexyl, decyl and hexadecyl. Examples of the aryl group include phenyl and naphthyl, with a phenyl group being preferred.

X represents a hydroxyl group or a hydrolyzable group. Examples of the hydrolyzable group include an alkoxy group (preferably an alkoxy group having a carbon number of 1 to 5, e.g., methoxy, ethoxy), a halogen atom (e.g., Cl, Br, I) and a group represented by R2COO (wherein R2 is preferably a hydrogen atom or an alkyl group having a carbon number of 1 to 6; e.g., CH₃COO, C₂H₅COO). Among these, an alkoxy group is preferred, and a methoxy group and an ethoxy group are more preferred.

m represents an integer of 1 to 3 and is preferably 1 or 2.

When a plurality of X's are present, the plurality of X's may be the same or different. The substituent contained in R1 is not particularly limited, but examples thereof include a halogen atom (e.g., fluorine, chlorine, bromine), a hydroxyl group, a mercapto group, a carboxyl group, an epoxy group, an alkyl group (e.g., methyl, ethyl, i-propyl, propyl, tert-butyl), an aryl group (e.g., phenyl, naphthyl), an aromatic heterocyclic group (e.g., furyl, pyrazolyl, pyridyl), an alkoxy group (e.g., methoxy, ethoxy, i-propoxy, hexyloxy), an aryloxy group (e.g., phenoxy), an alkylthio group (e.g., methylthio, ethylthio), an arylthio group (e.g., phenylthio), an alkenyl group (e.g., vinyl, 1-propenyl), an acyloxy group (e.g., acetoxy, acryloyloxy, methacryloyloxy), an alkoxycarbonyl group (e.g., methoxycarbonyl, ethoxycarbonyl), an aryloxycarbonyl group (e.g., phenoxycarbonyl), a carbamoyl group (e.g., carbamoyl, N-methylcarbamoyl, N,N-dimethylcarbamoyl, N-methyl-N-octylcarbamoyl), and an acylamino group (e.g., acetylamino, benzoylamino, acrylamino, methacrylamino). These substituents each may be further substituted.

R1 is preferably a substituted alkyl group or a substituted aryl group.

An organosilane compound having a vinyl polymerizable substituent represented by the following formula 2 is also preferred.

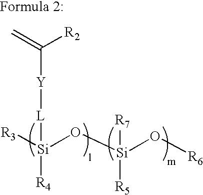

In formula 2, R₂ represents a hydrogen atom, a methyl group, a methoxy group, an alkoxycarbonyl group, a cyano group, a fluorine atom or a chlorine atom. Examples of the alkoxycarbonyl group include a methoxycarbonyl group and an ethoxycarbonyl group. R₂ is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, still more preferably a hydrogen atom or a methyl group.

Y represents a single bond, *—COO—**, *—CONH—** or *—O—** and is preferably a single bond, *—COO—** or *—CONH—**, more preferably a single bond or *—COO—**, still more preferably *—COO—**. * denotes the position bonded to ═C(R₂)— and ** denotes the position bonded to L.

L represents a divalent linking chain. Specific examples thereof include a substituted or unsubstituted alkylene group, a substituted or unsubstituted arylene group, a substituted or unsubstituted alkylene group having in the inside thereof a linking group (e.g., ether, ester, amido), and a substituted or unsubstituted arylene group having in the inside thereof a linking group. Among these, preferred are a substituted or unsubstituted alkylene group, a substituted or unsubstituted arylene group, and an alkylene group having in the inside thereof a linking group, more preferred are an insubstituted alkylene group, an unsubstituted arylene group and an alkylene group having in the inside thereof an ether or ester linking group, and still more preferred are an unsubstituted alkylene group and an alkylene group having in the inside thereof an ether or ester linking group. Examples of the substituent include a halogen, a hydroxyl group, a mercapto group, a carboxyl group, an epoxy group, an alkyl group and an aryl group. These substituents each may be further substituted.

1 (which represents a number satisfying the mathematical formula: 1=100−m) and m each represents a molar ratio. m represents a number of 0 to 50, and m is preferably a number of 0 to 40, more preferably a number of 0 to 30.

R₃ to R₆ each is preferably a halogen atom, a hydroxyl group, an unsubstituted alkoxy group or an unsubstituted alkyl group. R₃ to R₅ each is more preferably a chlorine atom, a hydroxyl group or an unsubstituted alkoxy group having a carbon number of 1 to 6, still more preferably a hydroxyl group or an alkoxy group having a carbon number of 1 to 3, yet still more preferably a hydroxyl group or a methoxy group.

R₆ represents a hydrogen atom, an alkyl group, an alkoxy group, an alkoxycarbonyl group, a cyano group, a fluorine atom or a chlorine atom. Examples of the alkyl group include a methyl group and an ethyl group; examples of the alkoxy group include a methoxy group and an ethoxy group; and examples of the alkoxycarbonyl group include a methoxycarbonyl group and an ethoxycarbonyl group. R₆ is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, still more preferably a hydrogen atom or a methyl group. R₇ has the same meaning as R1 in formula 1 and is preferably a hydroxyl group or an unsubstituted alkyl group, more preferably a hydroxyl group or an alkyl group having a carbon number of 1 to 3, still more preferably a hydroxyl group or a methyl group.

Two or more kinds of the compounds represented by formula 1 may be used in combination. In particular, the compound of formula 2 is synthesized using at least one kind of the compound of formula 1 as the starting material. Specific examples of the compound represented by formula 1 and the starting material for the compound represented by formula 2 are set forth below, but the present invention is not limited thereto.

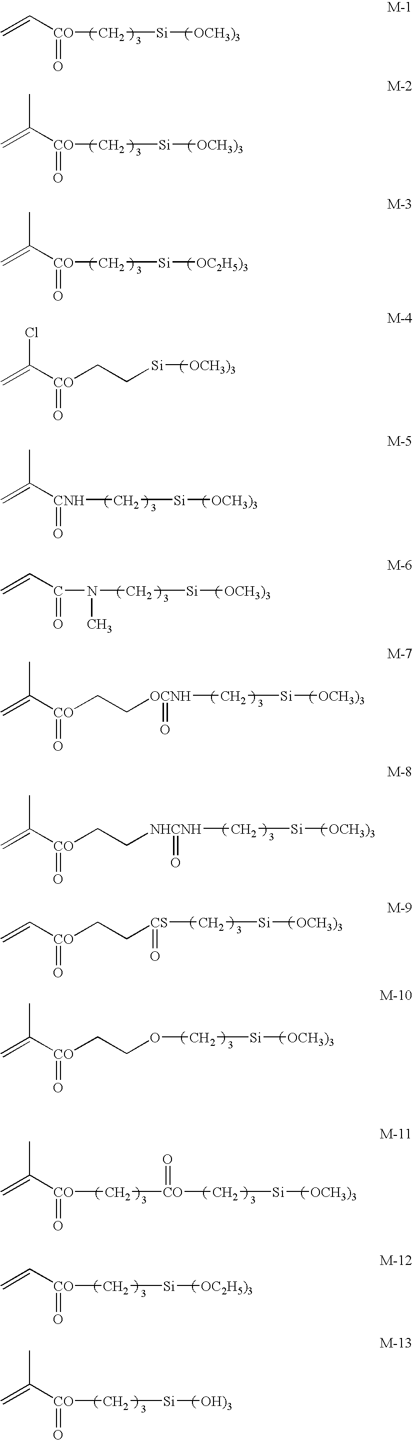

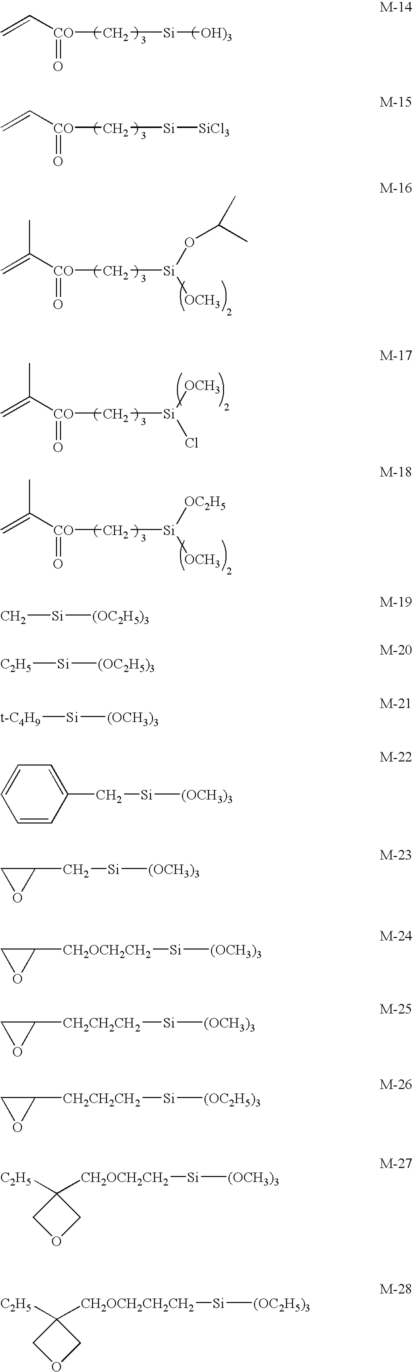

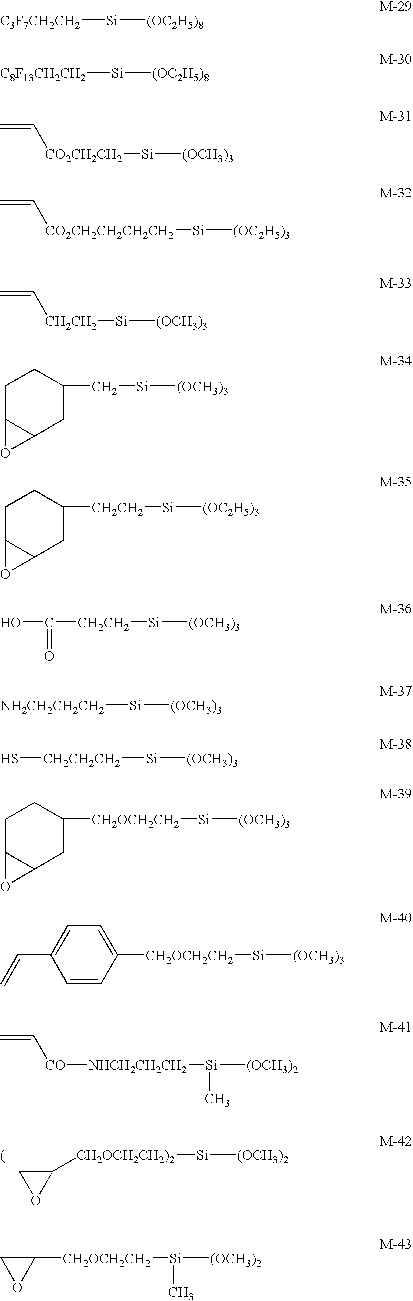

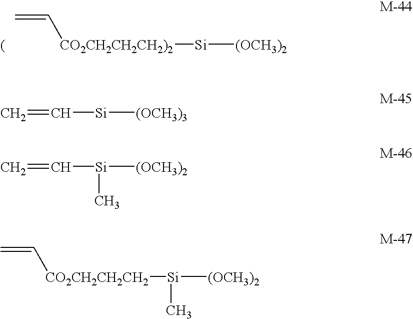

### M-48 Methyltrimethoxysilane

Among these, (M-1), (M-2) and (M-25) are preferred as the organosilane containing a polymerizable group.

In order to obtain the effect of the present invention, the content of the vinyl polymerizable group-containing organosilane in the hydrolysate of organosilane and/or the partial condensate thereof is preferably from 30 to 100 mass %, more preferably from 50 to 100 mass %, still more preferably from 70 to 95 mass %. If the content of the vinyl polymerizable group-containing organosilane is less than 30 mass %, this is disadvantageous in that production of a solid matter, clouding of the liquid, worsening of the pot life or difficult control of the molecular weight (increase of molecular weight) may be caused or when a polymerization treatment is performed, the performance (for example, scratch resistance of antireflection film) may be hardly enhanced due to small content of the polymerizable group. In the synthesis of the compound represented by formula 2, at least one organosilane containing a vinyl polymerizable group, selected from (M-1) and (M-2), and at least one organosilane having no vinyl polymerizable group, selected from (M-19) to (M-21) and (M-48), are preferably used in combination each in the above-described amount.

At least either one of the hydrolysate of organosilane of the present invention and the partial condensate thereof is preferably reduced in the volatility so as to stabilize the performance of the coated product. Specifically, the volatilization volume per hour at 105° C. is preferably 5 mass % or less, more preferably 3 mass % or less, still more preferably 1 mass % or less.

The sol component for use in the present invention is prepared by the hydrolysis of the above-described organosilane and/or the partial condensation thereof.

The hydrolysis and condensation reaction is performed by adding water in an amount of 0.05 to 2.0 mol, preferably from 0.1 to 1.0 mol, per mol of the hydrolyzable group (X) and stirring the resulting solution at 25 to 100° C. in the presence of a catalyst for use in the present invention.

In at least either one of the hydrolysate of the organosilane of the present invention and the partial condensate thereof, either the hydrolysate of the vinyl polymerizable group-containing organosilane or the partial condensate thereof preferably has a weight average molecular weight of 450 to 20,000, more preferably from 500 to 10,000, still more preferably from 550 to 5,000, yet still more preferably from 600 to 3,000, excluding the components having a molecular weight of less than 300.

Out of the components having a molecular weight of 300 or more in the hydrolysate of the organosilane and/or the partial condensate thereof, the content of the components having a molecular weight of more than 20,000 is preferably 10 mass % or less, more preferably 5 mass % or less, still more preferably 3 mass % or less. If this content exceeds 10 mass %, the cured film obtained by curing a curable composition containing such a hydrolysate of the organosilane and/or a partial condensate thereof may have poor transparency or poor adhesion to the substrate.

Here, the weight average molecular weight and the molecular weight are a molecular weight determined by the differential refractometer detection with a solvent THF in a GPC analyzer using a column of TSKgel GMHxL, TSKgel G4000HxL or TSKgel G2000HxL (trade names, all produced by Tosoh Corp.) and expressed in terms of polystyrene. The content is an area % of the peaks in the above-described molecular weight range, assuming that the peak area of the components having a molecular weight of 300 or more is 100%.

The dispersity (weight average molecular weight/number average molecular weight) is preferably from 3.0 to 1.1, more preferably from 2.5 to 1.1, still more preferably from 2.0 to 1.1, yet still more preferably from 1.5 to 1.1.

The state of X in formula 1 being condensed in the form of —OSi can be confirmed by the ²⁹Si—NMR analysis of the hydrolysate of the organosilane of the present invention or the partial condensate thereof.

At this time, assuming that the case where three bonds of Si are condensed in the form of —OSi is (T3), the case where two bonds of Si are condensed in the form of —OSi is (T2), the case where one bond of Si is condensed in the form of —OSi is (T1) and the case where Si is not condensed at all is (T0), the condensation rate α is represented by:

α=(T3×3+T2×2+T1×1)/3/(T3+T2+T1+T0) Mathematical Formula (II)

The condensation rate is preferably from 0.2 to 0.95, more preferably from 0.3 to 0.93, still more preferably from 0.4 to 0.9.

If the condensation rate is less than 0.1, the hydrolysis or condensation proceeds insufficiently and due to increase in the monomer component, insufficient curing results, whereas if it exceeds 0.95, the hydrolysis or condensation excessively proceeds and since the hydrolyzable group is consumed out, the interaction of binder polymer, resin substrate, inorganic fine particle and the like is decreased, as a result, the effect can be hardly obtained even when these are used.

The hydrolysate of the organosilane compound and the partial condensate thereof used in the present invention are described in detail below.

The hydrolysis reaction of the organosilane and the subsequent condensation reaction are generally performed in the presence of a catalyst. Examples of the catalyst include inorganic acids such as hydrochloric acid, sulfuric acid and nitric acid; organic acids such as oxalic acid, acetic acid, butyric acid, maleic acid, citric acid, formic acid, methanesulfonic acid and toluenesulfonic acid; inorganic bases such as sodium hydroxide, potassium hydroxide and ammonia; organic bases such as triethylamine and pyridine; metal alkoxides such as triisopropoxy aluminum, tetrabutoxy zirconium, tetrabutyl titanate and dibutyltin dilaurate; metal chelate compounds with the center metal being a metal such as Zr, Ti or Al; and F-containing compounds such as KF and NH₄F.

One of these catalysts may be used alone, or a plurality of species thereof may be used in combination.

The hydrolysis and condensation reaction of the organosilane may be performed without a solvent or in a solvent, but in order to uniformly mix the components, an organic solvent is preferably used. Suitable examples thereof include alcohols, aromatic hydrocarbons, ethers, ketones and esters.

The solvent is preferably a solvent capable of dissolving the organosilane and the catalyst. In view of the process, the organic solvent is preferably used as a coating solution or as a part of the coating solution. Furthermore, a solvent which does not impair the solubility or dispersibility when mixed with other materials such as fluorine-containing polymer is preferred.

Examples of the alcohols include a monohydric alcohol and a dihydric alcohol. The monohydric alcohol is preferably a saturated aliphatic alcohol having a carbon number of 1 to 8.

Specific examples of the alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether and ethylene glycol acetate monoethyl ether.

Specific examples of the aromatic hydrocarbons include benzene, toluene and xylene. Specific examples of the ethers include tetrahydrofuran and dioxane. Specific examples of the ketones include acetone, methyl ethyl ketone, methyl isobutyl ketone, diisobutyl ketone and cyclohexanone. Specific examples of the esters include ethyl acetate, propyl acetate, butyl acetate and propylene carbonate.

One of these organic solvents may be used alone, or two or more species thereof may be used as a mixture. The solid content concentration in the reaction is not particularly limited but is usually from 1 to 100%.

The reaction is performed by adding water in an amount of 0.05 to 2 mol, preferably from 0.1 to 1 mol, per mol of the hydrolyzable group of the organosilane, and stirring the resulting solution at 25 to 100° C. in the presence or absence of the above-described solvent and in the presence of the catalyst.

In the present invention, the hydrolysis is preferably performed by stirring the solution at 25 to 100° C. in the presence of at least one metal chelate compound where an alcohol represented by the formula: R3OH (wherein R3 represents an alkyl group having a carbon number of 1 to 10) and a compound represented by the formula: R4COCH₂COR5 (wherein R4 represents an alkyl group having a carbon number of 1 to 10 and R5 represents an alkyl group having a carbon number of 1 to 10 or an alkoxy group having a carbon number of 1 to 10) are present as ligands and the center metal is a metal selected from Zr, Ti and Al.

In the case of using a fluorine-containing compound as the catalyst, the fluorine-containing compound has a capability of allowing the progress of complete hydrolysis and condensation and this is advantageous in that the polymerization degree can be determined by selecting the amount of water added and an arbitrary molecular weight can be designed. That is, in order to prepare an organosilane hydrolysate/partial condensate having an average polymerization degree of M, this may be attained by using water in an amount of (M-1) mol per M mol of the hydrolyzable organosilane.

Any metal chelate compound may be suitably used without particular limitation as long as it is a metal chelate compound where an alcohol represented by the formula: R3OH (wherein R3 represents an alkyl group having a carbon number of 1 to 10) and a compound represented by the formula: R4COCH₂COR5 (wherein R4 represents an alkyl group having a carbon number of 1 to 10 and R5 represents an alkyl group having a carbon number of 1 to 10 or an alkoxy group having a carbon number of 1 to 10) are present as ligands and the center metal is a metal selected from Zr, Ti and Al. Within this category, two or more kinds of metal chelate compounds may be used in combination. The metal chelate compound for use in the present invention is preferably selected from the group consisting of compounds represented by the formulae: Zr(OR3)ₚ₁(R4COCHCOR5)ₚ₂, Ti(OR3)_{q1}(R4COCHCOR5)_{q2} and Al(OR3)ᵣ₁(R4COCHCOR5)ᵣ₂. These compounds have an activity of accelerating the condensation reaction of the hydrolysate of the organosilane compound and the partial condensate thereof.

In the metal chelate compounds, R3 and R4 may be the same or different and each represents an alkyl group having a carbon number of 1 to 10, such as ethyl group, n-propyl group, i-propyl group, n-butyl group, sec-butyl group, tert-butyl group, n-pentyl group or phenyl group. R5 represents an alkyl group having a carbon number of 1 to 10 the same as above or an alkoxy group having a carbon number of 1 to 10, such as methoxy group, ethoxy group, n-propoxy group, i-propoxy group, n-butoxy group, sec-butoxy group or tert-butoxy group. In the metal chelate compounds, p1, p2, q1, q2, r1 and r2 each represents an integer determined to satisfy the relationships of p1+p2=4, q1+q2=4 and r1+r2=3.

Specific examples of the metal chelate compound include a zirconium chelate compound such as zirconium tri-n-butoxyethylacetoacetate, zirconium di-n-butoxy-bis-(ethylacetoacetate), zirconium n-butoxytris(ethylacetoacetate), zirconium tetrakis(n-propylacetoacetate), zirconium tetrakis(acetylacetoacetate) and zirconium tetrakis(ethylacetoacetate); a titanium chelate compound such as titanium diisopropoxybis(ethylacetoacetate), titanium diisopropoxybis(acetylacetate) and titanium diisopropoxybis(acetylacetone); and an aluminum chelate compound such as aluminum diisopropoxyethylacetoacetate, aluminum diisopropoxyacetylacetonate, aluminum isopropoxy-bis(ethylacetoacetate), aluminum isopropoxybis(acetyl-acetonate), aluminum tris(ethylacetoacetate), aluminum tris(acetylacetonate) and aluminum monoacetyl-acetonatebis(ethylacetoacetate).

Among these metal chelate compounds, preferred are zirconium tri-n-butoxyethylacetoacetate, titanium diisopropoxybis(acetylacetonate), aluminum diisopropoxyethylacetoacetate and aluminum tris(ethylacetoacetate). One of these meal chelate compounds may be used alone, or two or more species thereof may be used as a mixture. A partial hydrolysate of such a metal chelate compound may also be used.

The metal chelate compound is preferably used in a proportion of 0.01 to 50 mass %, more preferably from 0.1 to 50 mass, still more preferably from 0.5 to 10 mass %, based on the organosilane compound. When the metal chelate compound is used in this range, the condensation reaction of the organosilane compound proceeds at a high rate, the coating film has good durability, and the composition comprising the hydrolysate of the organosilane compound, the partial condensate thereof and the metal chelate compound is assured of good storage stability.

In the coating solution for use in the present invention, at least either one of a β-diketone compound and a β-ketoester compound is preferably added in addition to the composition containing the above-described sol component and metal chelate compound. This is further described below.

The compound used in the present invention is at least either one of a β-diketone compound and a β-ketoester compound, represented by the formula: R4COCH₂COR5, and this compound functions as a stability enhancer for the composition used in the present invention. That is, this compound is considered to coordinate to a metal atom in the metal chelate compound (at lease any one compound of zirconium, titanium and aluminum compounds) and inhibit the metal chelate compound from exerting the activity of accelerating the condensation reaction of the hydrolysate of the organosilane compound and the partial condensate thereof, whereby the storage stability of the composition obtained is improved. R4 and R5 constituting the β-diketone compound and β-ketoester compound have the same meanings as R4 and R5 constituting the metal chelate compound above.

Specific examples of the β-diketone compound and the β-ketoester compound include acetylacetone, methyl acetoacetate, ethyl acetoacetate, n-propyl acetoacetate, i-propyl acetoacetate, n-butyl acetoacetate, sec-butyl acetoacetate, tert-butyl acetoacetate, 2,4-hexane-dione, 2,4-heptane-dione, 3,5-heptane-dione, 2,4-octane-dione, 2,4-nonane-dione and 5-methyl-hexane-dione. Among these, ethyl acetoacetate and acetylacetone are preferred, and acetylacetone is more preferred. One of these β-diketone compounds and β-ketoester compounds may be used alone, or two or more species thereof may be used as a mixture. In the present invention, the β-diketone compound and the β-ketoester compound each is preferably used in an amount of 2 mol or more, more preferably from 3 to 20 mol, per mol of the metal chelate compound. If the amount added is less than 2 mol, the composition obtained may suffer from poor storage stability and this is not preferred.

The content of the hydrolysate of the organosilane compound or the partial condensate thereof is preferably small in the case of an antireflection layer which is a relatively thin film, and preferably large in the case of a hardcoat or antiglare layer which is a thick film. Considering the expression of effect, refractive index, shape/surface state of film and the like, the content is preferably from 0.1 to 50 mass %, more preferably from 0.5 to 30 mass %, and most preferably from 1 to 15 mass %, based on the entire solid content of the layer containing the hydrolysate of the organosilane compound or the partial condensate thereof (the layer to which the hydrolysate of the organosilane compound or the partial condensate thereof is added).

In the case of using the hydrolysate of the vinyl polymerizable group-containing organosilane compound and/or the partial condensate thereof, a photolyzable initiator is preferably used in combination. Examples of the skeleton of such an initiator include the compounds exemplified for the initiator which is described later.

### (Polymerization Initiator)

### <Photoinitiator>

Examples of the photoradical polymerization initiator include acetophenones, benzoins, benzophenones, phosphine oxides, ketals, anthraquinones, thioxanthones, azo compounds, peroxides (see, for example, in JP-A-2001-139663), 2,3-dialkyldione compounds, disulfide compounds, fluoroamine compounds, aromatic sulfoniums, lophine dimers, onium salts, borate salts, active esters, active halogens, inorganic complexes and coumarins.

Examples of the acetophenones include 2,2-dimethoxyacetophenone, 2,2-diethoxyacetophenone, p-dimethylacetophenone, 1-hydroxy-dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone and 4-tert-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether and benzoin isopropyl ether. Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone) and 3,3′4,4′-tetra(tert-butylperoxycarbonyl)benzophenone.

Examples of the borate salts include organoborate salt compounds described in Japanese Patent 2764769, JP-A-2002-116539, and Kunz, Martin, Rad Tech′ 98, Proceeding April, pages 19-22, 1998, Chicago. More specifically, examples thereof include compounds described in paragraphs [0022] to [0027] of JP-A-2002-116539, supra. Other examples of the organoboron compound include organoboron transition metal coordination complexes described in JP-A-6-348011, JP-A-7-128785, JP-A-7-140589, JP-A-7-306527 and JP-A-7-292014, and specific examples thereof include ion complexes with a cationic coloring matter.

Examples of the phosphine oxides include 2,4,6-trimethylbenzoyldiphenylphosphine oxide.

Examples of the active esters include 1,2-octanedione, 1-[4-(phenylthio)-2-(O-benzoyloxime)], sulfonic acid esters and cyclic active ester compounds.

Specifically, Compounds 1 to 21 described in Examples of JP-A-2000-80068 are preferred.

Examples of the onium salts include an aromatic diazonium salt, an aromatic iodonium salt and an aromatic sulfonium salt.

Specific examples of the active halogens include compounds described in Wakabayashi et al., Bull Chem. Soc. Japan, Vol. 42, page 2924 (1969), U.S. Pat. No. 3,905,815, JP-A-5-27830, and M. P. Hutt, Journal of Heterocyclic Chemistry, Vol. 1 (No. 3) (1970), particularly a trihalomethyl group-substituted oxazole compound and an s-triazine compound Among these, preferred is an s-triazine derivative where at least one mono-, di- or tri-halogen-substituted methyl group is bonded to the s-triazine ring. Specifically, s-triazine and oxathiazole compounds are known, and examples thereof include 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl-4,6-bis(trichloromethyl)-s-triazine and 2-trihalomethyl-5-(p-methoxyphenyl)-1,3,4-oxadiazole. Specific preferred examples thereof include compounds described at pp. 14-30 of JP-A-58-15503 and pp. 6-10 of JP-A-55-77742, Compound Nos. 1 to 8 described at page 287 of JP-B-60-27673 (the term “JP-B” as used herein means an “examined Japanese patent publication”), Compound Nos. 1 to 17 described at pp. 443-444 of JP-A-60-239736, and Compound Nos. 1 to 19 described in U.S. Pat. No. 4,701,399.

Specific examples of the active halogens are set forth below.

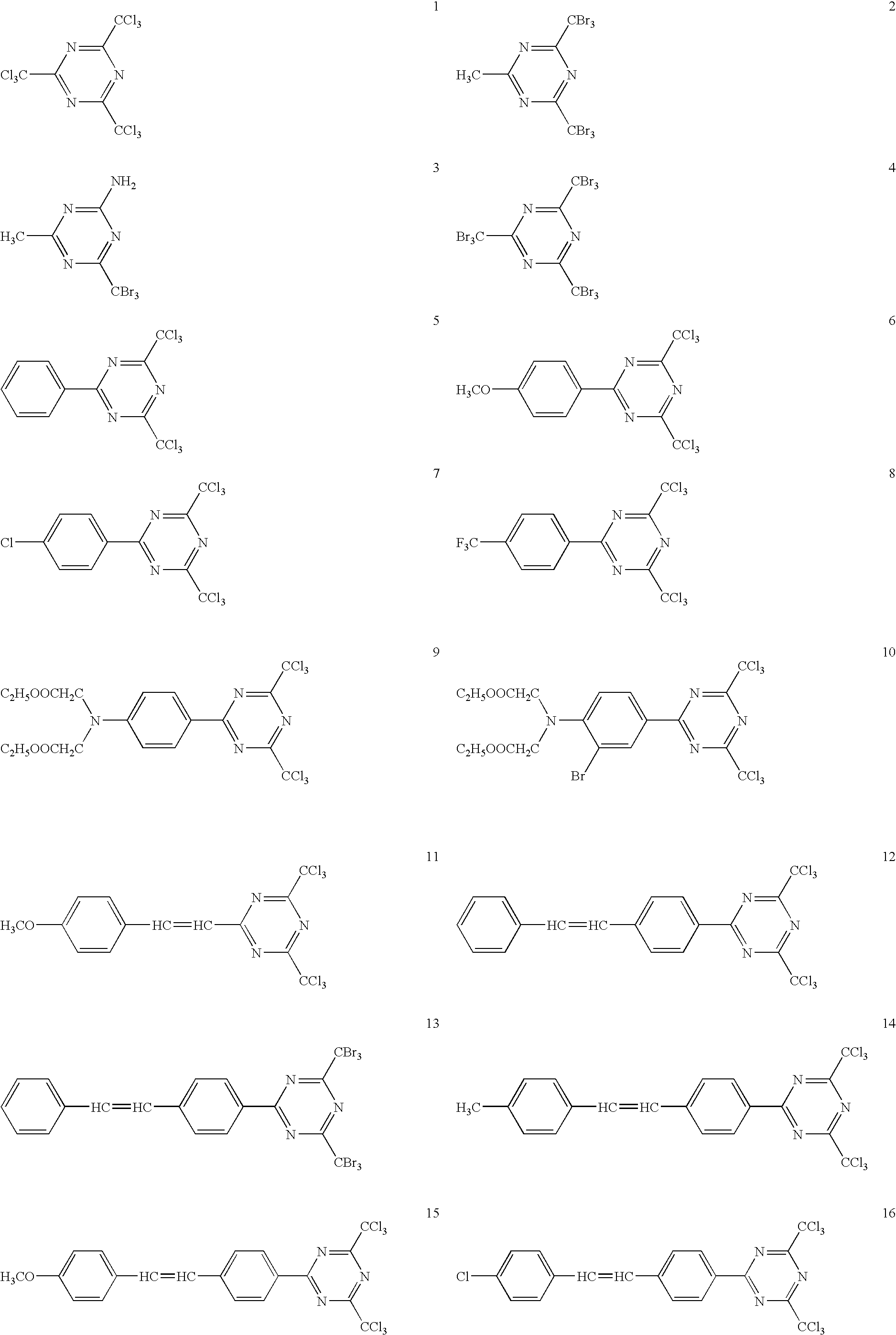

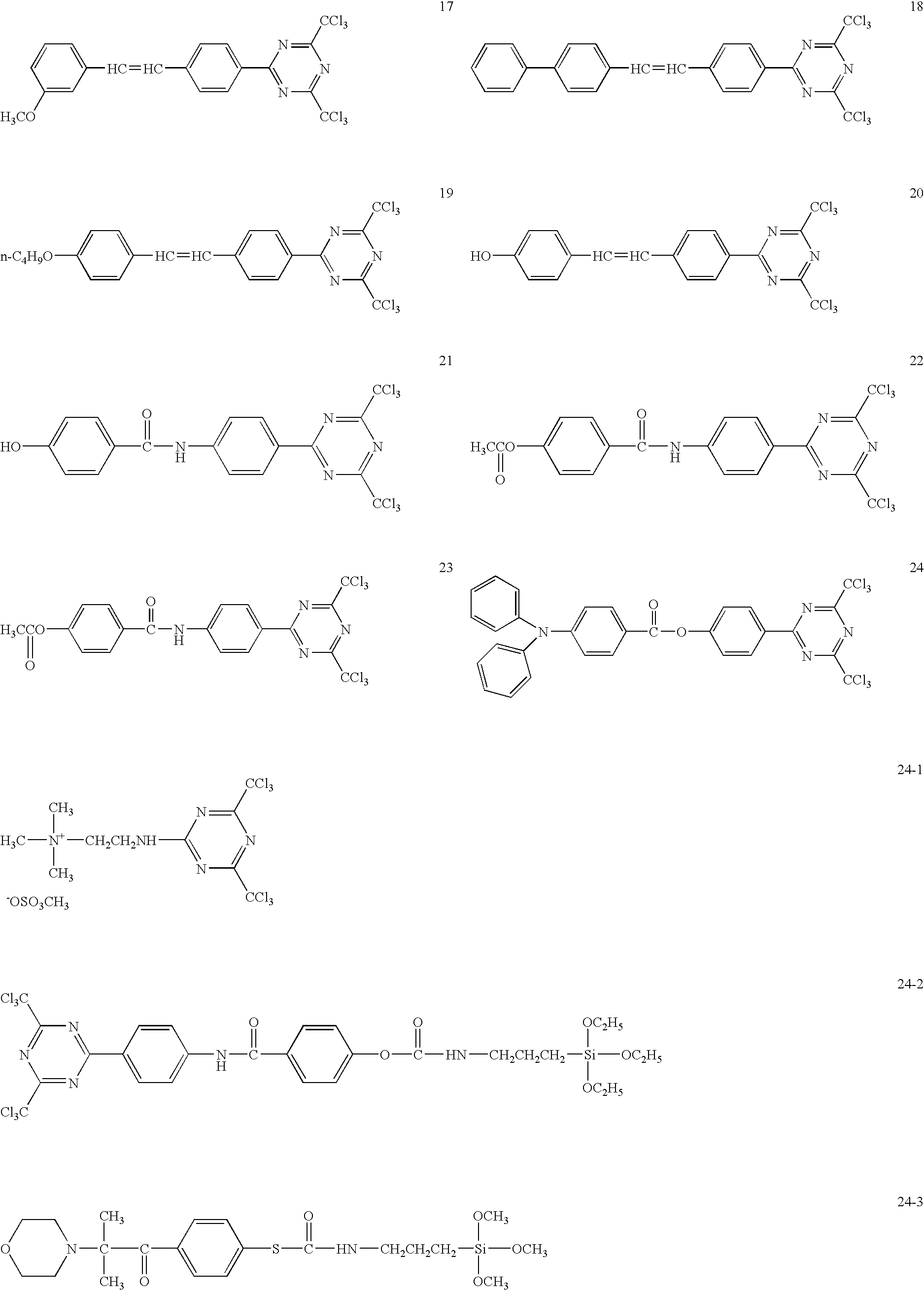

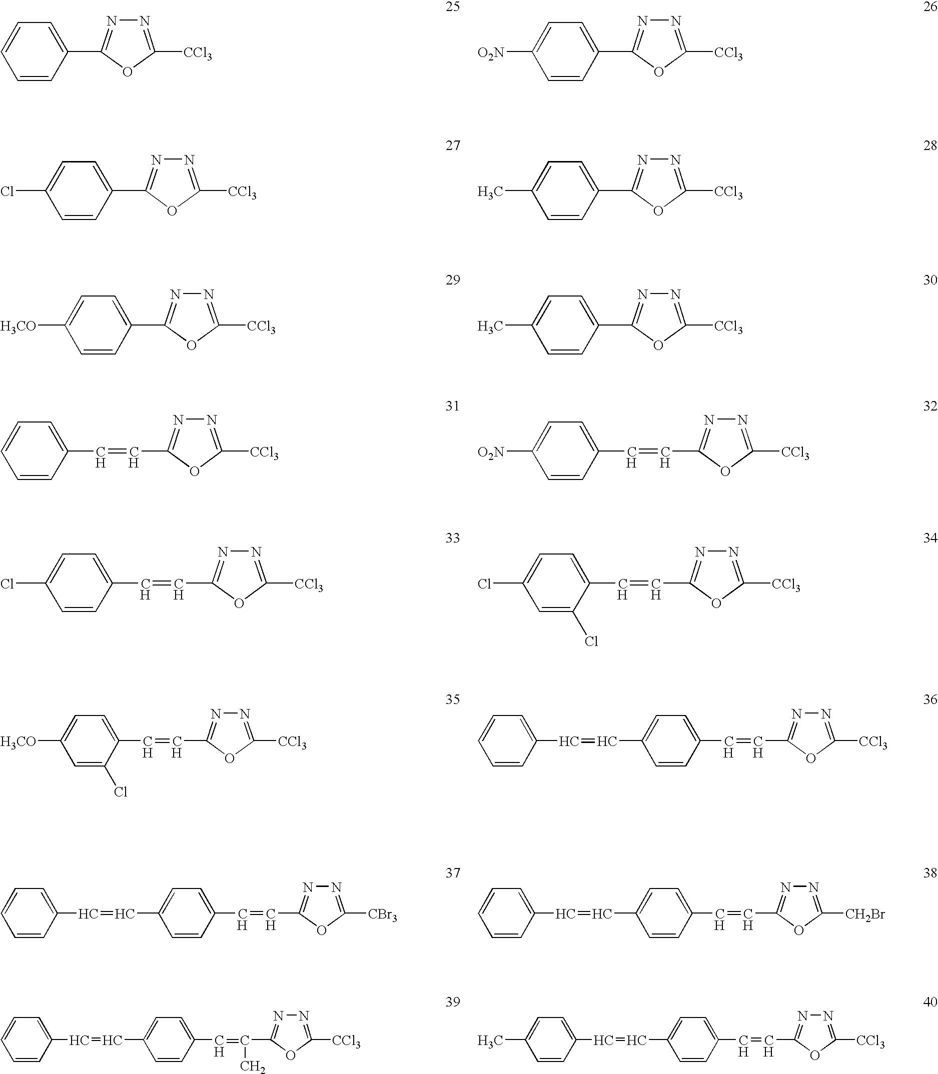

Examples of the inorganic complexes include bis-(η⁵-2,4-cyclopentadien-1-yl)-bis(2,6-difluoro-3-(1H-pyrrol-1-yl)-phenyl)titanium.

Examples of the coumarins include 3-ketocoumarin.

These initiators may be used individually or as a mixture.

Various examples are also described in Saishin UV Koka Gijutsu (Latest UV Curing Technologies), page 159, Technical Information Institute Co., Ltd. (1991), and Kiyomi Kato, Shigaisen Koka System (Ultraviolet Curing System), pp. 65-148, Sogo Gijutsu Center (1989), and these are useful in the present invention.

Preferred examples of the commercially available photoradical polymerization initiator include KAYACURE (e.g., DETX-S, BP-100, BDMK, CTX, BMS, 2-EAQ, ABQ, CPTX, EPD, ITX, QTX, BTC, MCA) produced by Nippon Kayaku Co., Ltd.; Irgacure (e.g., 651, 184, 500, 819, 907, 369, 1173, 1870, 2959, 4265, 4263) produced by Ciba Specialty Chemicals Corp.; Esacure (KIP100F, KB1, EB3, BP, X33, KT046, KT37, KIP150, TZT) produced by Sartomer Company Inc.; and a mixture thereof.

The photopolymerization initiator is preferably used in an amount of 0.1 to 15 parts by mass, more preferably from 1 to 10 parts by mass, per 100 parts by mass of the polyfunctional monomer.

### <Photosensitizer>

In addition to the photopolymerization initiator, a photosensitizer may be used. Specific examples of the photosensitizer include n-butylamine, triethylamine, tri-n-butylphosphine, Michler's ketone and thioxanthone.

Furthermore, one or more auxiliary agents such as azide compound, thiourea compound and mercapto compound may be used in combination.

Examples of the commercially available photosensitizer include KAYACURE (DMBI, EPA) produced by Nippon Kayaku Co., Ltd.

### <Thermal Initiator>

As for the thermal radical initiator, an organic or inorganic peroxide, an organic azo or diazo compound, or the like may be used.

More specifically, examples of the organic peroxide include benzoyl peroxide, halogen benzoyl peroxide, lauroyl peroxide, acetyl peroxide, dibutyl peroxide, cumene hydroperoxide and butyl hydroperoxide; examples of the inorganic peroxide include hydrogen peroxide, ammonium persulfate and potassium persulfate; examples of the azo compound include 2,2′-azobis(isobutyronitrile), 2,2′-azobis(propionitrile) and 1,1′-azobis(cyclohexanecarbonitrile); and examples of the diazo compound include diazoaminobenzene and p-nitrobenzenediazonium.

### (Crosslinking Agent (Crosslinking Compound))

In the case where the monomer or polymer binder constituting the present invention lacks satisfactory curability by itself, the necessary curability can be imparted by blending a crosslinking compound. Particularly, it is effective to incorporate the crosslinking compound into the low refractive index layer.

For example, when the polymer body contains a hydroxyl group, various amino compounds are preferably used as the curing agent. The amino compound used as the crosslinking compound is, for example, a compound having two or more groups in total of either one or both of a hydroxyalkylamino group and an alkoxyalkylamino group, and specific examples thereof include a melamine-based compound, a urea-based compound, a benzoguanamine-based compound and a glycoluril-based compound.

The melamine-based compound is generally known as a compound having a skeleton where a nitrogen atom is bonded to the triazine ring, and specific examples thereof include melamine, alkylated melamine, methylol melamine and alkoxylated methyl melamine. A compound having two or more groups in total of either one or both of a methylol group and an alkoxylated methyl group within one molecule is preferred. Specifically, a methylolated melamine obtained by reacting melamine and formaldehyde under basic conditions, an alkoxylated methyl melamine, and a derivative thereof are preferred, and an alkoxylated methyl melamine is more preferred because good storage stability of the curable resin composition and good reactivity are obtained. The methylolated melamine and alkoxylated methyl melamine used as the crosslinking compound are not particularly limited, and various resinous materials obtained by the method described, for example, in Plastic Zairyo Koza (Plastic Material Course) [8] Urea-Melamine Jushi (Urea-Melamine Resin), Nikkan Kogyo Shinbun-Sha, can also be used.

Examples of the urea-based compound include, in addition to urea, a polymethylolated urea and its derivative such as alkoxylated methylurea and urone ring-containing methylolated urone or alkoxylated methylurone. Also as for the compound such as urea derivative, various resinous materials described in the publication above can be used.

### (Curing Catalyst)

In the film of the present invention, a curing catalyst capable of generating a radical or an acid upon irradiation with ionizing radiation or heat can be used as a curing catalyst for accelerating the curing.

### <Thermal Acid Generator>

As one example of the optical film of the present invention, the film can be cured by heating to cause a crosslinking reaction between the hydroxyl group of a fluorine-containing compound and a curing agent capable of crosslinking with the hydroxyl group. In this system, the curing is accelerated by an acid and therefore, an acidic substance is preferably added to the curable resin composition. However, if a normal acid is added, the crosslinking reaction proceeds even in the coating solution and this may give rise to a failure (e.g., unevenness, repelling). Accordingly, in order to satisfy both the storage stability and the curing activity in the thermal curing system, it is more preferred that a compound capable of generating an acid by the effect of heat is added as the curing catalyst.

The curing catalyst is preferably a salt comprising an acid and an organic base. Examples of the acid include an organic acid such as sulfonic acid, phosphonic acid and carboxylic acid, and an inorganic acid such as sulfuric acid and phosphoric acid. In view of compatibility with the polymer, an organic acid is more preferred, a sulfonic acid and a phosphonic acid are still more preferred, and a sulfonic acid is most preferred. Preferred examples of the sulfonic acid include p-toluenesulfonic acid (PTS), benzenesulfonic acid (BS), p-dodecylbenzenesulfonic acid (DBS), p-chlorobenzenesulfonic acid (CBS), 1,4-naphthalenedisulfonic acid (NDS), methanesulfonic acid (MsOH) and nonafluorobutane-1-sulfonic acid (NFBS), and these all can be preferably used (abbreviations are shown in parentheses).

The curing catalyst greatly varies depending on the basicity and boiling point of the organic base combined with the acid. The curing catalyst preferably used in the present invention from respective standpoints is described below.

As the basicity of the organic base is lower, the acid generation efficiency at the heating is higher and this is preferred in view of curing activity, but if the basicity is too low, the storage stability becomes insufficient. Accordingly, an organic base having appropriate basicity is preferably used. When the basicity is expressed by using, as an index, pKa of the conjugated acid, the pKa of the organic base for use in the present invention is preferably from 5.0 to 11.0, more preferably from 6.0 to 10.5, still more preferably from 6.5 to 10.0. As for the pKa value of the organic base, the values in an aqueous solution are described in Kagaku Binran (Chemical Handbook), Kiso-Hen (Basic Edition), 5th rev., Vol. 2, pp. II-334 to 340, compiled by The Chemical Society of Japan, Maruzene (2004), and an organic base having an appropriate pKa can be selected therefrom. Even when not described in this publication, a compound estimated to have an appropriate pKa from its structure can also be preferably used. Compounds having an appropriate pKa described in the publication above are shown in Table 1 below, but the compounds which can be preferably used in the present invention are not limited thereto.

TABLE 1

| | | pKa |
|---|---|---|
| b-1 | N,N-dimethylaniline | 5.1 |
| b-2 | benzimidazole | 5.5 |
| b-3 | pyridine | 5.7 |
| b-4 | 3-methylpyridine | 5.8 |
| b-5 | 2,9-dimethyl-1,10-phenanthroline | 5.9 |
| b-6 | 4,7-dimethyl-1,10-phenanthroline | 5.9 |
| b-7 | 2-methylpyridine | 6.1 |
| b-8 | 4-methylpyridine | 6.1 |
| b-9 | 3-(N,N-dimethylamino) pyridine | 6.5 |
| b-10 | 2,6-dimethylpyridine | 7.0 |
| b-11 | imidazole | 7.0 |
| b-12 | 2-methylimidazole | 7.6 |
| b-13 | N-ethylmorpholine | 7.7 |
| b-14 | N-methylmorpholine | 7.8 |
| b-15 | bis (2-methoxyethyl) amine | 8.9 |
| b-16 | 2,2′-iminodiethanol | 9.1 |
| b-17 | N,N-dimethyl-2-aminoethanol | 9.5 |
| b-18 | trimethylamine | 9.9 |
| b-19 | triethylamine | 10.7 |

As the boiling point of the organic base is lower, the acid generation efficiency at the heating is higher and this is preferred in view of curing activity Accordingly, an organic base having an appropriate boiling point is preferably used. The boiling point of the base is preferably 120° C. or less, more preferably 80° C. or less, still more preferably 70° C. or less.

Examples of the organic base which can be preferably used in the present invention include, but are not limited to, the following compounds. The boiling points are shown in parentheses.

b-3: pyridine (115° C.), b-14: 4-methylmorpholine (115° C.), b-20: diallylmethylamine (111° C.), b-19: triethylamine (88.8° C.), b-21: tert-butylmethylamine (67 to 69° C.), b-22: dimethylisopropylamine (66° C.), b-23: diethylmethylamine (63 to 65° C.), b-24: dimethylethylamine (36 to 38° C.), and b-18: trimethylamine (3 to 5° C.).

In use as the acid catalyst, a salt comprising the acid and the organic base may be isolated and used or after mixing the acid and the organic base to form a salt in a solution, the solution may be used. For both the acid and the organic base, one species may be used alone or a plurality of species may be mixed and used. In mixing the acid and the organic base, these are preferably mixed such that the equivalent ratio of the acid to the organic base becomes 1:0.9 to 1.5, more preferably 1:0.95 to 1.3, still more preferably 1:1.0 to 1.1.

Examples of the material commercially available as the thermal acid generator include Catalyst 4040, Catalyst 4050, Catalyst 600, Catalyst 602, Catalyst 500 and Catalyst 2969, all produced by Nihon Cytec Industries Inc.; NACURE series 155, 1051, 5076 and 4054J and, as the block type thereof, NACURE series 2500, 5225, X49-110, 3525 and 4167, all produced by King Industries.

The ratio of the thermal acid generator used is preferably from 0.01 to 10 parts by mass, more preferably from 0.1 to 5 parts by mass, still more preferably from 0.2 to 3 parts by mass, per 100 parts by mass of the curable resin composition. When the amount added is in this range, good storage stability of the curable resin composition and good scratch resistance of the coating film are ensured.

### <Photosensitive Acid Generator, Photoacid Generator>

The photoacid generator which can be further used as the photopolymerization initiator is described in detail below.

Examples of the acid generator include known compounds such as photo-initiator for photo-cationic polymerization, photo-decoloring agent for coloring matters, photo-discoloring agent and known acid generator used for microresist or the like, and a mixture thereof. Also, examples of the acid generator include an organic halogenated compound, a disulfone compound and an onium compound. Of these, specific examples of the organohalogen compound and the disulfone compound are the same as those described above for the radical-generating compound.

Examples of the photosensitive acid generator include (1) various onium salts such as iodonium salt, sulfonium salt, phosphonium salt, diazonium salt, ammonium salt and pyridinium salt; (2) sulfone compounds such as β-ketoester, β-sulfonylsulfone and their α-diazo compound; (3) sulfonic acid esters such as alkylsulfonic acid ester, haloalkylsulfonic acid ester, arylsulfonic acid ester and imino sulfonate; (4) sulfonimide compounds; and (5) diazomethane compounds.

Examples of the onium compound include a diazonium salt, an ammonium salt, an iminium salt, a phosphonium salt, an iodonium salt, a sulfonium salt, an arsonium salt and a selenonium salt. Among these, a diazonium salt, an iodonium salt, a sulfonium salt and an iminium salt are preferred in view of photosensitivity for the initiation of photopolymerization, material stability of the compound, and the like. Examples thereof include compounds described in paragraphs [0058] and [0059] of JP-A-2002-29162.

The proportion of the photosensitive acid generator used is preferably from 0.01 to 10 parts by mass, more preferably from 0.1 to 5 parts by mass, per 100 parts by mass of the curable resin composition.

As for the specific compound and use method, those described, for example, in JP-A-2005-43876 can be used.

In the optical film of the present invention, the low refractive index layer can be formed by coating, and the coating solution for forming the low refractive index layer preferably contains, as the film-forming component, at least one kind of a light-transparent resin having an ultraviolet (UV)-curable and/or heat-curable functional group (the light-transparent resin having a ultraviolet (UV)-curable and/or heat-curable functional group is preferably the fluorine-containing polymer or organosilane compound described above or the like).

Also, in the optical film of the present invention, preferably, the coating solution for forming the low refractive index layer contains at least two or more kinds of light-transparent resins as the film-forming component; more preferably, out of these resins, at least one kind of a light-transparent resin has an ultraviolet (UV)-curable functional group and at least one different kind of a light-transparent resin has a heat-curable functional group; still more preferably, the coating solution for forming the low refractive index layer additionally contains at least one kind of a polymerization initiator and at least one kind of a heat-curable crosslinking agent; and yet still more preferably, the low refractive index layer additionally contains a curing catalyst capable of accelerating the thermal curing (as for the polymerization initiator, the heat-curable crosslinking agent and the curing catalyst capable of accelerating the thermal curing, those described above can be preferably used).

Furthermore, the value obtained by dividing the total weight of at least one light-transparent resin having an ultraviolet (UV)-curable functional group and at least one kind of a polymerization initiator, contained in the coating solution for forming the low refractive index layer, by the total weight of at least one kind of a light-transparent resin having a heat-curable functional group and at least one kind of a heat-curable crosslinking agent is preferably from 0.05 to 0.19 in view of the scratch resistance and cost, more preferably from 0.10 to 0.19, still more preferably from 0.15 to 0.19. If the value is less than 0.05, this is not preferred in view of the scratch resistance, whereas if it exceeds 0.20, the proportion of the UV curing component increases and addition of more processing conditions (for example, nitrogen purging at UV curing or elevation of film surface temperature) becomes necessary for increasing the polymerization efficiency at UV curing. The oxygen concentration at UV curing, adjusted by nitrogen purging, is preferably 1,000 ppm or less, more preferably 500 ppm or less, still more preferably 100 ppm or less, and most preferably 50 ppm or less. The film surface temperature at UV curing is preferably 50° C. or more, more preferably 70° C. or more, still more preferably 90° C. or more. If the temperature is excessively high, the support is softened and a handling (conveyance) failure may occur. Therefore, the upper limit of the temperature is decided by taking into account this point.

### (Leveling Agent)

For the purpose of improving the surface state (prevention of unevenness), various leveling agents are preferably used in at least one hardcoat layer of the present invention. Similarly, for the purpose of preventing unevenness, various leveling agents are preferably used in the low refractive index layer of the present invention. Specifically, the leveling agent is preferably a fluorine-based leveling agent or a silicone-based leveling agent. In particular, a combination use of both a fluorine-based leveling agent and a silicone-based leveling agent is more preferred, because high ability of preventing unevenness is obtained. It is still more preferred to use a leveling agent in all layers.

Also, the leveling agent is preferably an oligomer or a polymer rather than a low molecular compound. When a leveling agent is added, the leveling agent swiftly undergoes uneven distribution to the surface of the coated liquid film and the leveling agent remains unevenly distributed to the surface even after drying, as a result, the surface energy of the hardcoat layer or low refractive index layer to which the leveling agent is added, decreases due to the leveling agent.

From the standpoint of preventing unevenness of the hardcoat layer, the surface energy of the hardcoat layer is preferably low. The surface energy (γs^{v}, unit: mJ/m²) of the hardcoat layer is an energy-reduced surface tension value (a value obtained by converting the mN/m unit into the mJ/m² unit) of the antiglare hardcoat layer, and the surface tension is defined as a value γs^{v}(=γs^{d}+γs^{h}) which is the sum of γs^{d} and γs^{h} obtained according to the following simultaneous equations (1) and (2) from respective contact angles θ_{H2O} and θ_{CH2I2} with pure water H₂O and methylene iodide CH₂I₂ experimentally determined on the antiglare hardcoat layer by referring to D. K. Owens, J. Appl. Polym. Sci., 13, 1741 (1969). Before the measurement, the sample needs to be subjected to humidity conditioning under predetermined temperature-humidity conditions for a fixed time or more. At this time, the temperature is preferably from 20 to 27° C., the humidity is preferably from 50 to 65% RH, and the humidity conditioning time is preferably 2 hours or more.

1+cos θH₂O=2√γs^{d}(√γH₂Od/γH₂Ov)+2√γs^{h}(√γH₂Oh/γH₂Ov) (1)

1+cos θCH₂I₂=2√γs^{d}(√γCH₂I₂d/γCH₂I₂v)+2√γs^{h}(√γCH₂I₂h/γCH₂I₂v) (2)

wherein γ_{H2O}^{d}=21.8°, γ_{H2O}^{h}=51.0°, γ_{H2O}^{v}=72.8°, γ_{CH2I2}^{d}=49.5°, γ_{CH2I2}^{h}=1.3 and γ_{CH2I2}^{v}=50.8°.

The surface energy of the hardcoat layer is preferably 45 mJ/m² or less, more preferably from 20 to 45 mJ/m², still more preferably from 20 to 40 mJ/m².

By setting the surface energy of the hardcoat layer to 45 mJ/m² or less, an effect of hardly causing unevenness of the hardcoat layer can be obtained.

However, in the case of further coating an upper layer such as low refractive index layer on the hardcoat layer, the leveling agent is preferably dissolved out into the upper layer. The surface energy of the hardcoat layer after immersing and washing out the hardcoat layer with the solvent (e.g., methyl ethyl ketone, methyl isobutyl ketone, toluene, cyclohexanone) of the coating solution of the upper layer on the hardcoat layer is preferably rather high. The surface energy here is preferably from 35 to 70 mJ/m².

The fluorine-based leveling agent preferred as the leveling agent for the hardcoat layer is described below. The silicone-based leveling agent is described later.

The fluorine-based leveling agent is preferably a polymer having a fluoroaliphatic group. Furthermore, the useful polymer is a polymer comprising a repeating unit (polymerization unit) corresponding to the monomer of (i) below, or a copolymer of an acrylic or methacrylic resin comprising a repeating unit (polymerization unit) corresponding to the monomer of (i) below and a repeating unit (polymerization unit) corresponding to the monomer of (ii) below, with a vinyl-based monomer copolymerizable therewith. As for these monomers, those described in J. Brandrup, Polymer Handbook, 2nd ed., Chapter 2, pp. 1-483, Wiley Interscience (1975) may be used.

Examples thereof include compounds having one addition-polymerizable unsaturated bond selected from acrylic acid, methacrylic acid, acrylic acid esters, methacrylic acid esters, acrylamides, methacrylamides, allyl compounds, vinyl ethers and vinyl esters.

(i) Fluoroaliphatic group-containing monomer represented by the following formula A

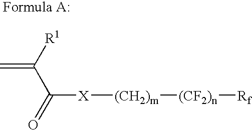

In formula A, R¹ represents a hydrogen atom, a halogen atom or a methyl group and is preferably a hydrogen atom or a methyl group. X represents an oxygen atom, a sulfur atom or —N(R¹²)— and is preferably an oxygen atom or —N(R¹²)—, more preferably an oxygen atom. R¹² represents a hydrogen atom or an alkyl group having a carbon number of 1 to 8 which may have a substituent, and is preferably a hydrogen atom or an alkyl group having a carbon number of 1 to 4, more preferably a hydrogen atom or a methyl group. R_{f} represents —CF₃ or —CF₂H.

In formula A, m represents an integer of 1 to 6 and is preferably an integer of 1 to 3, more preferably 1.

In formula A, n represents an integer of 1 to 11 and is preferably an integer of 1 to 9, more preferably from 1 to 6. R_{f} is preferably —CF₂H.

Also, two or more kinds of polymerization units derived from the fluoroaliphatic group-containing monomer represented by formula A may be contained as constituent components in the fluorine-based polymer.

(ii) Monomer represented by the following formula B, which is copolymerizable with (i)

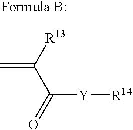

In formula B, R¹³ represents a hydrogen atom, a halogen atom or a methyl group and is preferably a hydrogen atom or a methyl group. Y represents an oxygen atom, a sulfur atom or —N(R¹⁵)— and is preferably an oxygen atom or —N(R¹⁵)—, more preferably an oxygen atom. R¹⁵ represents a hydrogen atom or an alkyl group having a carbon number of 1 to 8 and is preferably a hydrogen atom or an alkyl group having a carbon number of 1 to 4, more preferably a hydrogen atom or a methyl group.

R¹⁴ represents a linear, branched or cyclic alkyl group having a carbon number of 1 to 60 which may have a substituent, or an aromatic group (for example, a phenyl group or a naphthyl group) which may have a substituent. The alkyl group may contain a poly(alkyleneoxy) group. R¹⁴ is preferably a linear, branched or cyclic alkyl group having a carbon number of 1 to 20, more preferably a linear or branched alkyl group having a carbon number of 1 to 10.

Specific structure examples of the preferred fluorine-based polymer are set forth below, but the present invention is not limited thereto. In the formulae, the numeral indicates a molar ratio of respective monomer components, and Mw indicates a mass average molecular weight.

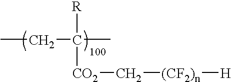

| | R | n | Mw |
|---|---|---|---|
| FP-1 | H | 4 | 8000 |
| FP-2 | H | 4 | 16000 |
| FP-3 | H | 4 | 33000 |
| FP-4 | CH₃ | 4 | 12000 |
| FP-5 | CH₃ | 4 | 28000 |
| FP-6 | H | 6 | 8000 |
| FP-7 | H | 6 | 14000 |
| FP-8 | H | 6 | 29000 |
| FP-9 | CH₃ | 6 | 10000 |
| FP-10 | CH₃ | 6 | 21000 |
| FP-11 | H | 8 | 4000 |
| FP-12 | H | 8 | 16000 |
| FP-13 | H | 8 | 31000 |
| FP-14 | CH₃ | 8 | 3000 |
| PP-15 | CH₃ | 8 | 10000 |
| FP-16 | CH₃ | 8 | 27000 |
| FP-17 | H | 10 | 5000 |
| FP-18 | H | 10 | 11000 |
| FP-19 | CH₃ | 10 | 4500 |
| FP-20 | CH₃ | 10 | 12000 |
| FP-21 | H | 12 | 5000 |
| FP-22 | H | 12 | 10000 |
| FP-23 | CH₃ | 12 | 5500 |
| FP-24 | CH₃ | 12 | 12000 |

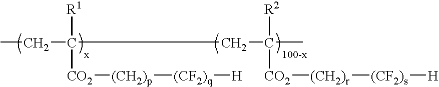

| | x | R¹ | p | q | R² | r | s | Mw |
|---|---|---|---|---|---|---|---|---|
| FP-25 | 50 | H | 1 | 4 | CH₃ | 1 | 4 | 10000 |
| FP-26 | 40 | H | 1 | 4 | H | 1 | 6 | 14000 |
| FP-27 | 60 | H | 1 | 4 | CH₃ | 1 | 6 | 21000 |
| FP-28 | 10 | H | 1 | 4 | H | 1 | 8 | 11000 |
| FP-29 | 40 | H | 1 | 4 | H | 1 | 8 | 16000 |
| FP-30 | 20 | H | 1 | 4 | CH₃ | 1 | 8 | 8000 |
| FP-31 | 10 | CH₃ | 1 | 4 | CH₃ | 1 | 8 | 7000 |
| FP-32 | 50 | H | 1 | 6 | CH₃ | 1 | 6 | 12000 |
| FP-33 | 50 | H | 1 | 6 | CH₃ | 1 | 6 | 22000 |
| FP-34 | 30 | H | 1 | 6 | CH₃ | 1 | 6 | 5000 |
| FP-35 | 40 | CH₃ | 1 | 6 | H | 3 | 6 | 3000 |
| FP-36 | 10 | H | 1 | 6 | H | 1 | 8 | 7000 |
| FP-37 | 30 | H | 1 | 6 | H | 1 | 8 | 17000 |
| FP-38 | 50 | H | 1 | 6 | H | 1 | 8 | 16000 |
| FP-39 | 50 | CH₃ | 1 | 6 | H | 3 | 8 | 19000 |
| FP-40 | 50 | H | 1 | 8 | CH₃ | 1 | 8 | 5000 |
| FP-41 | 80 | H | 1 | 8 | CH₃ | 1 | 8 | 10000 |
| FP-42 | 50 | CH₃ | 1 | 8 | H | 3 | 8 | 14000 |
| FP-43 | 90 | H | 1 | 8 | CH₃ | 3 | 8 | 9000 |
| FP-44 | 70 | H | 1 | 8 | H | 1 | 10 | 7000 |
| FP-45 | 90 | H | 1 | 8 | H | 3 | 10 | 12000 |
| FP-46 | 50 | H | 1 | 8 | H | 1 | 12 | 10000 |
| FP-47 | 70 | H | 1 | 8 | CH₃ | 3 | 12 | 8000 |

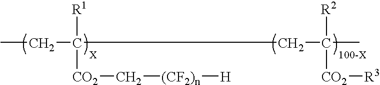

| | x | R¹ | n | R² | R³ | Mw |
|---|---|---|---|---|---|---|
| FP-48 | 90 | H | 6 | H | C₂H₈ | 9000 |
| FP-49 | 80 | H | 6 | H | C₂H₈ | 24000 |
| FP-50 | 60 | H | 6 | H | C₂H₈ | 38000 |
| FP-51 | 90 | H | 6 | H | C₄H₉ (n) | 16000 |
| FP-52 | 80 | H | 6 | H | C₄H₉ (n) | 17000 |
| FP-53 | 60 | H | 6 | H | C₄H₉ (n) | 10000 |
| FP-54 | 90 | H | 6 | H | C₄H₉ (iso) | 16000 |
| FP-55 | 80 | H | 6 | H | C₄H₉ (iso) | 18000 |
| FP-56 | 60 | H | 6 | H | C₄H₉ (iso) | 21000 |
| FP-57 | 90 | H | 6 | H | C₄H₉ (t) | 14000 |
| FP-58 | 80 | H | 6 | H | C₄H₉ (t) | 12000 |
| FP-59 | 60 | H | 6 | H | C₄H₉ (t) | 13000 |
| FP-60 | 90 | H | 6 | H | C₆H₁₃ (n) | 10000 |
| FP-61 | 80 | H | 6 | H | C₆H₁₃ (n) | 8000 |
| FP-62 | 60 | H | 6 | H | C₆H₁₃ (n) | 12000 |
| FP-63 | 80 | H | 4 | H | C₂H₈ | 25000 |
| FP-64 | 80 | H | 4 | H | C₄H₉ (n) | 32000 |
| FP-65 | 80 | H | 4 | H | C₄H₉ (iso) | 28000 |
| FP-66 | 80 | H | 4 | H | C₄H₉ (t) | 25000 |
| FP-67 | 80 | H | 4 | H | C₆H₁₃ (n) | 20000 |
| FP-68 | 80 | H | 8 | H | C₂H₈ | 5000 |
| FP-69 | 80 | H | 8 | H | C₄H₉ (n) | 6000 |
| FP-70 | 80 | H | 8 | H | C₄H₉ (iso) | 5000 |
| FP-71 | 80 | H | 8 | H | C₄H₉ (t) | 7000 |
| FP-72 | 80 | H | 8 | H | C₆H₁₃ (n) | 5000 |
| FP-78 | 80 | H | 4 | CH₃ | C₂H₈ | 12000 |
| FP-79 | 80 | H | 4 | CH₃ | C₄H₉ (n) | 14000 |
| FP-80 | 80 | H | 4 | CH₃ | C₄H₉ (iso) | 20000 |
| FP-81 | 80 | H | 4 | CH₃ | C₄H₉ (t) | 22000 |
| FP-82 | 80 | H | 4 | CH₃ | C₆H₁₃ (n) | 18000 |
| FP-83 | 80 | CH₃ | 4 | CH₃ | C₂H₈ | 6000 |
| FP-84 | 80 | CH₃ | 4 | CH₃ | C₄H₉ (n) | 8000 |
| FP-85 | 80 | CH₃ | 4 | CH₃ | C₄H₉ (iso) | 7000 |
| FP-86 | 80 | CH₃ | 4 | CH₃ | C₄H₉ (t) | 12000 |
| FP-87 | 80 | CH₃ | 4 | CH₃ | C6H13 (n) | 6000 |

The amount of the polymerization unit of the fluoroaliphatic group-containing monomer constituting the fluorine-based polymer is preferably in excess of 10 mass %, more preferably from 50 to 100 mass %, and most preferably from 75 to 100 mass % when it is important to prevent unevenness of the hardcoat layer, or most preferably from 50 to 75 mass % when a low refractive index layer is coated on the hardcoat layer (the amount is based on all polymerization units constituting the fluorine-based polymer).

The silicone-based leveling agent is described below.

Examples of the silicone-based leveling agent include a polydimethylsiloxane modified at the side or main chain terminal with various substituents such as oligomer (e.g., ethylene glycol, propylene glycol), and examples thereof include KF-96 and X-22-945 produced by Shin-Etsu Chemical Co., Ltd. In addition, a nonionic surfactant having a hydrophobic group composed of dimethylpolysiloxane and a hydrophilic group composed of polyoxyalkylene can also be preferably used.

Specific examples of this nonionic surfactant include SILWET L-77, L-720, L-7001, L-7002, L-7604, Y-7006, FZ-2101, FZ-2104, FZ-2105, FZ-2110, FZ-2118, FZ-2120, FZ-2122, FZ-2123, FZ-2130, FZ-2154, FZ-2161, FZ-2162, FZ-2163, FZ-2164, FZ-2166 and FZ-2191, and SUPERSILWET SS-2801, SS-2802, SS-2803, SS-2804 and SS-2805, which are silicone surfactants produced by Nippon Unicar Co., Ltd.

As for the preferred structure of the nonionic surfactant having a hydrophobic group composed of dimethylpolysiloxane and a hydrophilic group composed of polyoxyalkylene, a linear block copolymer where the dimethylpolysiloxane structure moiety and the polyoxyalkylene chain are alternately and repeatedly bonded is preferred, and this is described in JP-A-6-49486.

Specific examples thereof include ABN SILWET FZ-2203, FZ-2207 and FZ-2208, which are silicone surfactants produced by Nippon Unicar Co., Ltd.

The amount of the fluorine-based leveling agent or silicone-based leveling agent added to the coating solution is preferably from 0.001 to 1.0 mass %, more preferably from 0.01 to 0.2 mass %.

### (Solvent of Coating Solution for Low Refractive Index Layer)

For reducing the dry unevenness of the low refractive index layer, the solvent of the coating solution for the low refractive index layer of the optical film of the present invention preferably contains a low boiling point solvent having a boiling point of 120° C. or less in an amount of 50 to 100 mass %, preferably from 70 to 100 mass %, more preferably from 90 to 100 mass %, based on the entire solvent mass in the coating solution for the low refractive index layer). By virtue of changing as above the solvent composition of the low refractive index layer of the sample according to the present invention, which is described later, the effect was confirmed in the surface state evaluation of the low refractive index layer. Specific representative examples of the solvent of the coating solution are methyl ethyl ketone, methyl isobutyl ketone and toluene, each ensuring good solubility of the fluorine-containing polymer in the low refractive index layer.

### (Thickening Agent of Hardcoat Layer)

In the hardcoat layer, a thickening agent may be used for adjusting the viscosity of the coating solution.

By the thickening, precipitation of the particle contained may be suppressed or the unevenness-preventing effect may be expected. The thickening agent as used herein means a substance which causes increase in the viscosity of a liquid when added. The increment of viscosity of the coating solution, which is brought about by the addition, is preferably from 0.05 to 50 cP, more preferably from 1 to 50 cF, and most preferably from 2 to 50 cP.

The high-molecular polymer used as the thickening agent preferably contains substantially no fluorine atom and/or substantially no silicon atom. The term “substantially” as used herein means that the content of fluorine atom and/o silicon atom is 0.1 mass % or less, preferably 0.01 mass % or less, based on the mass of the high-molecular polymer.

A high-molecular polymer is preferred as the thickening agent, and specific examples thereof include, but are not limited to, the followings:

polyacrylic acid ester,

polymethacrylic acid ester,

polyvinyl acetate,

polyvinyl propionate,

polyvinyl butyrate

polyvinylbutyral,

polyvinylformal,

polyvinylacetal,

polyvinylpropanal,

polyvinylhexanal,

polyvinylpyrrolidone,

cellulose acetate,

cellulose propionate, and

cellulose acetate butyrate.

Among these, preferred are a polymethacrylic acid ester (specifically, methyl polymethacrylate and ethyl polymethacrylate), polyvinyl acetate, polyvinyl propionate, cellulose propionate and cellulose acetate butyrate.

The mass average molecular weight of these polymers is preferably from 100,000 to 1,000,000.

Other than these, a known viscosity adjusting agent or thixotropy imparting agent, such as smectite, fluorotetrasilicon mica, bentonite, silica, montmorillonite and sodium polyacrylate described in JP-A-8-325491, and ethyl cellulose, polyacrylic acid and organic clay described in JP-A-10-219136, may be used.

### [Transparent Support]

The transparent support of the optical film of the present invention is preferably a plastic film. Examples of the polymer for forming the plastic film include a cellulose ester (e.g., triacetyl cellulose, diacetyl cellulose; representatively, TAC-TD8OU, TD80UL, etc. produced by FUJIFILM Corporation), a polyamide, a polycarbonate, a polyester (e.g., polyethylene terephthalate, polyethylene naphthalate), a polystyrene, a polyolefin, a norbornene-based resin (ARTON, trade name, produced by JSR Corp.) and an amorphous polyolefin (ZEONEX, trade name, produced by Zeon Corp.). Among these, preferred are triacetyl cellulose, polyethylene terephthalate and polyethylene naphthalate, and more preferred is triacetyl cellulose. Furthermore, a cellulose acylate film substantially free of a halogenated hydrocarbon such as dichloromethane and the production method thereof are described in JIII Journal of Technical Disclosure (No. 2001-1745, issued Mar. 15, 2001; hereinafter simply referred to as Technical Disclosure No. 2001-1745), and the cellulose acylate described therein can also be preferably used in the present invention. The thickness of the support is, in view of the need for thinning and the handling (suitability for conveyance), suitably from 20 to 200 μm, preferably from 30 to 100 μm, more preferably from 35 to 90 μm, and most preferably from 40 to 80 μm.

### [Properties of Optical Film]

The surface haze and internal haze used in the present invention are described in detail below. [1] The entire haze value (H) of the optical film obtained is measured according to JIS-K7136. [2] After adding several silicone oil drops on the front and back surfaces of the optical film, the film is sandwiched from front and back by two 1 mm-thick glass plates (Microslide Glass No. S9111, produced by Matsunami K. K.), the haze is measured in a surface haze-removed state by bringing the two glass plates into complete contact with the optical film obtained, and the value obtained by subtracting, from this haze, the haze separately measured by interposing only the silicone oil between two glass plates is calculated as the internal haze (Hi). [3] The value obtained by subtracting the internal haze (Hi) calculated in [2] above from the entire haze (H) measured in [1] above is calculated as the surface haze (Hs).

In view of antifouling property, the contact angle for pure water on the surface of the optical film of the present invention as measured in an environment of 25° C. and 60% RH is preferably 90° or more, more preferably 95° or more, still more preferably 100° or more. Also, the change of contact angle between before and after saponification (described later) which is necessary at the processing into a polarizing plate, is preferably 5° or less, more preferably 3° or less, and most preferably 1° or less.

In view of dust resistance, the vertical separation charge of the optical film of the present invention for polyethylene terephthalate as measured in an environment of 25° C. and 60% RH is preferably from −500 to +500 pc (pico coulomb)/cm², more preferably from −200 to +200 pc (pico coulomb)/cm², still more preferably from −100 to +100 PC (pico coulomb)/cm². The vertical separation charge is measured as follows.

The measurement sample is previously left standing for 2 hours or more in an environment of 25° C. and 60% RH. The measuring apparatus comprises a stage on which the measurement sample is placed, and a head for holding the other party film, which can repeat pressing from above to the measurement sample and separation therefrom. A polyethylene terephthalate is loaded in this head and after removing electricity from the measuring part, the head is repeatedly pressed to and separated from the measurement sample. The electric charge value is read at the first separation and at the fifth separation, and the obtained values are averaged. By varying the sample, this operation is repeated on three samples. All values are averaged and the obtained value is defined as the vertical separation charge.

In the case of an optical film where at least one member out of the constituent materials of the low refractive index layer comprises a fluorine-containing material, for adjusting the vertical separation charge to fall in the preferred range, the photoelectron spectral intensity ratio F/C is from 0.5 to 5, preferably from 0.5 to 3, more preferably from 0.5 to 2. Also, for adjusting the vertical separation charge, silicone having high surface orientation property similarly to fluorine is preferably contained and in this case, the photoelectron spectral intensity ratio Si/C is from 0.05 to 0.5, preferably from 0.1 to 0.5, more preferably from 0.2 to 0.5. Incidentally, F/C (═F₁ₛ/C₁ₛ) and Si/C (═Si₂ₚ/C₁ₛ) are values measured as follows.

The photoelectron spectra of Si₂ₚ, F₁ₛ and C₁ₛ on the outermost surface of the optical film are measured by ESCA-3400 (degree of vacuum: 1×10⁻⁵ Pa, X-ray source: target Mg, voltage: 12 kV, current: 20 mA) manufactured by Shimadzu Corp.

For enhancing the dust resistance, this may be attained by adjusting the surface resistance value of the optical film of the present invention to less than 1×10¹¹ Ω/square (Ω/□), preferably less than 1×10¹⁰ Ω/square, more preferably less than 1×10⁹ Ω/square. The measuring method of the surface resistance value is described later. In the optical film of the present invention, various electrically conducting particles may be used so as to impart electrical conductivity. The electrically conducting particle is preferably formed of an oxide or nitride of metal. Examples of the oxide or nitride of metal include tin oxide, indium oxide, zinc oxide and titanium nitride, with tin oxide and indium oxide being preferred. The electrically conducting inorganic particle comprises such an oxide or nitride of metal as the main component and may further contain other elements. The “main component” means a component of which content (mass %) is largest among the components constituting the particle. Examples of the other element include Ti, Zx, Sn, Sb, Cu, Fe, Mn, Pb, Cd, As, Cr, Hg, Zn, Al, Mg, Si, P, S, B, Nb, In, V and a halogen atom. In order to elevate the electrical conductivity of tin oxide or indium oxide, it is preferred to add Sb, P, B, Nb, In, V or a halogen atom. An Sb-containing tin oxide (ATO) and an Sn-containing indium oxide (ITO) are particularly preferred. The proportion of Sb in ATO is preferably from 3 to 20 mass %, and the proportion of Sn in ITO is preferably from 5 to 20 mass %.

The average primary particle diameter of the electrically conducting inorganic particle for use in the antistatic layer is preferably from 1 to 150 nm, more preferably from 5 to 100 nm, and most preferably from 5 to 70 nm. The average particle diameter of the electrically conducting inorganic particle in the antistatic layer formed is from 1 to 200 nm, preferably from 5 to 150 nm, more preferably from 10 to 100 nm, and most preferably from 10 to 80 nm. The average particle diameter of the electrically conducting particle is an average diameter weighed by the mass of particle and can be measured by a light scattering method or an electron micrograph.

The specific surface area of the electrically conducting inorganic particle is preferably from 10 to 400 m²/g, more preferably from 20 to 200 m²/g, and most preferably from 30 to 150 m²/g.

The electrically conducting inorganic particle may be surface-treated. The surface treatment is performed using an inorganic compound or an organic compound. Examples of the inorganic compound for use in the surface treatment include alumina and silica. A silica treatment is preferred. Examples of the organic compound for use in the surface treatment include a polyol, an alkanolamine, a stearic acid, a silane coupling agent and a titanate coupling agent, with a silane coupling agent being most preferred. Two or more kinds of surface treatments may be practiced in combination.

The shape of the electrically conducting inorganic particle is preferably rice grain-like, spherical, cubic, spindle-like or amorphous.

Two or more kinds of electrically conducting particles may be used in combination in a specific layer or as a film. The proportion of the electrically conducting inorganic particle in the antistatic layer is preferably from 20 to 90 mass %, more preferably from 25 to 85 mass %, still more preferably from 30 to 80 mass %. Also, the electrically conducting inorganic particle can be used in a dispersion state for the formation of the antistatic layer.

As for the measuring method of the surface resistance value, the sample film is previously left standing for 2 hours or more in an environment of 25° C. and 60% RH, and thereafter, the surface resistance on the coating layer side is measured by an ultra-insulating resistance/microammeter, TR8601 (manufactured by Advantest Corp.).

The dynamic friction coefficient of the optical film of the present invention is preferably 0.3 or less in view of enhancing the scratch resistance (prevention of stress concentration), more preferably 0.2 or less, still more preferably 0.1 or less. The method for measuring the coefficient of dynamic friction is as follows.

The measurement sample is previously left standing for 2 hours or more in an environment of 25° C. and 60% RH and thereafter, measured by a dynamic friction measuring meter, HEIDON-14, with a 5 mmφ stainless steel ball under a load of 100 g at a speed of 60 cm/min, and the obtained value is used.

In the optical film of the present invention, assuming that the average value of 5° specular reflectance in the wavelength region of 450 to 650 nm is A and the average value of integrated reflectance in that region is B, in view of denseness of black display in a bright room environment or enhancement of bright room contrast, B is preferably 3% or less and B-A is preferably 1.5% or less. B is more preferably 2% or less, still more preferably 1% or less, and B-A is more preferably 1% or less, still more preferably 0.5% or less. The average values of 5° specular reflectance and integrated reflectance are measured as follows.

In the measurement of the specular reflectance, an adapter “ARV-474” is loaded in a spectrophotometer “V-550” [manufactured by JASCO Corp.], the specular reflectance for the outgoing angle of −5° at an incident angle of 5° is measured in the wavelength region of 380 to 780 nm, and an average specular reflectance at 450 to 650 nm is calculated. In the measurement of the integrated reflectance, an adapter “ILV-471” is loaded in a spectrophotometer “V-550” [manufactured by JASCO Corp.], the integrated reflectance at an incident angle of 5° is measured in the wavelength region of 380 to 780 nm, and an average integrated reflectance at 450 to 650 nm is calculated.

### [Production Method of Optical Film]

The optical film of the present invention can be formed by the following method, but the present invention is not limited to this method.

### (Preparation of Coating Solution)

A coating solution containing components for forming each layer is prepared. At this time, the percentage of water content in the coating solution can be prevented from increasing by minimizing the volatilization volume of the solvent. The percentage of water content in the coating solution is preferably 5% or less, more preferably 2% or less. The volatilization volume of the solvent can be suppressed, for example, by enhancing the closeness at the stirring after materials are charged into a tank or by minimizing the contact area of the coating solution with air at the liquid transfer operation. Also, means for reducing the percentage of water content in the coating solution may be provided during, before or after the coating.

### (Filtration)

The coating solution used for coating is preferably filtered before coating. The filtration is preferably preformed using a filter having a pore size as small as possible within the range of not allowing for elimination of the components in the coating solution. In the filtration, a filter having an absolute filtration accuracy of 0.1 to 50 μm is used. A filter having an absolute filtration accuracy of 0.1 to 40 μm is more preferred. The filter thickness is preferably from 0.1 to 10 mm, more preferably from 0.2 to 2 mm. In this case, the filtration is preferably performed under a filtration pressure of 1.5 MPa or less, more preferably 1.0 MPa or less, still more preferably 0.2 MPa or less.

The filter member of filtration is not particularly limited as long as it does not affect the coating solution. Specific examples thereof are the same as those of the filtration member described above for the wet dispersion of an inorganic compound.

It is also preferred to ultrasonically disperse the filtered coating solution immediately before coating and assist in defoaming or keeping the dispersed state of the dispersion.

### (Treatment Before Coating)

The support for use in the present invention is preferably subjected, before coating, to a heat treatment for correcting the base deformation or to a surface treatment for improving the coatability or the adhesion to the coated layer. Specific example of the method for surface treatment include a corona discharge treatment, a glow discharge treatment, a flame treatment, an acid treatment, an alkali treatment and an ultraviolet irradiation treatment. It is also preferred to provide an undercoat layer as described in JP-A-7-333433.

Furthermore, examples of the dedusting method for use in the dedusting step as a pre-step before coating include a dry dedusting method such as a method of pressing a nonwoven fabric, a blade or the like against the film surface described in JP-A-59-150571; a method of blowing an air having a high cleanliness at a high speed to separate attached matters from the film surface, and sucking these matters through a proximate suction port described in JP-A-10-309553; and a method of blowing a compressed air under ultrasonic vibration to separate attached matters, and sucking these matters described in JP-A-7-333613 (for example, NEW ULTRA-CLEANER manufactured by Shinko Co., Ltd.).

Also, a wet dedusting method may be used, such as a method of introducing the film into a cleaning tank, and separating attached matters by using an ultrasonic vibrator; a method of supplying a cleaning solution to the film, and blowing an air at a high speed, followed by sucking described in JP-B-49-13020; and a method of continuously rubbing the web with a liquid-moistened roll, and jetting a liquid onto the rubbed face, thereby cleaning the web described in JP-A-2001-38306. Among these dedusting methods, an ultrasonic dedusting method and a wet dedusting method are preferred in view of the dedusting effect.

Before performing such a dedusting step, the static electricity on the film support is preferably destaticized so as to elevate the dedusting efficiency and prevent attachment of dirt. As for the destaticizing method, an ionizer of corona discharge type, an ionizer of light irradiation type (e.g., UV, soft X-ray), and the like may be used. The voltage charged on the film support before and after dedusting and coating is preferably 1,000 V or less, more preferably 300 V or less, still more preferably 100 V or less.

From the standpoint of maintaining the planarity of the film, in these treatments, the temperature of the cellulose acylate film is preferably kept to be Tg or less, specifically 150° C. or less.

In the case of laminating the cellulose acylate film to a polarizing film as in the case of using the film of the present invention for a protective film of a polarizing plate, in view of adhesive property to the polarizing film, an acid or alkali treatment, that is, a saponification treatment for cellulose acylate, is preferably performed.

In view of adhesive property, the surface energy of the cellulose acylate film is preferably 55 mN/m or more, more preferably from 60 to 75 mN/m. The surface energy can be adjusted by the above-described surface treatment.

### (Coating)

Each layer of the film of the present invention can be formed by the following coating methods, but the present invention is not limited thereto.

A known method such as dip coating method, air knife coating method, curtain coating method, roller coating method, wire bar coating method, gravure coating method, extrusion coating method (die coating method) (see, U.S. Pat. No. 2,681,294 and WO2005/123274) and microgravure coating method, is used. Among these, a microgravure coating method and a die coating method are preferred.

The microgravure coating method for use in the present invention is a coating method where a gravure roll having a diameter of about 10 to 100 mm, preferably from about 20 to 50 mm, and having a gravure pattern engraved on the entire circumference is rotated under the support in the direction reverse to the support-conveying direction and at the same time, a surplus coating solution is scraped off from the surface of the gravure roll by a doctor blade, thereby allowing a constant amount of the coating solution to be transferred to and coated on the bottom surface of the support at the position in which the top surface of the support is in a free state. A roll-form transparent support is continuously unrolled and on one side of the unrolled support, at least one layer of the hardcoat layer and the low refractive index layer containing a fluorine-containing olefin-based polymer can be coated by the microgravure coating method.

As for the coating conditions in the microgravure coating method, the number of lines in the gravure pattern engraved on the gravure roll is preferably from 50 to 800 lines/inch, more preferably from 100 to 300 lines/inch, the depth of the gravure pattern is preferably from 1 to 600 μm, more preferably from 5 to 200 μm, the rotation number of the gravure roll is preferably from 3 to 800 rpm, more preferably from 5 to 200 rpm, and the support conveying speed is preferably from 0.5 to 100 m/min, more preferably from 1 to 50 m/min.

In order to supply the film of the present invention with high productivity, an extrusion method (die coating method) is preferably used.

The die coating method is a pre-measurement system and therefore, a stable film thickness can be easily ensured. Also, this coating method can apply a low-amount coating solution at a high speed with good film thickness stability. The coating may be performed by other coating methods, but in a dip coating method, the coating solution in a liquid-receiving tank is inevitably vibrated and stepwise unevenness is readily generated. In a reverse roll coating method, stepwise unevenness is liable to occur due to eccentricity or deflection of a roll involved in the coating. Also, these coating methods are a post-measurement system and therefore, a stable film thickness can be hardly ensured. In view of productivity, the coating is preferably performed using the above-described die coating method at a rate of 25 m/min or more.

### (Drying)

After coating on the support directly or through another layer, the film of the present invention is preferably conveyed in the form of a web to a heated zone for drying the solvent.

As for the method of drying the solvent, various known techniques may be utilized. Specific examples thereof include those described in JP-A-2001-286817, JP-A-2001-314798, JP-A-2003-126768, JP-A-2003-315505 and JP-A-2004-34002.

The temperature in the drying zone is preferably from 25 to 140° C. and it is preferred that the temperature in the first half of the drying zone is relatively low and the temperature in the second half is relatively high. However, the temperature is preferably not more than a temperature at which the components other than the solvent contained in the coating composition for each layer start volatilizing. For example, some commercially available photoradical generators used in combination with an ultraviolet curable resin volatilize by about several tens of percent within several minutes in warm air at 120° C., and some monofunctional or bifunctional acrylate monomers or the like allow progress of their volatilization in warm air at 100° C. In such a case, the drying zone temperature is preferably not more than a temperature at which the components other the solvent contained in the coating composition for each layer start volatilizing.

In order to prevent drying unevenness, the drying air after applying the coating composition for each layer on the support is preferably blown at a wind velocity of 0.1 to 2 m/sec on the coating film surface when the solid content concentration of the coating composition is from 1 to 50%.

Also, after applying the coating composition for each layer on the support, the difference of temperature in the drying zone between the support and a transfer roll in contact with the surface opposite the coated surface of the support is preferably set to be from 0 to 20° C., because drying unevenness due to uneven heat transfer on the transfer roll can be prevented.

### (Curing)

The optical film of the present invention after drying the solvent is passed in the form of a web through a zone for curing each coating film by the irradiation of ionizing radiation and/or under the heat, whereby the coating film can be cured. The species of the ionizing radiation for use in the present invention is not particularly limited and according to the kind of the curable composition for forming a film, the radiation may be appropriately selected from ultraviolet ray, electron beam, near ultraviolet ray, visible light, near infrared ray, infrared ray, X-ray and the like. Among these, ultraviolet ray and electron beam are preferred, and ultraviolet is more preferred because the handling is easy and a high energy can be easily obtained.

As regards the light source of emitting ultraviolet ray for photopolymerizing an ultraviolet-reactive compound, any light source may be used as long as it emits an ultraviolet ray. Examples of the light source which can be used include a low-pressure mercury lamp, a medium-pressure mercury lamp, a high-pressure mercury lamp, an ultrahigh-pressure mercury lamp, a carbon arc lamp, a metal halide lamp and a xenon lamp. Also, an ArF excimer laser, a KrF excimer laser, an excimer lamp, a synchrotron radiation light and the like may be used. Among these, an ultrahigh-pressure mercury lamp, a high-pressure mercury lamp, a low-pressure mercury lamp, a carbon arc, a xenon arc and a metal halide lamp can be preferably used.

Furthermore, an electron beam may also be similarly used. Examples of the electron beam include electron beams having an energy of 50 to 1,000 kev, preferably from 100 to 300 keV, emitted from various electron beam accelerators such as Cockroft-Walton type, Van de Graff type, resonance transformer type, insulating core transformer type, linear type, dynamitron type and high frequency type.

The irradiation conditions vary depending on individual lamps, but the amount of irradiation light is preferably 10 mJ/cm² or more, more preferably from 50 to 10,000 mJ/cm², still more preferably from 50 to 2,000 mJ/cm². At this time, the irradiation dose distribution in the web width direction is preferably, including both edges, from 50 to 100%, more preferably from 80 to 100%, based on the maximum irradiation dose in the center.

In the present invention, at least one layer out of layers stacked on the support is preferably cured by a step of irradiating ionizing radiation and at the same time, irradiating the ionizing radiation in an atmosphere having an oxygen concentration of 1,000 ppm or less, preferably 500 ppm or less, more preferably 100 ppm or less, most preferably 50 ppm or less, for 0.5 seconds or more from the initiation of ionizing radiation irradiation in the state of the layer being heated at a film surface temperature of 50° C. or more.

It is also preferred that the layer is heated simultaneously with and/or successively to the irradiation of ionizing radiation, in an atmosphere having a low oxygen concentration.

In particular, the low refractive index layer which is an outermost layer and has a small film thickness is preferably cured by this method. The curing reaction is accelerated by the heat, and a film excellent in the physical strength and chemical resistance can be formed.

The time for which the ionizing radiation is irradiated is preferably from 0.7 to 60 seconds, more preferably from 0.7 to 10 seconds. If the irradiation time is less than 0.5 seconds, the curing reaction cannot be completed and satisfactory curing cannot be performed. Also, it is not preferred to keep the low oxygen condition for a long period of time, because large-scale equipment and a large amount of inert gas are required.

As for the means to reduce the oxygen concentration to 1,000 ppm or less, replacement of the atmospheric air with another gas is preferred, and replacement with nitrogen (nitrogen purging) is more preferred.

When the conditions are set such that the inert gas is supplied to the ionizing radiation irradiation chamber (also referred to as a “reaction chamber”) in which the curing reaction by ionizing radiation is performed, and at the same time, slightly blown out to the web inlet side of the reaction chamber, not only the carry-over air associated with the web conveyance can be eliminated to effectively decrease the oxygen concentration in the reaction chamber but also the substantial oxygen concentration on the extreme surface greatly susceptible to curing inhibition by oxygen can be efficiently reduced. The direction to which the inert gas flows on the web inlet side of the reaction chamber can be controlled by adjusting the balance between air supply and air discharge in the reaction chamber.

Blowing of the inert gas directly on the web surface is also preferred as the method for removing the carry-over air.

Furthermore, when a pre-chamber is provided before the reaction chamber and the oxygen on the web surface is previously eliminated, the curing can be allowed to proceed more efficiently. In order to efficiently use the inert gas, the gap between the side surface constituting the web inlet side of the ionizing radiation reaction chamber or pre-chamber and the web surface is preferably from 0.2 to 15 mm, more preferably from 0.2 to 10 mm, and most preferably from 0.2 to 5 mm. However, for continuously producing the web, the web needs to be joined and spliced and a method of laminating a bonding tape or the like is widely employed for joining. Therefore, when the gap between the inlet surface of the ionizing radiation reaction chamber or pre-chamber and the web is too small, there arises a problem that the bonding member such as bonding tape is hung up. To solve this problem, in the case of forming a narrow gap, at least a part of the inlet surface of the ionizing radiation reaction chamber or pr-chamber is preferably made movable, so that the gap can be enlarged for the thickness of the bonded part when the bonded part enters the chamber. This construction may be realized, for example, by a method where the inlet surface of the ionizing radiation reaction chamber or pre-chamber is made movable back and forth in the running direction and moved back and forth to enlarge the gap when the bonded part passes therethrough, or a method where the inlet surface of the ionizing radiation reaction chamber or pre-chamber is made movable perpendicularly to the web surface and moved vertically to enlarge the gap when the bonded part passes therethrough.

The ultraviolet ray may be irradiated on a plurality of constituent layers every time when one layer is formed or may be irradiated after the layers are stacked. Alternatively, some of these layers may be irradiated in combination. In view of productivity, the ultraviolet ray is preferably irradiated after stacking multiple layers.

In the present invention, at least one layer stacked on the support may be cured by a plurality of ionizing radiation irradiations. In this case, at least twice ionizing radiation irradiations are preferably performed in continuous reaction chambers where the oxygen concentration does not exceed 1,000 ppm. By performing a plurality of ionizing radiation irradiations in reaction chambers having the same low oxygen concentration, the reaction time necessary for curing can be effectively ensured.

Particularly, in the case of elevating the production speed for high productivity, a plurality of ionizing radiation irradiations become necessary for ensuring an ionizing radiation energy necessary for the curing reaction.

In the case where the curing percentage (100—percentage of residual functional group content) becomes a certain value less than 100%, at the time of providing another layer thereon and curing it by ionizing radiation and/or under heat, the curing percentage of the lower layer is preferably higher than that before providing the upper layer, because the adhesion between the lower layer and the upper layer is improved.

### (Handling)

In order to continuously produce the film of the present invention, a step of continuously feeding a rolled support film, a step of coating and drying the coating solution, a step of curing the coating film, and a step of taking up the support film having thereon the cured layer are performed.

A film support unrolled from a rolled film support is continuously fed to a clean room, static electricity charged to the film support is removed by a destaticizing apparatus in the clean room, and foreign matters adhering to the film support are then removed by a dedusting apparatus. Subsequently, a coating solution is coated on the film support in a coating part disposed in the clean room, and the coated film support is conveyed to a drying room and dried.

The film support having thereon the dried coating layer is delivered from the drying room to a curing room where the monomer contained in the coating layer is polymerized to effect curing. The film support having thereon the cured layer is further conveyed to a curing part where the curing is completed, and the film support having thereon the completely cured layer is taken up into a roll.

The above-described steps may be performed every time when each layer is formed, or a plurality of coating part-drying room-curing part lines may be provided to continuously perform the formation of respective layers.

In producing the film of the present invention, as described above, it is preferred that as well as the microfiltration operation of the coating solution, the coating step in the coating part and the drying step in the drying room are performed in an atmosphere having high air cleanliness and dirt and dust on the film are also satisfactorily removed before performing the coating. The air cleanliness in the coating step and drying step is, according to the standard of air cleanliness in US Federal Standard 209E, preferably not lower than class 10 (the number of particles of 0.5 μm or more is 353 per (cubic meter) or less), more preferably not lower than class 1 (the number of particles of 0.5 μm or more is 35.5 per (cubic meter) or less). The air cleanliness is preferably high also in the parts other than the coating-drying steps, such as delivery part and take-up part.

### (Saponification Treatment)

In producing a polarizing plate by using the film of the present invention for one film out of two surface protective films of the polarizing film, the surface on the side to be laminated with the polarizing film is preferably hydrophilized to improve the adhesive property on the adhesion surface.

a. Method by Dipping in Alkali Solution

This is a technique of dipping the film in an alkali solution under appropriate conditions to saponify all the surface having reactivity with an alkali on the entire film surface. This method requires no special equipment and is preferred in view of cost. The alkali solution is preferably an aqueous sodium hydroxide solution. The concentration is preferably from 0.5 to 3 mol/L, more preferably from 1 to 2 mol/L. The liquid temperature of the alkali solution is preferably from 30 to 75° C., more preferably from 40 to 60° C.

The combination of the saponification conditions is preferably a combination of relatively mild conditions but may be selected according to the material or constitution of the film or the objective contact angle.

The film after dipping in an alkali solution is preferably well washed with water or dipped in a dilute acid to neutralize the alkali component, so that the alkali component is not allowed to remain in the film.

By applying the saponification treatment, the surface opposite the surface having the coating layer is hydrophilized. The protective film for polarizing plate is used by bonding the hydrophilized surface of the transparent support to the polarizing film.

The hydrophilized surface is effective for improving the adhesive property to the adhesive layer comprising polyvinyl alcohol as a main component.

As for the saponification treatment, the contact angle for water on the transparent support surface opposite the surface having the coating layer is preferably lower in view of adhesive property to the polarizing film, but, on the other hand, in the dipping method, the surface having the coating layer as well as the inside of the layer are damaged simultaneously by an alkali and therefore, it is important to select minimum necessary reaction conditions. Particularly, in the case where the transparent support is triacetyl cellulose, the contact angle for water of the transparent support surface on the opposite side, when used as an index for the damage of each layer by an alkali, is preferably from 10 to 50°, more preferably from 30 to 50°, still more preferably from 40 to 50°. If the contact angle exceeds 50°, there arises a problem in the adhesive property to the polarizing film and this is not preferred, whereas if the contact angle is less than 10°, the film is too much damaged and the physical strength is disadvantageously impaired.

b. Method by Coating of Alkali Solution

In order to avoid the damage of each layer in the dipping method, an alkali solution coating method where an alkali solution is coated only on the surface opposite the surface having the coating layer under appropriate conditions and the coated solution is then heated, water-washed and dried, is preferably used. In this case, the “coating” means to contact an alkali solution or the like only with the surface to be saponified and includes spraying or contact with a belt or the like impregnated with the solution, other than coating. When such a method is employed, equipment and step for coating the alkali solution are separately required and therefore, this method is inferior to the dipping method of (1) in view of the cost. However, since the alkali solution comes into contact only with the surface to be saponified, the film may have, on the opposite surface, a layer using a material weak to an alkali solution. For example, a vapor deposition film or a sol-gel film is subject to various effects such as corrosion, dissolution and separation by an alkali solution and is not preferably provided in the case of dipping method, but in this coating method, such a film does not contact with the solution and therefore, can be used without problem.

The saponification methods (1) and (2) either can be performed after unrolling a rolled support and forming respective layers and therefore, the treatment may be added after the film production step and performed in a series of operations. Furthermore, by continuously performing also a step of laminating the film to a polarizing plate comprising a support unrolled similarly, a polarizing plate can be produced with higher efficiency than in the case of performing the same operations in the sheet-fed manner.

c. Method of Performing Saponification with Protection by Laminate Film

Similarly to (2) above, when the coating layer is insufficient in the resistance against an alkali solution, a method where after a final layer is formed, a laminate film is laminated on the surface where the final layer is formed, the laminate is then dipped in an alkali solution to hydrophilize only the triacetyl cellulose surface opposite the surface where the final layer is formed, and the laminate film is thereafter peeled off, may be employed. Also in this method, a hydrophilizing treatment enough as a polarizing plate protective film can be applied only to the triacetyl cellulose film surface opposite the surface where the final layer is formed, without damage to the coating layer. As compared with the method (2), this method is advantageous in that a special apparatus for coating an alkali solution is not necessary, though the laminate film remains as a waste.

d. Method by Dipping in Alkali Solution after Formation up to Mid-Layer

In the case where the layers up to a lower layer have resistance against an alkali solution but a layer thereon is insufficient in the resistance against an alkali solution, a method of forming the layers up to the layer, then dipping the film in an alkali solution to hydrophilize both surfaces, and thereafter forming the upper layer thereon, may be employed. The production process becomes cumbersome but this method is advantageous in that, for example, in a film comprising a hardcoat layer and a low refractive index layer formed of a fluorine-containing sol-gel film, when the layers have a hydrophilic group, the interlayer adhesion between the hardcoat layer and the low refractive index layer is enhanced.

e. Method of Forming Coating Layer on Previously Saponified Triacetyl Cellulose Film

After previously saponifying a triacetyl cellulose film, for example, by dipping it in an alkali solution, a coating layer may be formed on either one surface directly or through another layer. In the case of performing the saponification by dipping the film in an alkali solution, the interlayer adhesion to the triacetyl cellulose surface hydrophilized by the saponification is sometimes worsened. In such a case, the problem can be overcome by applying, after the saponification, a treatment such as corona discharge or glow discharge only to the surface where the coating layer is to be formed, thereby removing the hydrophilized surface, and then forming the coating layer. Also, when the coating layer has a hydrophilic group, good interlayer adhesion may be obtained.

### [Production of Polarizing Film]

The film of the present invention may be used as a protective film disposed on one side or both sides of a polarizing film, and the laminate can be used as a polarizing film.

While using the film of the present invention as one protective film, a normal cellulose acetate film may be used for the other protective film, but a cellulose acetate film produced by the above-described solution film-forming method and stretched in the width direction of a rolled film form at a stretch ratio of 10 to 100% is preferably used.

Furthermore, in the polarizing plate of the present invention, it is preferred that one surface is the optical film of the present invention and the other protective film is an optical compensation film having an optically anisotropic layer comprising a liquid crystalline compound.

The polarizing film includes an iodine-based polarizing film, a dye-based polarizing film using a dichroic dye, and a polyene-based polarizing film. The iodine-based polarizing film and the dye-based polarizing film are generally produced using a polyvinyl alcohol-based film.

The slow axis of the transparent support or cellulose acetate film of the optical film and the transmission axis of the polarizing film are arranged to run substantially in parallel.

The moisture permeability of the protective film is important for the productivity of the polarizing plate. The polarizing film and the protective film are laminated with an aqueous adhesive, and the solvent of this adhesive diffuses in the protective film and is thereby dried. As the moisture permeability of the protective film is higher, the drying rate and in turn the productivity are more elevated, but if the moisture permeability is excessively high, moisture enters into the polarizing film depending on the environment (at high humidity) where the liquid crystal display device is used, and the polarizing ability decreases.

The moisture permeability of the protective film is determined, for example, by the thickness of transparent support or polymer film (and polymerizable liquid crystal compound), the free volume or the hydrophilicity/hydrophobicity.

In the case of using the film of the present invention as a protective film of the polarizing plate, the moisture permeability is preferably from 100 to 1,000 g/m² 24 hrs, more preferably from 300 to 700 g/m²24 hrs.

In the film production, the thickness of the transparent support can be adjusted by the lip flow rate and the line speed or by stretching and compression. The moisture permeability varies depending on the main raw material used and therefore, can be adjusted to a preferred range by controlling the thickness.

In the film production, the free volume of the transparent support can be adjusted by the drying temperature and time.

Also in this case, the moisture permeability varies depending on the main raw material used and therefore, can be adjusted to a preferred range by controlling the free volume.

The hydrophilicity/hydrophobicity of the transparent support can be adjusted by an additive. The moisture permeability is elevated by adding a hydrophilic additive with the above-described free volume, and conversely, the moisture permeability can be lowered by adding a hydrophobic additive.

A polarizing plate having an optically compensating ability can be produced with high productivity at a low cost by independently controlling the moisture permeability.

The polarizing film may be a known polarizing film or a polarizing film cut out from a lengthy polarizing film with the absorption axis of the polarizing film being neither parallel nor perpendicular to the longitudinal direction. The lengthy polarizing film with the absorption axis of the polarizing film being neither parallel nor perpendicular to the longitudinal direction is produced by the following method.

This is a polarizing film obtained by stretching a continuously fed polymer film while holding its both edges with holding means and applying a tension and can be produced by a stretching method of stretching the film to from 1.1 to 20.0 times at least in the film width direction, moving the holding devices at both edges of the film to create a difference in the travelling speed of 3% or less in the longitudinal direction, and bending the film travelling direction in the state of the film being held at both edges such that the angle made by the film travelling direction at the outlet in the step of holding both edges of the film and the substantial stretching direction of the film is inclined at 20 to 70°. Particularly, a polarizing film produced with an inclination angle of 45° is preferred in view of productivity.

The stretching method of a polymer film is described in detail in JP-A-2002-86554 (paragraphs [0020] to [0030]).

It is also preferred that out of two protective films of a polarizer, the film other than the optical film of the present invention is an optical compensation film having an optical compensation layer comprising an optically anisotropic layer. The optical compensation film (phase difference film) can improve the viewing angle properties on a liquid crystal display screen.

The optical compensation film may be a known optical compensation film, but from the standpoint of enlarging the viewing angle, the optical compensation film described in JP-A-2001-100042 is preferred.

### [Use Mode of the Present Invention]

The optical film of the present invention is used for an image display device such as liquid crystal display (LCD), plasma display panel (PDP), electroluminescent display (ELD) and cathode ray tube display (CRT). The optical film of the present invention can be used on a known display such as plasma display panel (PDP) or cathode ray tube display (CRT).

### [Liquid Crystal Display Device]

The optical film or polarizing plate of the present invention can be advantageously used for an image display device such as liquid crystal display and is preferably used as the outermost surface layer of the display.

In general, the liquid crystal display device comprises a liquid crystal cell and two polarizing plates disposed on both sides thereof, and the liquid crystal cell carries a liquid crystal between two electrode substrates. Furthermore, one optically anisotropic layer is disposed between the liquid crystal cell and one polarizing plate, or two optically anisotropic layers are sometimes disposed, that is, one between the liquid crystal cell and one polarizing plate, and another between the liquid crystal cell and another polarizing plate.

The liquid crystal cell is preferably in TN mode, VA mode, OCB mode, IPS mode or ECB mode.

### (TN Mode)

In the TN-mode liquid crystal cell, rod-like liquid crystalline molecules are oriented substantially in the horizontal alignment at the time of not applying a voltage and furthermore, twisted at an angle of 60 to 120°.

The TN-mode liquid crystal cell is most frequently utilized in a color TFT liquid crystal display device and is described in a large number of publications.

### (VA Mode)

In the VA-mode liquid crystal cell, rod-like liquid crystalline molecules are oriented substantially in the vertical alignment at the time of not applying a voltage.

The VA-mode liquid crystal cell includes (1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625); (2) an (MVA-mode) liquid crystal cell where the VA mode is modified to a multi-domain system for enlarging the viewing angle (described in SID97, Digest of Tech. Papers (preprints), 28, 845 (1997)); (3) an (n-ASM-mode) liquid crystal cell where rod-like liquid crystalline molecules are oriented substantially in the vertical alignment at the time of not applying a voltage and oriented in the twisted multi-domain alignment at the time of applying a voltage (described in preprints of Nippon Ekisho Toronkai (Liquid Crystal Forum of Japan), 58-59 (1998)); and (4) a SURVAIVAL-mode liquid crystal cell (reported in LCD International 98).

### (OCB Mode)

The OCB-mode liquid crystal cell is a liquid crystal cell of bend orientation mode where rod-like liquid crystalline molecules are oriented substantially in the reverse direction (symmetrically) between upper portion and lower portion of the liquid crystal cell, and this is disclosed in U.S. Pat. Nos. 4,583,825 and 5,410,422. Since rod-like liquid crystalline molecules are symmetrically oriented between upper portion and lower portion of the liquid crystal cell, the liquid crystal cell of bend orientation mode has an optically self-compensating ability. Accordingly, this liquid crystal mode is called an OCB (optically compensatory bend) liquid crystal mode. The liquid crystal display device of bend orientation mode is advantageous in that the response speed is fast.

### (IPS Mode)

The IPS-mode liquid crystal cell employs a system of switching the nematic liquid crystal by applying a transverse electric field thereto, and this is described in detail in Proc. IDRC (Asia Display '95), pp. 577-580 and ibid., pp. 707-710.

### (ECB Mode)

In the ECB-mode liquid crystal cell, rod-like liquid crystalline molecules are oriented substantially in the horizontal alignment at the time of not applying a voltage. The ECB mode is one of liquid crystal display modes having a simplest structure and is described in detail, for example, in JP-A-5-203946.

### [Displays Other than Liquid Crystal Display Device]

### (PDP)

The plasma display panel (PDP) is generally composed of a gas, a glass substrate, an electrode, an electrode lead material, a thick print material and a fluorescent material. As for the glass substrate, two sheets of front glass substrate and rear glass substrate are used. An electrode and an insulating layer are formed on the two glass substrates, and a fluorescent material layer is further formed on the rear glass substrate. The two glass substrates are assembled, and a gas is sealed therebetween.

The plasma display panel (PDP) is already available on the market. The plasma display panel is described in JP-A-5-205643 and JP-A-9-306366.

In some cases, a front panel is disposed on the front surface of the plasma display panel. The front panel preferably has sufficiently high strength for protecting the plasma display panel. The front panel may be disposed with spacing from the plasma display panel or may be laminated directly to the plasma display body. In an image display device like the plasma display panel, the optical filter can be laminated directly to the display surface. In the case where a front panel is provided in front of the display, the optical filter may be laminated to the front side (outer side) or back side (display side) of the front panel.

### (Touch Panel)

The optical film of the present invention can be applied to a touch panel described, for example, in JP-A-5-127822 and JP-A-2002-48913.

### (Organic EL Device)

The optical film of the present invention can be used as a substrate (substrate film) or protective film of an organic EL device or the like.

In the case of using the optical film of the present invention for an organic EL device or the like, the contents described, for example, in JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617 and JP-A-2002-056976 may be applied. Furthermore, the contents described in JP-A-2001-148291, JP-A-2001-221916 and JP-A-2001-231443 are preferably used in combination.

### EXAMPLES

The present invention is described below by referring to Examples, but the present invention is not limited thereto.

TABLE 2
Preparation of Coating Solution for Hardcoat Layer:

| Raw Material | Coating Solution | HC-1 | HC-2 | HC-3 |
|---|---|---|---|---|
| Binder | DPHA | 16.1 | 46.0 | 48.3 |
| | Hardcoat coating | 27.3 | — | — |
| | solution containing | | | |
| | zirconia oxide | | | |
| | dispersion | | | |
| Particle | PMMA particle | 7.5 | — | — |
| | (monodispersion, 1.5 μm) | | | |
| | Styrene particle | — | 8.1 | — |
| | (monodispersion, 1.3 μm) | | | |
| | Silica-coated melamine | — | — | 5.8 |
| | resin particle | | | |
| | (monodispersion 2.0 μm) | | | |
| Initiator | Irgacure 184 | — | 2.2 | 2.2 |
| Leveling agent | FP-7 | — | 0.03 | 0.03 |
| Solvent | Methyl isobutyl ketone | 29.5 | 26.2 | 26.2 |
| | Methyl ethyl ketone | 19.6 | 17.5 | 17.5 |
| | Total | 100 | 100 | 100 |

The coating solutions HC-1 to HC-3 for hardcoat layer were prepared according to the Table above. In the Table, the numeral is in a mass % notation. Here, DPHA is a mixture of dipentaerythritol hexaacrylate and dipentaerythritol pentaacrylate [produced by Nippon Kayaku Co., Ltd.]; the hardcoat coating solution containing zirconia oxide dispersion is Desolite Z7404 as a methyl isobutyl ketone/methyl ethyl ketone (90/10 by mass %) solution [produced by JSR Corp]; the PMMA particle is MXS150H3CF with a particle diameter of 1.5 μm and a CV value of 9% [produced by Soken Kagaku K. K.]; the styrene particle is SX130 with a particle diameter of 1.5 μm and a CV value of 9% [produced by Soken Kagaku K. K.]; the silica-coated melamine resin particle is 2000M with a particle diameter of 2.0 μm and a CV value of 4% [produced by Nissan Chemicals Industries, Ltd.]; and Irgacure 184 is a polymerization initiator [produced by Ciba Specialty Chemicals]. These were thoroughly mixed and the solutions each was filtered through a polypropylene-made filter having a pore size of 30 μm to complete the coating solutions HC-1 to HC-3 for hardcoat layer.

### (Coating of Hardcoat Layer)

Using the slot die coater shown in FIG. 1 of JP-A-2003-211052, a 80 μm-thick triacetyl cellulose film (TAC-TD80U, produced by FUJIFILM Corporation) in a roll form was unrolled, and the coating solution HC-1 for hardcoat layer was coated thereon to have a coated amount of 16 ml/m², dried at 30° C. for 15 seconds and at 90° C. for 20 seconds, and then irradiated with an ultraviolet ray at an irradiation dose of 50 mJ/cm² by using an air-cooled metal halide lamp (manufactured by Eye Graphics Co., Ltd.) of 160 W/cm under nitrogen purging, thereby curing the coating layer. In this way, an optical film having a 7 μm-thick hardcoat layer (Comparative Sample 1) was produced and taken up.

Also, optical films with a hardcoat layer were produced thoroughly in the same manner as Comparative Sample 1 except for changing the amount added of the PMMA particle in HC-1 from 7.5 mass % to 3.5 mass % and 8.5 mass %. These samples are designated as Comparative Samples 2 and 3, respectively.

An optical film with a hardcoat layer was produced in the same manner as Comparative Sample 1 except for using the coating solution HC-2 for hardcoat layer in place of the coating solution HC-1 for hardcoat layer. This sample is designated as Comparative Sample 4. Also, optical films with a hardcoat layer were produced thoroughly in the same manner as Comparative Sample 1 except for changing the amount added of the styrene particle in HC-2 from 8.1 mass % to 10 mass % and 4.5 mass %. These samples are designated as Comparative Samples 5 and 6, respectively. Furthermore, a sample produced thoroughly in the same manner except for changing the styrene particle of Comparative Sample 4 to a polydivinylbenzene-based particle (particle diameter: 3.0 μm, CV value: 5%) (SP203) [produced by Sekisui Chemical Co., Ltd.] is designated as Comparative Sample 7.

An optical film with a hardcoat layer was produced in the same manner as Comparative Sample 1 except for using the coating solution HC-3 for hardcoat layer. This sample is designated as Example Sample 1. Optical films with a hardcoat layer were produced thoroughly in the same manner as Example Sample 1 except for changing the amount added of the silica-coated melamine resin particle in HC-3 from 5.8 mass % to 4.4 mass % and 4.8 mass %. These samples are designated as Example Samples 2 and 3. Also, samples produced thoroughly in the same manner except for changing the silica-coated melamine resin particle of Example Sample 1 to those having a particle diameter of 3.5 μm and a CV value of 4% (3500M) or a particle diameter of 6.5 μm and a CV value of 8% (6500M) [both produced by Nissan Chemicals Industries, Ltd.] or to a benzoguanaminemelamine resin particle (particle diameter: 4.0 μm, CV value: 7%) (EPOSTAR GP-H40) or a benzoguanaminemelamine resin particle (particle diameter: 2.0 μm, CV value: 30%) (EPOSTAR MS) [both produced by Nippon Shokubai Co., Ltd.] are designated as Example Sample 4, Example Sample 5, Comparative Sample 8 and Comparative Sample 9, respectively. A sample produced thoroughly in the same manner except that half of the silica-coated melamine resin particle of Example Sample 1 was replaced by one having a particle diameter of 3.5 μm and a CV value of 4% (3500M), is designated as Example Sample 6.

### (Internal Haze)

[1] The entire haze value (H) of the optical film obtained was measured according to JIS-K7136.

[2] After adding several silicone oil drops on the front and back surfaces of the optical film, the film was sandwiched from front and back by two 1 mm-thick glass plates (Microslide Glass No. S9111, produced by Matsunami K. K.), the haze was measured in a surface haze-removed state by bringing the two glass plates into complete contact with the optical film obtained, and the value obtained by subtracting, from this haze, the haze separately measured by interposing only the silicone oil between two glass plates was calculated as the internal haze (Hi).

[3] The value obtained by subtracting the internal haze (Hi) calculated in [2] above from the entire haze (H) measured in [1] above was calculated as the surface haze (Hs).

### (Surface Roughness)

The average value Ra of absolute deviations of the roughness curve from the centerline was measured according to JIS-BO601.

### (Evaluation of Rough Texture)

A polarizing plate produced using triacetyl cellulose TAC-TD80U (produced by FUJIFILM Corporation, thickness: 80 μm) and a polarizing plate produced using the optical film of the present invention were laminated to each other in a cross-Nicol arrangement to prepare a sample for inspection, and the surface rough texture (sparse or dense protrusion texture) on the optical film side was evaluated with an eye (inspection of reflection) in a bright room under 1,000 lux. The details are shown in Table 3 below.

⊚: The rough texture is very good (very fine texture)

◯: The rough texture is good.

◯Δ: The rough texture is fair.

Δ: The rough texture is slightly annoying.

×: The rough texture is bad.

### (Evaluation of Adhesion)

The adhesion between layers of the film or between the support and the coating layer can be measured by the following method.

The surface on the side having the coating layer is incised with a cutter knife at intervals of 1 mm to form 11 vertical lines and 11 horizontal lines in a crosshatch pattern and thereby define 100 squares in total. A test of press-bonding a polyester pressure-sensitive adhesive tape (No. 31B) produced by Nitto Denko Corp. and after standing for 24 hours, peeling off the tape is repeated three times on the same site, and the presence or absence of separation is observed with an eye.

◯: The number of squares separated out of 100 squares is 2 or less.

Δ: The number of squares separated out of 100 squares is from 3 to 10.

×: The number of squares separated out of 100 squares is 11 or more, and the adhesion is bad.

TABLE 3

| | | | Difference | CV Value | | | | | |
|---|---|---|---|---|---|---|---|---|---|
| | Refractive | Refractive | of | of | Surface | | | | |
| | Index of | Index of | Refractive | Particle | Haze | Internal | Ra | Rough | |
| Sample Name | Hardcoat | Particle | Index | (%) | (%) | Haze (%) | (μm) | Texture | Adhesion |
| Example Sample 1 | 1.51 | 1.65 | 0.14 | 4 | 3 | 79 | 0.06 | ◯ | ◯ |
| Example Sample 2 | 1.51 | 1.65 | 0.14 | 4 | 1 | 60 | 0.02 | ⊚ | ◯ |
| Example Sample 3 | 1.51 | 1.65 | 0.14 | 4 | 4 | 65 | 0.05 | ◯ | ◯ |
| Example Sample 4 | 1.51 | 1.65 | 0.14 | 4 | 1 | 64 | 0.03 | ⊚ | ◯ |
| Example Sample 5 | 1.51 | 1.65 | 0.14 | 8 | 6 | 70 | 0.08 | ◯Δ | ◯ |
| Example Sample 6 | 1.51 | 1.65 | 0.14 | 4 | 1 | 78 | 0.06 | ◯ | ◯ |
| Comparative Sample 1 | 1.62 | 1.51 | −0.11 | 9 | 6 | 68 | 0.08 | ◯Δ | Δ |
| Comparative Sample 2 | 1.62 | 1.51 | −0.11 | 9 | 5 | 32 | 0.07 | ◯ | Δ |
| Comparative Sample 3 | 1.62 | 1.51 | −0.11 | 9 | 6 | 77 | 0.09 | ◯Δ | Δ |
| Comparative Sample 4 | 1.51 | 1.61 | 0.10 | 9 | 6 | 45 | 0.09 | ◯Δ | X |
| Comparative Sample 5 | 1.51 | 1.61 | 0.10 | 9 | 6 | 55 | 0.08 | ◯Δ | X |
| Comparative Sample 6 | 1.51 | 1.61 | 0.10 | 9 | 4 | 25 | 0.07 | ◯ | X |
| Comparative Sample 7 | 1.51 | 1.62 | 0.11 | 5 | 2 | 45 | 0.04 | ◯ | Δ |
| Comparative Sample 8 | 1.51 | 1.57 | 0.06 | 7 | 4 | 58 | 0.06 | ◯ | Δ |
| Comparative Sample 9 | 1.51 | 1.57 | 0.06 | 30 | 7 | 42 | 0.11 | Δ | Δ |

As seen from Table 3, when a silica-coated particle is used, a film having very high internal haze can be obtained. Also, the weather resistance is enhanced. Furthermore, in order to improve the rough texture, the Ra value is preferably less than 0.10 μm, more preferably less than 0.07 μm, and most preferably less than 0.05 μm.

As regards Example Samples 2 and 3, optical films were produced thoroughly in the same manner except for changing the fluorine-based leveling agent FP-7 used in each hardcoat layer according to four formulations, that is, (1) FP-7 was removed; (2) FP-7 was removed and the same amount of fluorine-based leveling agent FP-86 was used in place of FP-7; (3) FP-7 was removed and the same amount of silicone-based leveling agent X-22-945 (produced by Shin-Etsu Chemical Co., Ltd.) was used in place of FP-7; (4) the amount of FP-7 was reduced to half and silicone-based leveling agent X-22-945 was added in half the amount of FP-7, and the external surface state of each optical film was evaluated. The external surface state was evaluated as follows.

### (Evaluation of External Surface State)

A polarizing plate produced using triacetyl cellulose TAC-TD80U (produced by FUJIFILM Corporation, thickness: 80 μm) and a polarizing plate produced using the optical film of the present invention were laminated to each other in a cross-Nicol arrangement to prepare a sample for inspection, and the external surface state on the optical film side was evaluated with an eye (inspection of reflection) in a dark room under a stand-type three-wavelength fluorescent lamp.

The surface state of Examples Samples 2 and 3 was very good, whereas the sample group of (1) exhibited poor surface state and was not good. On the other hand, the sample group of (2) or (3) had good surface state similarly to Example Samples 2 and 3 and was revealed to be an excellent optical film. Also, in the sample group of (4) using a fluorine-based leveling agent and a silicone-based leveling agent in combination, the surface state was further enhanced to one rank higher and these were a very excellent optical film.

### (Coating of Low Refractive Index Layer)

### [Preparation of Sol Solution (a)]

In a reaction vessel equipped with a stirrer and a reflux condenser, 119 parts by mass of methyl ethyl ketone, 101 parts by mass of 3-acryloyloxypropyltrimethoxysilane “KBM-5103” {produced by Shin-Etsu Chemical Co., Ltd.} and 3 parts by mass of diisopropoxyaluminum ethyl acetate were added and mixed and after adding 30 parts by mass of ion-exchanged water, the reaction was allowed to proceed at 60° C. for 4 hours. The reaction solution was cooled to room temperature to obtain Sol Solution (a). The mass average molecular weight of Sol Solution (a) was 1,600 and out of the oligomer or higher components, the proportion of the components having a molecular weight of 1,000 to 20,000 was 100 mass %. Also, the gas chromatography analysis revealed that the raw material acryloyloxypropyltrimethoxysilane was not remaining at all. This was finally produced as a methyl ethyl ketone solution, and the solid content concentration therein was 29 wt %.

### [Preparation of Coating Solution for Low Refractive Index Layer]

The coating solutions LN-1 to LN-9 for low refractive index layer were prepared according to the Table below. In the Table, the numeral is in the notation of parts by mass.

TABLE 4

| | | Name of Coating Solution | | | | | | | | |
|---|---|---|---|---|---|---|---|---|---|---|
| Name of Raw Material | | LN-1 | LN-2 | LN-3 | LN-4 | LN-5 | LN-6 | LN-7 | LN-8 | LN-9 |
| Fluorine- | JTA-113 | 53.0 | 53.0 | 53.0 | 53.0 | 52.1 | 55.6 | 56.5 | 55.6 | — |
| containing binder | P-3 | — | — | — | — | — | — | — | — | 7.51 |
| Binder | Sol (a) | — | 2.58 | 2.58 | 2.58 | 2.58 | 1.92 | 1.88 | 1.92 | 0.95 |
| Particle | MEK-ST | — | — | 5.57 | — | — | — | — | — | — |
| | MEK-ST-L | — | — | — | 5.57 | 5.57 | 5.57 | 5.57 | 5.57 | 6.12 |
| Initiator | Solution of the Compound 21 | — | — | — | — | 2.82 | 2.08 | 1.73 | 2.08 | 0.05 |
| | (shown below) | | | | | | | | | |
| | MP-Triazine | — | — | — | — | — | — | — | — | 0.09 |
| Additive | RMA-033 | — | — | — | — | — | — | — | — | 2.75 |
| | Compound b-13 in Table 1 | — | — | — | — | — | — | — | 0.07 | — |
| Solvent | Methyl ethyl ketone | 44.2 | 41.6 | 36.0 | 36.0 | 34.1 | 32.0 | 31.5 | 32.0 | 75.1 |
| | Cyclohexanone | 2.83 | 2.83 | 2.83 | 2.83 | 2.83 | 2.83 | 2.83 | 2.83 | 7.51 |

| | | | | | | | | | |
|---|---|---|---|---|---|---|---|---|---|
| Total | 100 | 100 | 100 | 100 | 100 | 100 | 100 | 100 | 100 |

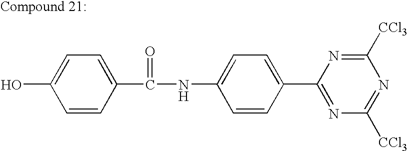

The coating solutions above each was filtered through a polypropylene-made filter having a pore size of 1 μm to complete the coating solutions for low refractive index layer (LN-1 to LN-9).

The compounds used for the production of each coating solution above are shown below. “JTA-113”: a thermal crosslinking fluorine-containing polymer solution containing a silicone moiety, in which the refractive index is 1.44, the solid content concentration is 6 mass %, the solvent is methyl ethyl ketone, and the solid content is consisting of 78 mass % of thermal crosslinking fluorine-containing polymer containing a silicone moiety, 20 mass % of melamine-based crosslinking agent and 2 mass % of paratoluene sulfonate, produced by JSR Corp.; “P-3”: Fluorine-Containing Copolymer (P-3) described in JP-A-2004-45462, in which the mass average molecular weight is about 50,000, the solid content concentration is 23.8 mass % and the solvent is methyl ethyl ketone; “MEK-ST”: a silica particle liquid dispersion, in which the average particle diameter is 15 nm, the solid content concentration is 30 mass % and the dispersion solvent is methyl ethyl ketone, produced by Nissan Chemicals Industries, Ltd.; “MEK-ST-L”: a silica particle liquid dispersion, in which the average particle diameter is 45 nm, the solid content concentration is 30 mass % and the dispersion solvent is methyl ethyl ketone, produced by Nissan Chemicals Industries, Ltd.; “Solution of the Compound 21”: the solid content concentration is 2 mass % and the solvent is methyl ethyl ketone; “MP-triazine”: a photopolymerization initiator, produced by Sanwa Chemical Co., Ltd.; and “RMS-033”: a reactive silicone resin, produced by Gelest. Furthermore, the hollow silica liquid dispersion described later is “hollow silica liquid dispersion”: CS-60 using isopropyl alcohol as the dispersion solvent, produced by Catalysts & Chemicals Ind. Co., Ltd., which is a hollow silica particle liquid dispersion obtained by surface-modifying (surface modification ratio: 30 mass % based on hollow silica) a hollow silica particle having a refractive index of 1.31, an average particle diameter of 60 nm and a shell thickness of 10 nm with “KBM-5103 (a silane coupling agent produced by Shin-Etsu Chemical Co., Ltd.)” and which is a liquid dispersion having a solid content concentration of 18.2 mass %.

### (Coating 1 of Low Refractive Index Layer)

After coating various hardcoat layers of the present invention, the coating solutions for low refractive index layer LN-1 to LN-8 each was wet-coated thereon by a bar coater to give a low refractive index layer dry thickness of 95 nm, then dried at 120° C. for 150 seconds, further dried at 100° C. for 8 minutes and thereafter irradiated with an ultraviolet ray at an irradiation dose of 110 mJ/cm² by using an air-cooled metal halide lamp (manufactured by Eye Graphics Co., Ltd.) of 240 W/cm in an atmosphere having an oxygen concentration reduced to 100 ppm under nitrogen purging, thereby forming a low refractive index layer, and the resulting film was taken up.

### (Coating 2 of Low Refractive Index Layer)

After coating various hardcoat layers of the present invention, the coating solution for low refractive index layer LN-9 was wet-coated thereon by a die coater to give a low refractive index layer dry thickness of 95 nm, then dried at 120° C. for 70 seconds and further irradiated with an ultraviolet ray at an irradiation dose of 400 mj/cm² by using an air-cooled metal halide lamp (manufactured by Eye Graphics Co., Ltd.) of 240 W/cm in an atmosphere having an oxygen concentration reduced to 100 ppm under nitrogen purging, thereby forming a low refractive index layer, and the resulting film was taken up.

Samples were produced thoroughly in the same manner as Example Samples 1 to 6 and Comparative Sample 1 except for applying the coating solution LN-6 onto each hardcoat layer of Example Samples 1 to 6 and Comparative Sample 1 according to the above-described coating method of low refractive index layer. These samples are designated as Example Samples 101 to 106 and Comparative Sample 101, respectively. Also, the triacetyl cellulose TAC TD80U (produced by FUJIFILM Corporation) is designated as Comparative Sample 102.

### (Viewing Angle in Oblique Direction)

The viewing-side polarizing plate provided in a liquid crystal display device (20″ TV, LC-20AX5, manufactured by Sharp Corp.) using a VA-mode liquid crystal cell was removed and instead, the polarizing plate using the optical film of the present invention was laminated thereto by bonding the back surface through a pressure-sensitive adhesive, with the coated surface being on the viewing side. The liquid crystal display device was displayed in white and the contrast ratio in the polar angle direction at an azumuthal direction of 45° from the front face of the liquid crystal television was measured using a measuring apparatus (“EZ-Contrast 160D”, manufactured by ELDIM). The angle at which the contrast ratio became 20 or less was determined.

TABLE 5

| | Viewing Angle in |
|---|---|
| Sample Name | Oblique Direction |
| Example Sample 101 | 85 |
| Example Sample 102 | 78 |
| Example Sample 103 | 80 |
| Example Sample 104 | 79 |
| Example Sample 105 | 81 |
| Example Sample 106 | 82 |
| Comparative Sample 101 | 80 |
| Comparative Sample 102 | 70 |

As seen from Table 5, the viewing angle can be enlarged by using any one of these optical films Also, Example Samples 101 to 106 can enlarge the viewing angle similarly to Comparative Sample 101 using an expensive zirconia oxide dispersion. In particular, Example Sample 6 is preferred because of no tint when the liquid crystal display device is displayed in white.

In Example Sample 102, (1) MEK-ST (a methyl ethyl ketone dispersion of SiO₂ sol having an average particle diameter of 10 to 20 nm and a solid content concentration of 30 mass % [produced by Nissan Chemicals Industries, Ltd.]) was added to adjust the refractive index of hardcoat to 1.44. The difference in the refractive index from the resin particle was 0.21. The viewing-side polarizing plate provided in a liquid crystal display device (20″ TV, LC-20AX5, manufactured by Sharp Corp.) using a VA-mode liquid crystal cell was removed and instead, the polarizing plate using this optical film of the present invention was laminated thereto by bonding the back surface through a pressure-sensitive adhesive, with the coated surface on the viewing side. The liquid crystal display device was set to the white/black display mode and the contrast (ratio of white luminance and black luminance) was measured using a measuring apparatus (“EZ-Contrast 160D”, manufactured by ELDIM). As a result, the contrast was decreased by 15% as compared with Example Sample 102. The difference in the refractive index between the hardcoat layer and the resin particle is preferably 0.20 or less.

Samples were produced thoroughly in the same manner as Example Sample 103 except that in Example Sample 103, (1) the amount of the resin particle in the hardcoat layer was increased or decreased (the surface haze was adjusted); (2) the fine titanium dioxide particle shown below was added to the hardcoat layer to increase the refractive index of the hardcoat layer (the refractive index of the hardcoat layer was adjusted; the refractive index n can be adjusted by the amount of titanium dioxide filled); (3) the mixing ratio between JTA-113 and Sol (a) in the low refractive index layer was changed (the refractive index of the low refractive index layer was adjusted); (4) the silica fine particle in the low refractive index layer was replaced by the above-described hollow silica fine particle (the refractive index of the low refractive index layer was adjusted); or (5) the amount of the hollow silica fine particle used was increased (the refractive index of the low refractive index layer was adjusted). These are designated as Example Samples 201 to 219. The details are shown in Table 6 below.

As for the fine titanium dioxide particle, a fine titanium dioxide particle (MPT-129C, produced by Ishihara Sangyo Kaisha, Ltd.; TiO₂:Co₃O₄:Al₂O₃:ZrO₂=90.5:3.0:4.0:0.5 by weight) containing cobalt and being surface-treated with aluminum hydroxide and zirconium hydroxide, was used. 41.1 Parts by mass of the dispersant shown below and 701.8 parts by mass of cyclohexanone was added to 257.1 parts by mass of this fine titanium dioxide particle and dispersed by a Dynomill to prepare a titanium dioxide liquid dispersion having a weight average diameter of 70 nm. This liquid dispersion was added to the coating solution for hardcoat layer of the present invention and the formulation amount was adjusted.

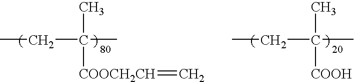

### (Reflectance)

In the measurement of the specular reflectance, an adapter ”ARV-474” was loaded in a spectrophotometer “V-550” [manufactured by JASCO Corp.], the specular reflectance for the outgoing angle of −5° at an incident angle of 5° was measured in the wavelength region of 380 to 780 nm, and an average specular reflectance at 450 to 650 nm was calculated. In the measurement of the integrated reflectance, an adapter “ILV-471” was loaded in a spectrophotometer “V-550” [manufactured by JASCO Corp.], the integrated reflectance at an incident angle of 5° was measured in the wavelength region of 380 to 780 nm, and an average integrated reflectance at 450 to 650 nm was calculated.

### (Denseness of Black at Black Display)

The viewing-side polarizing plate provided in a liquid crystal display device (20″ TV, LC-20AX5, manufactured by Sharp Corp.) using a VA-mode liquid crystal cell was removed and instead, the polarizing plate using the optical film of the present invention was laminated thereto by bonding the back surface through a pressure-sensitive adhesive, with the coated surface on the viewing side. The liquid crystal display device was set to the black display mode in a bright room under 1,000 lux, and the black display was evaluated with an eye by the following scoring.

On a scale of 1 to 20, the score of 20 indicates a perfect black display absolutely free from light-brownish appearing due to outside light, whereas the score of less than 5 indicates a display with too strong light-brownish appearing due to outside light and unallowable as the black display.

TABLE 6

| | | | Mixing | | | | | Denseness of |
|---|---|---|---|---|---|---|---|---|
| | Amount of | | Ratio in | Amount of | | | | Black at |
| | Particle | Amount of | Low | Hollow | Integrated | Specular | | Black |
| | in Hardcoat | Titanium | Refractive | Silica | Reflectance | Reflectivity | B − A | Display Time |
| Sample Name | Layer | Oxide | Index Layer | Dispersion | B (%) | A (%) | (%) | (score) |
| Example Sample 103 | 4.8 | 0 | 29 | 0 | 2.7 | 2.0 | 0.7 | 15 |
| Example Sample 201 | 2.4 | 0 | 29 | 0 | 2.7 | 2.4 | 0.3 | 17 |
| Example Sample 202 | 3.6 | 0 | 29 | 0 | 2.7 | 2.2 | 0.5 | 17 |
| Example Sample 203 | 5.2 | 0 | 29 | 0 | 2.7 | 1.7 | 1.0 | 14 |
| Example Sample 204 | 5.6 | 0 | 29 | 0 | 2.7 | 1.5 | 1.2 | 13 |
| Example Sample 205 | 6.0 | 0 | 29 | 0 | 2.7 | 1.2 | 1.5 | 12 |
| Example Sample 206 | 6.3 | 0 | 29 | 0 | 2.7 | 1.1 | 1.6 | 11 |
| Example Sample 207 | 6.5 | 0 | 29 | 0 | 2.7 | 0.9 | 1.8 | 11 |
| Example Sample 208 | 4.8 | 0 | 15 | 0 | 3.4 | 2.9 | 0.5 | 13 |
| Example Sample 209 | 4.8 | 0 | 10 | 0 | 3.7 | 3.2 | 0.5 | 13 |
| Example Sample 210 | 4.8 | 0 | 20 | 0 | 3.0 | 2.5 | 0.5 | 17 |
| Example Sample 211 | 4.8 | 7 | 29 | 0 | 2.2 | 1.7 | 0.5 | 16 |
| Example Sample 212 | 4.8 | 10 | 29 | 0 | 2.0 | 1.5 | 0.5 | 17 |
| Example Sample 213 | 4.8 | 0 | 29 | 5.6 | 1.2 | 0.7 | 0.5 | 18 |
| Example Sample 214 | 4.8 | 0 | 29 | 6.0 | 1.0 | 0.5 | 0.5 | 19 |
| Example Sample 215 | 4.8 | 0 | 29 | 7.5 | 0.8 | 0.3 | 0.5 | 19 |
| Example Sample 216 | 2.4 | 10 | 29 | 0 | 2.0 | 1.7 | 0.3 | 17 |
| Example Sample 217 | 5.4 | 10 | 29 | 0 | 2.0 | 1.3 | 0.7 | 16 |
| Example Sample 218 | 6 | 10 | 29 | 0 | 2.0 | 1.0 | 1.0 | 15 |
| Example Sample 219 | 6.5 | 10 | 29 | 0 | 2.0 | 0.8 | 1.2 | 14 |

kind of a light-transparent resin having a heat-curable functional group and at least one kind of a heat-curable crosslinking agent is 0.24 in LN-5 (Example Sample 305), 0.18 in LN-6 (Example Sample 103) and 0.16 in LN-7 (Example Sample 307). Samples (Example Samples 401 to 410) produced thoroughly in the same manner as Example Sample 103 except that the coating solution for low refractive index layer was produced by varying (X) in the range from 0 to 0.3 by such a preparation method, were evaluated. The results obtained are shown in Table 8. It is seen that (X) in the optical film of the present invention is preferably from 0.05 to 0.19, more preferably from 0.10 to 0.19, still more preferably from 0.15 to 0.19.

TABLE 8

| | | Steel Wool Rubbing |
|---|---|---|
| Sample Name | (X) | Resistance (score) |
| Example Sample 401 | 0 | 3 |
| Example Sample 402 | 0.04 | 3 |
| Example Sample 403 | 0.05 | 8 |
| Example Sample 404 | 0.08 | 8 |
| Example Sample 405 | 0.10 | 8.5 |
| Example Sample 406 | 0.13 | 8.5 |
| Example Sample 407 | 0.14 | 8.5 |
| Example Sample 307 | 0.15 | 9 |
| Example Sample 103 | 0.18 | 9 |
| Example Sample 408 | 0.19 | 9 |
| Example Sample 409 | 0.21 | 7.5 |
| Example Sample 305 | 0.24 | 7.5 |
| Example Sample 410 | 0.30 | 7.5 |

Samples produced thoroughly in the same manner as Example Sample 309 except that in Example Sample 309, the amount of RMS-033 in the coating solution LN-9 which is the coating solution for low refractive index layer was increased

As seen from Table 6, in samples of the present invention, B is 3% or less and B-A is 1.5% or less, whereby an optical film ensuring good denseness of black at the black display time in a bright-room environment can be provided. Furthermore, it is seen that B is preferably 2% or less, more preferably 1% or less, and B-A is preferably 1% or less, more preferably 0.5% or less.

Samples produced thoroughly in the same manner as Example Sample 103 except that in Example Sample 103, the coating solutions LN-1 to LN-5 and LN-7 to LN-9 were used in place of the coating solution LN-6 and each was coated according to the above-described coating method for low refractive index layer, were designated as Example Samples 301 to 305 and Example Samples 307 to 309. Also, samples produced thoroughly in the same manner as Example Sample 103 except that in the coating solution LN-6, the size of the silica fine particle contained in the low refractive index layer was changed from 45 nm to 95 nm (100% of the thickness of low refractive index layer), 145 nm (150% of the thickness of low refractive index layer) and 160 nm (160% of the thickness of low refractive index layer) (these coating solutions are named as LN-61, LN-62 and LN-63), were designated as Example Samples 310 to 312. The details are shown in Table 7 below.

### (Steel Wool Rubbing Resistance <Scratch Resistance (ii)>)

The scratch resistance of the optical film can be evaluated by performing a rubbing test using a rubbing tester under the following conditions.

Environmental conditions of evaluation: 25° C. and 60% RH; rubbing material: a steel wool (Grade No. #0000, manufactured by Nippon Steel Wool K. K.) wound around the rubbing tip (1 cm×1 cm) of the tester, which comes into contact with the sample, and fixed by a band not to move; moving distance (one way): 13 cm; rubbing speed: 13 cm/sec; load: 500 g/cm²; contact area of tip: 1 cm×1 cm; and number of rubbings: 10 reciprocations.

An oily black ink was applied to the back side of the rubbed sample, and the rubbed portion (scratches therein) and the non-rubbed portion were compared by reflected light with an eye and scored (on a scale of 1 to 10). The score of 10 indicates that scratches were not observed at all. When the score is 2 or less, the scratch resistance is not good.

TABLE 7

| | Coating Solution | Steel Wool |
|---|---|---|
| | for Low | Rubbing |
| | Refractive Index | Resistance |
| Sample Name | Layer | (score) |
| Example Sample 103 | LN-6 | 9 |
| Example Sample 301 | LN-1 | 3 |
| Example Sample 302 | LN-2 | 4 |
| Example Sample 303 | LN-3 | 5 |
| Example Sample 304 | LN-4 | 6 |
| Example Sample 305 | LN-5 | 7 |
| Example Sample 307 | LN-7 | 8 |
| Example Sample 308 | LN-8 | 9 |
| Example Sample 309 | LN-9 | 10 |
| Example Sample 310 | LN-61 | 8 |
| Example Sample 311 | LN-62 | 6 |
| Example Sample 312 | LN-63 | 4 |

In Example Sample 312, the steel wool rubbing resistance is slightly lower. This is considered to result because the particle diameter of the silica fine particle is 160% of the thickness of low refractive index layer and the silica fine particle can be hardly retained in the low refractive index layer.

Table 7 reveals the followings. In the optical film of the present invention, (1) the low refractive index layer contains a fine particle having a particle diameter corresponding to 15 to 150% of the thickness of the low refractive index layer; (2) at least one kind of a light-transparent resin constituting the low refractive index layer has an ultraviolet (UV)-curable and/or heat-curable functional group; (3) the low refractive index layer comprises at least two or more kinds of light-transparent resins, at least one kind of the light-transparent resin has an ultraviolet (UV)-curable functional group, and at least one different kind of the light-transparent resin has a heat-curable functional group; (4) the low refractive index layer further contains at least one kind of a polymerization initiator and/or at least one kind of a heat-curable crosslinking agent; or (5) the low refractive index layer further contains a curing catalyst capable of accelerating the thermal curing, whereby an optical film more excellent in the scratch resistance can be provided. As for the effect of (5), the same effect could be confirmed even when the compound b-13 shown in [Table 1] above, contained in the coating solution LN-8, was replaced by the compound b-19 shown in [Table 1] above.

The value (X) obtained by dividing the total weight of at least one kind of a light-transparent resin having an ultraviolet (UV)-curable functional group and at least one kind of a polymerization initiator, contained in the low refractive index layer, by the total weight of at least one or decreased, are designated as Example Samples 501 to 508. The details are shown in Table 9 below.

### (Evaluation of Antifouling Property)

As an index for good or bad antifouling property, the optical film obtained was subjected to evaluations of removability of (1) marker stain and (2) fingerprint stain ((1) removability of marker stain: after writing on the optical film by using a black marker, Macky Care Gokuboso (produced by ZEBRA Co.) and allowing to stand for one whole day, the removability by wiping with a tissue paper was evaluated; (2) removability of fingerprint stain: after pressing a finger against the optical film to attach a fingerprint and allowing to stand for one whole day, the removability by wiping with tissue paper was evaluated). On a scale of 1 to 6, the score of 6 indicates a maximum level in which the marker or fingerprint can be easily wiped off only by lightly wiping the stain.

Also, the contact angle was measured by dropping several pure water drops on the surface of each optical film and its correspondence with the antifouling property was examined.

TABLE 9

| | | Antifouling Property | |
|---|---|---|---|
| | Contact Angle | (score) | |
| Sample Name | (pure water) | Marker | Fingerprint |
| Example Sample 103 | 104° | 6 | 6 |
| Example Sample 309 | 108° | 6 | 6 |
| Example Sample 501 | 103° | 5.5 | 5.5 |
| Example Sample 502 | 99° | 5.5 | 5.5 |
| Example Sample 503 | 98° | 5 | 5 |
| Example Sample 504 | 94° | 5 | 5 |
| Example Sample 505 | 93° | 4.5 | 4.5 |
| Example Sample 506 | 90° | 4.5 | 4.5 |
| Example Sample 507 | 84° | 3 | 3 |
| Example Sample 508 | 83° | 3 | 3 |

As seen from Table 9, in view of the antifouling property, the pure water contact angle of the optical film of the present invention is preferably 90° or more, more preferably 95° or more, still more preferably 100° or more, and most preferably 105° or more. By adjusting the contact angle of the optical film of the present invention to fall within the desired range, an optical film having very good antifouling property can be provided.

Samples produced thoroughly in the same manner as Example Sample 305 except that in Example Sample 305, KF-96 (10 cs) [silicone oil, produced by Shin-Etsu Chemical Co., Ltd.] was further added to the coating solution LN-5 which is the coating solution for low refractive index layer, are designated as Example Samples 601 to 606. Also, samples produced thoroughly in the same manner as Example Sample 103 except that in Example Sample 103, KF-96 (10 cs) [silicone oil, produced by Shin-Etsu Chemical Co., Ltd.] was further added to the coating solution LN-6 which is the coating solution for low refractive index layer, are designated as Example Samples 607 and 608. Furthermore, Example Samples 309, 502, 504, 506, 507 and 508 were prepared. These samples were subjected to evaluation of steel wool rubbing resistance. The details are shown in Table 10 below.

### (Measurement of Coefficient of Dynamic Friction)

The optical film of the present invention was previously left standing for 2 hours or more in an environment of 25° C. and 60% RH and thereafter, measured by a dynamic friction measuring meter, HEIDON-14, with a 5 mmφ stainless steel ball under a load of 100 g at a speed of 60 cm/min, and the obtained value was used.

TABLE 10

| | | Steel Wool |
|---|---|---|
| | Coefficient of | Rubbing |
| Sample Name | Dynamic Friction | Resistance (score) |
| Example Sample 305 | 0.24 | 8 |
| Example Sample 601 | 0.21 | 8 |
| Example Sample 602 | 0.19 | 9 |
| Example Sample 603 | 0.15 | 9 |
| Example Sample 604 | 0.12 | 9 |
| Example Sample 605 | 0.10 | 10 |
| Example Sample 606 | 0.08 | 10 |
| Example Sample 103 | 0.24 | 9 |
| Example Sample 607 | 0.19 | 10 |
| Example Sample 608 | 0.14 | 10 |
| Example Sample 309 | 0.22 | 10 |
| Example Sample 502 | 0.24 | 10 |
| Example Sample 504 | 0.27 | 10 |
| Example Sample 506 | 0.31 | 10 |
| Example Sample 507 | 0.36 | 7 |
| Example Sample 508 | 0.39 | 7 |

As seen from Table 10, the coefficient of dynamic friction of the optical film of the present invention is preferably 0.3 or less, more preferably 0.2 or less, and most preferably 0.1 or less. By adjusting the coefficient of dynamic friction of the optical film of the present invention to fall within the desired range, an optical film having very good scratch resistance can be provided.

The dust resistance of the optical film of the present invention is then evaluated. The evaluation of dust resistance is performed as follows.

### (Evaluation of Dust Resistance)

After humidity-conditioning the optical film of the present invention at 25° C. and 60% RH for 2 hours, the optical film was destaticized (zero cancelling) by a destaticizer in the same environment and then strongly rubbed 20 times with dry tissue paper by a constant force, and thereafter, tissue paper scraps separately prepared were spread on the optical film. Subsequently, the optical film surface was vertically erected on a desk, and the way of falling of tissue paper scraps (dust resistance) was evaluated by tapping the end face of the optical film three times. On a scale of 1 to 10, the score of 10 indicates a maximum level in which tissue paper scraps are not attached at all.

### (Preparation of Coating Solution for Antistatic Layer)

A commercially available transparent antistatic paint, ”Peltron C-4456S-7” (solid content concentration: 45%, produced by Nippon Pelnox Corp.), was used as the coating solution for antistatic layer of the present invention (however, the antistatic layer of the present invention is not limited thereto). C-4456S-7 is a paint for transparent antistatic layer containing an electrically conducting fine particle ATO dispersed using a dispersant. The refractive index of the coating film formed of this paint was 1.55.

### (Coating of Antistatic Layer)

The transparent antistatic layer above was provided between the hardcoat layer and the low refractive index layer of the optical film of the present invention described later. As for the coating method, the coating solution for antistatic layer was coated by a microgravure coating system, dried at 30° C. for 15 seconds and at 90° C. for 20 seconds, and cured by irradiating an ultraviolet ray thereon at an irradiation dose of 50 mJ/cm² with use of an air-cooled metal halide lamp (manufactured by Eye Graphics Co., Ltd.) of 160 W/cm under nitrogen purging, thereby providing a transparent antistatic layer having a thickness of 1.2 μm.

### (Measurement of Surface Resistance Value)

The surface resistance value on the coating layer side of the optical film of the present invention was measured using an ultra-insulating resistance/microammeter, TR8601 (manufactured by Advantest Corp.). The measurement sample was previously left standing for 2 hours or more in an environment of 25° C. and 60% RH. The denotation is on the order of Ω/square.

### (Measurement of Vertical Separation Charge)

Similarly to the measurement of surface resistance value above, the measurement sample was previously left standing for 2 hours or more in an environment of 25° C. and 60% RH. The measuring apparatus was comprising a stage on which the measurement sample is placed, and a head for holding the other party film, which can repeat pressing from above to the measurement sample and separation therefrom. A polyethylene terephthalate was loaded in this head and after removing electricity from the measuring part, the head was repeatedly pressed to and separated from the measurement sample. The electric charge value was read at the first separation and at the fifth separation, and the obtained values were averaged. By varying the sample, this operation was repeated on three samples. All values were averaged and the obtained value was used as the vertical separation charge.

A sample produced thoroughly in the same manner as Example Sample 103 except for providing the above-described antistatic layer between the hardcoat layer and the low refractive index layer of Example Sample 103 is designated as Example Sample 702, and samples produced thoroughly in the same manner as Example Sample 702 except for changing the surface resistance value by increasing or decreasing the amount of ATO in the antistatic layer of Example Sample 702 are designated as Example Samples 701 and 703 to 705. Also, Example Samples 309, 501, 502, 504, 505, 506, 507 and 508 were prepared. The surface resistance value, vertical separation charge and dust resistance of the optical film were evaluated. The details are shown in Table 11 below.

TABLE 11

| | Surface | Vertical | |
|---|---|---|---|
| | Resistance | Separation | Dust |
| | Value | Charge | Resistance |
| Sample Name | (Ω/square) | (pc/cm²) | (score) |
| Example Sample 103 | 10¹⁵ | −30 | 7.5 |
| Example Sample 309 | 10¹⁵ | −40 | 7.5 |
| Example Sample 501 | 10¹⁵ | −70 | 7 |
| Example Sample 502 | 10¹⁵ | −100 | 7 |
| Example Sample 504 | 10¹⁵ | −130 | 6 |
| Example Sample 505 | 10¹⁵ | −170 | 6 |
| Example Sample 506 | 10¹⁵ | −200 | 6 |
| Example Sample 507 | 10¹⁵ | −510 | 5 |
| Example Sample 508 | 10¹⁵ | −880 | 3 |
| Example Sample 701 | 10¹² | −30 | 7.5 |
| Example Sample 702 | 10¹¹ | −30 | 7.5 |
| Example Sample 703 | 10¹⁰ | −30 | 9 |
| Example Sample 704 | 10⁹ | −30 | 9.5 |
| Example Sample 705 | 10⁸ | −30 | 10 |

As seen from Table 11, in order to obtain an optical film with excellent dust resistance, in the optical film of the present invention, the absolute value of the vertical separation charge at 25° C. and 60% RH is preferably 500 pc (pico coulomb)/cm² or less, more preferably 200 pc (pico coulomb)/cm² or less, still more preferably 100 pc (pico coulomb)/cm² or less. Furthermore, for more enhancing the dust resistance, this can be achieved by setting the surface resistance value of the optical film of the present invention to less than 1×10¹¹ Ω/square, preferably less than 1×10¹⁰ Ω/square, more preferably 1×10⁹ Ω/square.

Samples produced thoroughly in the same manner as Example Sample 103 except for changing the solvent composition of the low refractive index layer of Example Sample 103 as shown in Table 12 below, are designated as Example Samples 801 to 831.

### (Evaluation of Drying Unevenness of Low Refractive Index Layer)

A polarizing plate produced using triacetyl cellulose TAC-TD80U (produced by FUJIFILM Corporation, thickness: 80 μm) and a polarizing plate produced using the optical film of the present invention were laminated to each other in a cross-Nicol arrangement to prepare a sample for inspection, and the external surface state on the optical film side was evaluated with an eye (inspection of reflection) in a dark room under a stand-type three-wavelength fluorescent lamp. On a scale of 1 to 15, the level in which drying unevenness was not observed at all was rated a score of 15.

TABLE 12

| | Solvent composition of Coating | | |
|---|---|---|---|
| | Solution for Low Refractive Index | | |
| | Layer | | Evaluation Results |
| | | Solvent Having | of Drying |
| | Solvent Having | Boiling Point | Unevenness of Low |
| | Boiling Point of | Exceeding | Refractive Index |
| Sample Name | 120° C. or Less | 120° C. | Layer (score) |
| Example | methyl ethyl | cyclohexanone | 15 |
| Sample 103 | ketone (97) | (3) | |
| Example | methyl ethyl | cyclohexanone | 15 |
| Sample 801 | ketone (90) | (10) | |
| Example | methyl ethyl | cyclohexanone | 14 |
| Sample 802 | ketone (85) | (15) | |
| Example | methyl ethyl | cyclohexanone | 14 |
| Sample 803 | ketone (75) | (25) | |
| Example | methyl ethyl | cyclohexanone | 14 |
| Sample 804 | ketone (70) | (30) | |
| Example | methyl ethyl | cyclohexanone | 13 |
| Sample 805 | ketone (60) | (40) | |
| Example | methyl ethyl | cyclohexanone | 13 |
| Sample 806 | ketone (50) | (50) | |
| Example | methyl ethyl | cyclohexanone | 10 |
| Sample 807 | ketone (40) | (60) | |
| Example | methyl isobutyl | cyclohexanone | 14 |
| Sample 808 | ketone (97) | (3) | |
| Example | methyl isobutyl | cyclohexanone | 14 |
| Sample 809 | ketone (90) | (10) | |
| Example | methyl isobutyl | cyclohexanone | 13 |
| Sample 810 | ketone (85) | (15) | |
| Example | methyl isobutyl | cyclohexanone | 13 |
| Sample 811 | ketone (75) | (25) | |
| Example | methyl isobutyl | cyclohexanone | 13 |
| Sample 812 | ketone (70) | (30) | |
| Example | methyl isobutyl | cyclohexanone | 12 |
| Sample 813 | ketone (60) | (40) | |
| Example | methyl isobutyl | cyclohexanone | 12 |
| Sample 814 | ketone (50) | (50) | |
| Example | methyl isobutyl | cyclohexanone | 9 |
| Sample 815 | ketone (40) | (60) | |
| Example | toluene (97) | cyclohexanone | 14 |
| Sample 816 | | (3) | |
| Example | toluene (90) | cyclohexanone | 14 |
| Sample 817 | | (10) | |
| Example | toluene (85) | cyclohexanone | 13 |
| Sample 818 | | (15) | |
| Example | toluene (75) | cyclohexanone | 13 |
| Sample 819 | | (25) | |
| Example | toluene (70) | cyclohexanone | 13 |
| Sample 820 | | (30) | |
| Example | toluene (60) | cyclohexanone | 12 |
| Sample 821 | | (40) | |
| Example | toluene (50) | cyclohexanone | 12 |
| Sample 822 | | (50) | |
| Example | toluene (40) | cyclohexanone | 9 |
| Sample 823 | | (60) | |
| Example | butyl methyl | cyclohexanone | 11 |
| Sample 824 | ketone (97) | (3) | |
| Example | butyl methyl | cyclohexanone | 11 |
| Sample 825 | ketone (90) | (10) | |
| Example | butyl methyl | cyclohexanone | 10 |
| Sample 826 | ketone (85) | (15) | |
| Example | butyl methyl | cyclohexanone | 10 |
| Sample 827 | ketone (75) | (25) | |
| Example | butyl methyl | cyclohexanone | 10 |
| Sample 828 | ketone (70) | (30) | |
| Example | butyl methyl | cyclohexanone | 9 |
| Sample 829 | ketone (60) | (40) | |
| Example | butyl methyl | cyclohexanone | 9 |
| Sample 830 | ketone (50) | (50) | |
| Example | butyl methyl | cyclohexanone | 6 |
| Sample 831 | ketone (40) | (60) | |

Boiling point: methyl ethyl ketone (80° C.), methyl isobutyl ketone (113° C.), toluene (111° C.), butyl methyl ketone (127° C.), and cyclohexanone (156° C.).

As seen from Table 12, in the optical film of the present invention, when out of the solvents contained in the coating solution for low refractive index layer, the solvent having a boiling point of 120° C. or less accounts for 50 to 100 mass % based on the entire mass of the solvents in the coating solution for low refractive index layer, the drying unevenness (surface state) of the low refractive index layer can be enhanced. The proportion of this solvent is preferably from 70 to 100 mass %, and most preferably from 90 to 100 mass %, based on the entire mass. By setting the proportion in this way, an optical film with very excellent external surface state can be provided.

### (Evaluation Using Polarizing Plate Having Optically Anisotropic Layer)

A polarizing film was produced by adsorbing iodine to a stretched polyvinyl alcohol film. Example Sample 103 was saponified and laminated to one side of the polarizing film by using a polyvinyl alcohol-based adhesive, such that the transparent substrate film (cellulose triacetate) of Example Sample 103 came to the polarizing film side. Also, the following optical compensation film (KH-01) was laminated to the opposite side of the polarizing film by using a polyvinyl alcohol-based adhesive, such that the cellulose acetate film came to the polarizing film side. The transmission axis of the polarizing film and the slow axis of KH-01 were arranged to run in parallel. In this way, a polarizing plate (HKH-01) with light-diffusing layer was produced.

### (Preparation of KH-01)

A cellulose acetate solution was prepared by charging the following composition into a mixing tank and stirring the composition under heating to dissolve respective components.

Composition of Cellulose Acylate Solution

| | | |
|---|---|---|
| Cellulose acetate having an | 100 | parts by mass |
| acetylation degree of 60.9% | | |
| Triphenyl phosphate | 7.8 | parts by mass |
| (plasticizer) | | |
| Biphenyl diphenyl phosphate | 3.9 | parts by mass |
| (plasticizer) | | |
| Methylene chloride (first solvent) | 300 | parts by mass |
| Methanol (second solvent) | 54 | parts by mass |
| 1-Butanol (third solvent) | 11 | parts by mass |

In a separate mixing tank, 25 parts by mass of the retardation raising agent shown below as a wavelength-dispersion controlling agent, 80 parts by mass of methylene chloride and 20 parts by mass of methanol were charged and stirred under heating to prepare a retardation raising agent solution. 7 Parts by mass of the retardation raising agent solution was mixed with 493 parts by mass of the cellulose acetate solution, and these solutions were thoroughly stirred to prepare a dope. The amount of the retardation raising agent added was 1.5 parts by mass per 100 parts by mass of cellulose acetate.

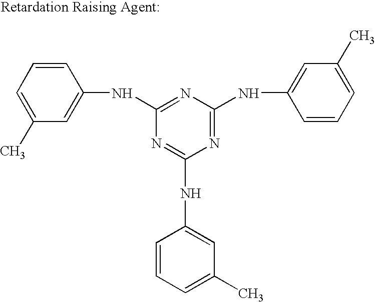

The dope obtained was cast using a band casting machine. After the film surface temperature on the band reached 40° C., the film was dried for 1 minute, then peeled off and further dried with dry air at 140° C. to produce a cellulose acetate film (thickness: 90 μm) having a residual solvent amount of 0.3 mass %. The optical properties of the produced cellulose acetate film (CAF-01) were measured, as a result, The Re retardation value was 5 nm, and the Rth retardation value was 80 nm. Incidentally, in the measurement of optical properties, Re retardation value and Rth retardation value at a wavelength of 550 nm were measured using an ellipsometer (M150, manufactured by JASCO Corp.).

The produced cellulose acetate film was coated with 5 ml/m² of 1.5 N potassium hydroxide (water/IPA/PG=14/86/15 vol %), then kept at 60° C. for about 10 seconds and after water-washing the potassium hydroxide remaining on the film surface, dried. The surface energy of this cellulose acetate film was measured by the contact angle method and found to be 63 mN/m. On this cellulose acetate film, a coating solution having the following composition was coated by a #16 wire bar to have a coverage of 28 ml/m², and dried with warm air at 60° C. for 60 seconds and further with warm air at 90° C. for 150 seconds. Subsequently, the film formed was subjected to rubbing in the direction parallel to the longitudinal direction of the cellulose acetate film.

Composition of Coating Solution for Orientation Film

| | |
|---|---|
| Modified polyvinyl alcohol | 10 parts by mass |
| shown below | |
| Water | 371 parts by mass |
| Methanol | 119 parts by mass |
| Glutaraldehyde (crosslinking | 0.5 parts by mass |
| agent) | |

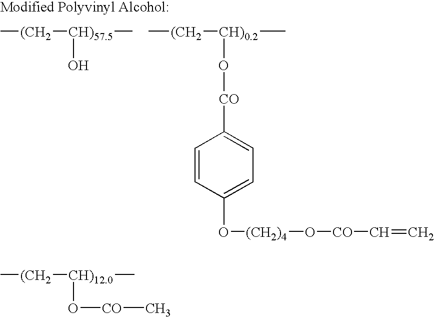

### (Formation of Optically Anisotropic Layer)

On the orientation film, a coating solution obtained by dissolving 41.01 g of the discotic (liquid crystalline) compound shown below, 4.06 g of ethylene oxide-modified trimethylolpropane triacrylate (V#360, produced by Osaka Organic Chemical Industry Ltd.), 0.90 g of cellulose acetate butyrate (CAB551-0.2, produced by Eastman Chemical), 0.23 g of cellulose acetate butyrate (CAB531-1, produced by Eastman Chemical), 1.35 g of a photopolymerization initiator (Irgacure 907, produced by Ciba Geigy) and 0.45 g of a sensitizer (Kayacure DETX, produced by Nippon Kayaku Co., Ltd.) in 102 g of methyl ethyl ketone was coated by a #3.6 wire bar. This coating was heated in a constant-temperature zone at 130° C. for 2 minutes to align the discotic compound, then irradiated with UV for 1 minute by using a high-pressure mercury lamp of 120 W/cm in an atmosphere of 60° C. to polymerize the discotic compound, and allowed to cool to room temperature, thereby forming an optically anisotropic layer. In this way, an optical Compensation Film (KH-01) was produced. The Re retardation value of the optically anisotropic layer measured at a wavelength of 550 nm was 43 nm. Also, the angle (tilt angle) between the discotic plane and the first transparent support plane was 42° on average.

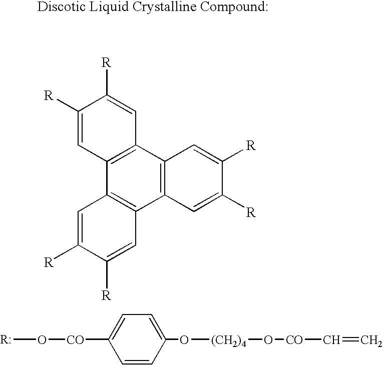

A pair of polarizing plates provided in a liquid crystal display device (6E-A3, manufactured by Sharp Corp.) using a TN-mode liquid crystal cell were removed, and the polarizing plate (HKH-01) was instead laminated on the viewer side through a pressure-sensitive adhesive such that KH-01 came to the liquid cell side. On the backlight side, the following polarizing plate (HKH-H1) was laminated. The transmission axis of the polarizing plate on the viewer side and the transmission axis of the polarizing plate on the backlight side were arranged in O mode. The viewing angle of the liquid crystal display device produced was measured in 8 steps from black display (L1) to white display (L8) by using a measuring apparatus (EZ-Contrast 160D, manufactured by ELDIM). The results are shown in Table 13.

Also, a polarizing plate (HKH-H1) was produced by laminating a commercially available cellulose triacetate film (FUJI-TAC TD80UF, produced by FUJIFILM Corporation) in place of the optical compensation film (KH-01) of the polarizing plate (HKH-01) with light-diffusing layer, and measured in the same manner as in the evaluation of the polarizing plate (HKH-01) with light-diffusing layer. The results are shown in Table 13.

TABLE 13

| | Viewing Angle, contrast ratio ≧ 1 | | |
|---|---|---|---|
| Polarizing Plate | Up | Down | Right/Left |
| Example HKH-01 | 70° | 65° | 160° |
| Comparative Example HKH-H1 | 15° | 25° | 37° |

(Note)
Tone reversal on black side: reversal between L1 and L2

Even when the support of the optical compensation film (KH-01) of the polarizing plate (HKH-01) with light-diffusing layer was changed to the film described in JP-A-2006-030937, the same effects were obtained.

This application is based on Japanese Patent application Jp 2006-168852, filed Jun. 19, 2006, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. An optical film comprising: a transparent support; and at least one hardcoat layer containing a light-transparent resin, wherein at least one of the at least one hardcoat layer contains at least one light-transparent organic resin particle, and a surface of the light-transparent organic resin particle is covered with a metal oxide.

2. The optical film of claim 1, wherein the metal oxide is silica.

3. The optical film of claim 1, wherein the light-transparent organic resin particle is a melamine resin.

4. The optical film of claim 1, wherein the light-transparent organic resin particle has an average particle diameter of 2.5 μm or less.

5. The optical film of claim 1, wherein the light-transparent organic resin particle has a CV value of less than 10%.

6. The optical film of claim 1, wherein the light-transparent organic resin particle has a refractive index being higher than a refractive index of the hardcoat layer, and a difference between the refractive index of the light-transparent organic resin particle and the refractive index of the hardcoat layer is 0.10 or more.

7. The optical film of claim 1, wherein the optical film has an internal haze of from 20% to less than 80%.

8. The optical film of claim 1, wherein the optical film has a surface haze of less than 3%.

9. The optical film of claim 1, wherein the optical film has an Ra of less than 0.07 μm.

10. The optical film of claim 1, wherein the hardcoat layer has a thickness of 5 μm or more.

11. The optical film of claim 1, wherein the optical film comprises at least two light-transparent particles having different average particle diameter from each other, at least one of the at least two light-transparent particles is the light-transparent organic resin particle having an average particle diameter of 2.5 μm or less, at least one of the at least two light-transparent particles is a light-transparent particle having an average particle diameter of 3 μm or more, and a number of the light-transparent organic resin particles having an average particle diameter of 2.5 μm or less per unit area is 3 times or more a number of the light-transparent particles having an average particle diameter of 3 μm or more per unit area.

12. The optical film of claim 1, further comprising: a low refractive index layer as an outermost layer and the low refractive index layer has a refractive index lower than a refractive index of a layer provided adjacent to the low refractive index layer.

13. The optical film of claim 1, wherein when an average value of 5° specular reflectance in a wavelength region of 450 to 650 nm is A and an average value of integrated reflectance in the region is B, B is 3% or less and B-A is 1.5% or less.

14. The optical film of claim 12, wherein the low refractive index layer contains at least one particle having a particle diameter corresponding to 15 to 150% of a thickness of the low refractive index layer.

15. The optical film of claim 14, wherein at least one of the particle is a hollow particle.

16. The optical film of claim 12, wherein the low refractive index layer is formed by coating and a coating solution for forming the low refractive index layer contains at least one light-transparent resin having at least one of an ultraviolet-curable functional group and a heat-curable functional group.

17. The optical film of claim 12, wherein the low refractive index layer is formed by coating, and a coating solution for forming the low refractive index layer contains at least two light-transparent resins including a light-transparent resin having an ultraviolet-curable functional group and a light-transparent resin having a heat-curable functional group.

18. The optical film of claim 16, wherein the low refractive index layer is formed by coating, a coating solution for forming the low refractive index layer contains at least two light-transparent resins including a light-transparent resin having an ultraviolet-curable functional group and a fluorine group and a light-transparent resin having no fluorine group and having an ultraviolet-curable functional group.

19. The optical film of claim 16, wherein the coating solution for forming the low refractive index layer further contains at least one of a polymerization initiator and a heat-curable crosslinking agent.

20. The optical film of claim 19, wherein the coating solution for forming the low refractive index layer further contains at least one curing catalyst capable of accelerating a thermal curing.

21. The optical film of claim 1, comprising at least one of a fluorine-based leveling agent and a silicone-based leveling agent.

22. The optical film of claim 1, wherein all layers included in the optical film contain a silica material.

23. The optical film of claim 1, wherein a contact angle by pure water on a surface of the optical film as measured in an environment of 25° C. and 60% RH is 90° or more.

24. The optical film of claim 1, wherein a coefficient of dynamic friction on a surface of the optical film as measured in an environment of 25° C. and 60% RH is 0.3 or less.

25. The optical film of claim 1, wherein a vertical separation charge for polyethylene terephthalate as measured in an environment of 25° C. and 60% RH is from −500 to +500 pc/cm².

26. The optical film of claim 1, which has a surface resistance value as measured in an environment of 25° C. and 60% RH is less than 1×10¹¹ Ω/square.
